(19) United States
(12) Patent Application Publication
(10) Pub. No.: US 2003/0215217 A1
(43) Pub. Date: Nov. 20, 2003

(54) Information recording medium, recording apparatus, reproduction apparatus, and recording and reproduction apparatus

(76) Inventors: Noriaki Horii, Osaka (JP); Masaya Yamamoto, Osaka (JP); Masatoshi Shimbo, Hyogo (JP)

Correspondence Address: Neil A. DuChez, Renner, Otto, Boisselle & Sklar, LLP, Nineteenth Floor, 1621 Euclid Avenue, Cleveland, OH, 44115, US

(21) Appl. No.: 10/410,590

(22) Filed: Apr. 9, 2003

(30) Foreign Application Priority Data
Apr. 11, 2002 (JP) 2002-108702

(51) Int. Cl. H04N 5/76; G11B 19/04; G11B 15/04

(52) U.S. Cl. 386/94; 380/201; 360/60

(57) ABSTRACT

An information recording medium for recording of information and copyright information representing copyright regarding the information. The copyright information includes reproduction restriction information for restricting reproduction of the information.

### BACKGROUND OF THE INVENTION

1. Field of the Invention

The present invention relates to an information recording medium, and a reproduction apparatus, a recording apparatus, and a recording and reproduction apparatus using the information recording medium. In particular, the present invention relates to an information recording medium for recording of distributed music contents, and a reproduction apparatus, a recording apparatus, and a recording and reproduction apparatus using the information recording medium.

2. Description of the Related Art

Recently, many electronic music distribution systems have started service owing to development of various compression encoding systems and rapid propagation of Internet technologies. The electronic music distribution systems use compression encoding systems such as, for example, MP3 to distribute songs in a sufficiently short time even to users using a network having a narrow bandwidth. In recent years, some of the distribution systems have distributed still pictures, moving pictures, texts, and the like as well as songs.

These electronic music distribution systems often adopt copy control systems which are different from those used conventionally. The conventional copy control systems, which are of a generation management type, permits the user to make a copy (child-generation copy) from an original medium, but does not permit the user to make a copy (grandchild-generation copy) from the child-generation copy. Electronic music distribution systems often use a copy control system using a technique referred to as the “transfer technique”. The transfer technique is used for copying a content from an original medium to another medium, in which case the content in the original medium is made unusable. The copied content is often treated as a content in an original medium and permitted to be transferred to still anther medium. In order to allow such new copy control systems to be used, each content is provided with inherent information for uniquely specifying itself. The inherent information is distributed together with the content. The inherent information is, for example, a code according to the ISRC (International Standard Recording Code).

Some contents distributed by the electronic music distribution systems are restricted such that the contents are permitted to be reproduced only under certain conditions. For example, the content are permitted to be reproduced up to a certain number of times or until a certain time. These restrictions regarding reproduction are set by the distributors of the contents, and the reproduction apparatuses are required to conform to the reproduction restrictions.

Today, there is demand for consumer appliances for recording and reproducing the contents distributed by electronic music distribution systems. It has been conceived that the distributed contents may be recorded and reproduced by home-use audio recorder/player using the DVD-RAM Standards. These home-use audio recorder/player are required to conform to the copy control system determined by the distribution system (conventional generation management type copy control system, or the copy control system using the transfer technique) and to reproduce the contents accurately based on the reproduction restrictions set by the distribution system. The home-use audio recorder/players are also required to correctly permit or prohibit editing of the contents since most of the distributed contents are protected by copyright. Furthermore, the distributed contents may include a song, a still picture, and/or a text. The home-use audio recorder/player are required to correctly permit or prohibit a change in the linking between the song, the still picture, and the text.

### SUMMARY OF THE INVENTION

According to one aspect of the invention, an information recording medium for recording of information and copyright information representing copyright regarding the information is provided. The copyright information includes reproduction restriction information for restricting reproduction of the information.

In one embodiment of the invention, the information is at least one of audio information, still picture information, moving picture information, and text information.

In one embodiment of the invention, the reproduction restriction information represents one of a time period in which the information is permitted to be reproduced, a time limit until which the information is permitted to be reproduced, a number of times that the information is permitted to be reproduced, a time period in which the information is permitted to be reproduced after an initial reproduction of the information, a password for reproducing the information, a reproduction quality of the information, and an area of the information recording medium which is permitted to be reproduced.

In one embodiment of the invention, the reproduction restriction information indicates that reproduction of the information is restricted by a combination of a plurality of types of restriction.

In one embodiment of the invention, the information includes first information and second information linked to the first information. The reproduction restriction information includes permission information indicating that the second information is permitted to be reproduced when the first information is permitted to be reproduced.

In one embodiment of the invention, the information includes first information and second information linked to the first information. The reproduction restriction information includes permission information indicating that the second information is permitted to be reproduced regardless of whether or not the first information is permitted to be reproduced.

According to another aspect of the invention, an information recording medium for recording of information, management information for managing reproduction of the information, and copyright information representing copyright regarding the information is provided. The copyright information is recorded in a different area of the information recording medium from an area in which the information and the management information are recorded.

In one embodiment of the invention, the information is at least one of audio information, still picture information, moving picture information, and text information.

In one embodiment of the invention, the information, the management information, and the copyright information are included in different files from each other.

In one embodiment of the invention, the information includes a plurality of pieces of partial information. The management information includes a plurality of pieces of partial management information. The copyright information includes a plurality of pieces of partial copyright information. Each of the plurality of pieces of partial management information represents a management content regarding reproduction of a respective one of the plurality of pieces of partial information. Each of the plurality of pieces of partial copyright information represents copyright regarding a respective one of the plurality of pieces of partial information. The plurality of pieces of partial management information, and the plurality of pieces of partial copyright information, are each provided with inherent information for identifying each piece of partial information. Each of the pieces of partial management information and each of the pieces of partial copyright information which correspond to common partial information are provided with the same inherent information.

In one embodiment of the invention, the inherent information is positive serial numbers.

According to still another aspect of the invention, an information recording medium for recording of information including a plurality of pieces of partial information, and copyright information representing copyright regarding a specific piece of partial information among the plurality of pieces of partial information is provided.

In one embodiment of the invention, the plurality of pieces of information are at least one of audio information, still picture information, moving picture information, and text information.

According to still another aspect of the invention, an information recording and reproduction apparatus includes a reading section for reading first information from an information recording medium including the first information and second information linked to the first information; an output section for outputting the first information; a writing section for deleting the first information from the information recording medium; and a control section for controlling the reading section and the writing section. The control section controls the writing section so as to delete the second information from the information recording medium when transferring the first information to another information recording medium.

In one embodiment of the invention, the first information is at least one of audio information and moving picture information. The second information is at least one of still picture information and text information.

In one embodiment of the invention, the recording and reproduction apparatus further includes a display section for displaying that the second information is deleted from the information recording medium when transferring the first information to the another information recording medium.

According to still another aspect of the invention, an information recording and reproduction apparatus includes a reading section for reading second information from a first information recording medium including the first information and second information linked to the first information; an output section for outputting the second information; a writing section for deleting the second information from the first information recording medium; and a control section for controlling the reading section and the writing section. The control section controls the reading section and the writing section so as to transfer the first information from the first information recording medium to a second information recording medium when transferring the second information from the first information recording medium to the second information recording medium.

In one embodiment of the invention, the first information is at least one of audio information and moving picture information. The second information is at least one of still picture information and text information.

In one embodiment of the invention, the first information recording medium further includes transfer information which represents whether the first information is permitted to be transferred or prohibited from being transferred. The reading section further reads the transfer information from the first information recording medium. The control section transfers the first information and the second information to the second information recording medium when the transfer information represents the first information is permitted to be transferred. The control section does not transfer the first information or the second information to the second information recording medium when the transfer information represents the first information is prohibited from being transferred.

In one embodiment of the invention, the first information recording medium further includes transfer information which represents that transfer of the second information is permitted or prohibited in conformance with whether the first information is permitted to be transferred or prohibited from being transferred. The reading section further reads the transfer information from the first information recording medium. The control section transfers the first information and the second information to the second information recording medium when the first information is permitted to be transferred. The control section does not transfer the first information or the second information to the second information recording medium when the first information is prohibited from being transferred.

According to still another aspect of the invention, a recording and reproduction apparatus for transferring first information from a first information recording medium including the first information to a second information recording medium is provided. The recording and reproduction apparatus includes a reading section for reading the first information from the first information recording medium; an output section for outputting the first information; a writing section for deleting the first information from the first information recording medium; and a control section for controlling the reading section and the writing section. The control section determines whether or not second information which can be linked to the first information has been recorded on the second information recording medium; when the second information has been recorded on the second information recording medium, the control section controls the reading section and the writing section so as to transfer the first information to the second information recording medium; and when the second information has not been recorded on the second information recording medium, the control section controls the reading section and the writing section so as not to transfer the first information to the second information recording medium.

In one embodiment of the invention, the first information is at least one of still picture information and text information. The second information is at least one of audio information and moving picture information.

According to still another aspect of the invention, a reproduction apparatus includes a reading section for reading information and copyright information representing copyright regarding the information from an information recording medium having the information and the copyright information; and an output section for outputting the information. The copyright information includes reproduction restriction information for restricting reproduction of the information. The reproduction apparatus further includes a control section for controlling at least one of the reading section and the output section based on a restriction represented by the reproduction restriction information.

In one embodiment of the invention, the information is at least one of audio information, still picture information, moving picture information, and text information.

In one embodiment of the invention, the reproduction apparatus further includes a memory section. The control section updates the reproduction restriction information as the information is reproduced, and stores the updated reproduction restriction information in the memory section.

In one embodiment of the invention, the control section determines whether or not to permit reproduction of the information based on a restriction represented by the reproduction restriction information.

In one embodiment of the invention, the reproduction restriction information includes permission information representing a time period in which reproduction of the information is permitted. The control section calculates a remaining time period in which reproduction of the information is permitted based on a time period in which the information has been reproduced and the time period represented by the permission information, and controls the reading section based on the calculated remaining time period.

In one embodiment of the invention, the control section controls the reading section so as to reproduce the information until the calculated remaining time period becomes zero, and so as not to reproduce the information when the calculated remaining time period reaches zero.

In one embodiment of the invention, the reproduction apparatus further includes a memory section. The reproduction restriction information includes permission information representing a time period in which reproduction of the information is permitted. The control section calculates a remaining time period in which reproduction of the information is permitted based on a time period in which the information has been reproduced and the time period represented by the permission information, generates remaining time period information representing the calculated remaining time period, and stores the generated remaining time period information in the memory section. The control section controls the reading section based on the remaining time period represented by the remaining time period information stored in the memory section.

In one embodiment of the invention, the reproduction restriction information includes permission information representing a time period in which reproduction of the information is permitted. The control section compares a time period in which the information has been reproduced with the time period represented by the permission information, and controls the reading section based on the comparison result.

In one embodiment of the invention, when the time period in which the information has been reproduced is shorter than the time period represented by the permission information, the control section controls the reading section so as to reproduce the information; and when the time period in which the information has been reproduced reaches the time period represented by the permission information, the control section controls the reading section so as not to reproduce the information.

In one embodiment of the invention, the reproduction apparatus further includes a memory section. The reproduction restriction information includes permission information representing a time period in which reproduction of the information is permitted. The control section generates past reproduction time information which represents the time period in which the information has been reproduced, and stores the generated past reproduction time period information in the memory section. The control section compares the time period represented by the past reproduction time information stored in the memory section with the time period represented by the permission information, and controls the reading section based on the result of the comparison.

In one embodiment of the invention, the reproduction apparatus further includes a clock section representing a date/time. The reproduction restriction information includes permission information representing a time limit until which reproduction of the information is permitted. The control section compares a date/time represented by the clock section with the time limit represented by the permission information, and controls the reading section based on the result of the comparison.

In one embodiment of the invention, when the date/time represented by the clock section is before the time limit represented by the permission information, the control section controls the reading section so as to reproduce the information, and when the date/time represented by the clock section is not before the time limit represented by the permission information, the control section controls the reading section so as not to reproduce the information.

In one embodiment of the invention, the reproduction restriction information includes permission information representing an area of the information recording medium which is permitted to be reproduced. The area has a part of the information recorded therein. The control section controls the reading section so as to reproduce the part of the information recorded in the area.

In one embodiment of the invention, the reproduction restriction information includes permission information representing a number of times that the information is permitted to be reproduced. The control section calculates a remaining reproduction number of times that the information is permitted to be reproduced based on the number of times that the information has been reproduced and the number of times represented by the permission information, and controls the reading section based on the calculated remaining reproduction number of times.

In one embodiment of the invention, the control section controls the reading section so as to reproduce the information until the calculated remaining reproduction number of times becomes zero, and controls the reading section so as not to reproduce the information when the calculated remaining reproduction number of times becomes zero.

In one embodiment of the invention, the reproduction apparatus further includes a memory section. The reproduction restriction information includes permission information representing a number of times that the information is permitted to be reproduced. The control section calculates a remaining reproduction number of times that the information is permitted to be reproduced based on the number of times that the information has been reproduced and the number of times represented by the permission information, generates remaining reproduction number information representing the calculated remaining reproduction number of times, and stores the generated remaining reproduction number information in the memory section. The control section controls the reading section based on the remaining reproduction number of times represented by the remaining reproduction number information stored in the memory section.

In one embodiment of the invention, the reproduction restriction information includes permission information representing a number of times that the information is permitted to be reproduced. The control section compares the number of times that the information has been reproduced with the number of times represented by the permission information, and controls the reading section based on the result of the comparison.

In one embodiment of the invention, when the number of times that the information has been reproduced is smaller than the number of times represented by the permission information, the control section controls the reading section so as to reproduce the information; and when the number of times that the information has been reproduced reaches the number of times represented by the permission information, the control section controls the reading section so as not to reproduce the information.

In one embodiment of the invention, the reproduction apparatus further includes a memory section. The reproduction restriction information includes permission information representing a number of times that the information is permitted to be reproduced. The control section generates past reproduction number information representing a number of times that the information has been reproduced, and stores the generated past reproduction number information in the memory section. The control section compares the number of times represented by the past reproduction number information stored in the memory section with the number of times represented by the permission information stored in the memory section, and controls the reading section based on the result of the comparison.

In one embodiment of the invention, the reproduction apparatus further includes a clock section representing a date/time. The reproduction restriction information includes permission information representing a time period, from an initial reproduction of the information, in which reproduction of the information is permitted. The control section specifies a date/time when the information was first reproduced from a date/time represented by the clock section, and calculates the time limit until which the reproduction of the information is permitted based on a date/time when the information was first reproduced and the time period represented by the permission information. The control section compares a date/time represented by the clock section with the calculated time limit, and controls the reading section based on the result of the comparison.

In one embodiment of the invention, when a date/time represented by the clock section is before the calculated time limit, the control section controls the reading section so as to reproduce the information, and when a date/time represented by the clock section is not before the calculated time limit, the control section controls the reading section so as not to reproduce the information.

In one embodiment of the invention, the reproduction apparatus further includes a clock section representing a date/time; and a memory section. The reproduction restriction information includes permission information representing a time period, from an initial reproduction of the information, in which reproduction of the information is permitted. The control section specifies a date/time when the information was first reproduced from a date/time represented by the clock section, calculates the time limit until which the reproduction of the information is permitted based on a date/time when the information was first reproduced and the time period represented by the permission information, generates time limit information representing the calculated time limit, and stores the generated time limit information in the memory section. The control section compares the time limit represented by the time limit information stored in the memory section with the date/time represented by the clock, and controls the reading section based on the result of the comparison.

In one embodiment of the invention, the control section generates initial reproduction date/time information representing a date/time when the information was first reproduced, and stores the generated initial reproduction date/time information in the memory section. The control section compares the date/time represented by the initial reproduction date/time information stored in the memory section with a time/date represented by the clock section, and controls the reading section based on the result of the comparison between the time limit represented by the time limit information stored in the memory section and the date/time represented by the clock section, and the result of the comparison between the date/time represented by the initial reproduction date/time information stored in the memory section and the date/time represented by the clock section.

In one embodiment of the invention, the reproduction restriction information includes reproduction quality information representing a quality of the information at the time of reproduction. The control section controls the output section so as to reproduce the information with the quality represented by the reproduction quality information.

In one embodiment of the invention, the information includes first information and second information linked to the first information. The reproduction restriction information includes first reproduction restriction information for restricting reproduction of the first information, and second reproduction restriction information for restricting reproduction of the second information. The second reproduction restriction information includes permission information representing that when reproduction of the first information is permitted, reproduction of the second information is permitted. The control section determines whether or not to permit reproduction of the first information based on the first reproduction restriction information, permits reproduction of the second information when reproduction of the first information is permitted, and does not permit reproduction of the second information when reproduction of the first information is not permitted.

In one embodiment of the invention, the information includes first information and second information linked to the first information. The reproduction restriction information includes permission information which represents that reproduction of the second information is permitted regardless of whether or not reproduction of the first information is permitted. The control section permits reproduction of the second information regardless of whether or not the reproduction of the first information is permitted.

According to still another aspect of the invention, a recording and reproduction apparatus includes an obtaining section for obtaining information and copyright information representing copyright regarding the information; a writing section for writing the information on an information recording medium; and a control section for controlling the writing section. The control section determines whether or not the copyright information includes reproduction restriction information for restricting reproduction of the information, and when the copyright information includes the reproduction restriction information, the control section controls the writing section so as not to write the information on the information recording medium.

In one embodiment of the invention, the information is at least one of audio information, still picture information, moving picture information, and text information.

In one embodiment of the invention, when the copyright information does not include the reproduction restriction information, the control section controls the writing section so as to write the information on the information recording medium.

In one embodiment of the invention, the recording and reproduction apparatus further includes a display section for displaying that the information cannot be written on the information recording medium when the copyright information includes the reproduction restriction information.

According to still another aspect of the invention, a reproduction apparatus includes a reading section for reading information and copyright information regarding the information from an information recording medium including the information and the copyright information; an output section for out putting the information; and a control section for controlling the reading section. The control section determines whether or not the copyright information includes reproduction restriction information for restricting reproduction of the information, and when the copyright information includes the reproduction restriction information, the control section controls the reading section so as not to reproduce the information.

In one embodiment of the invention, the information is at least one of audio information, still picture information, moving picture information, and text information.

In one embodiment of the invention, when the copyright information does not include the reproduction restriction information, the control section controls the reading section so as to reproduce the information.

In one embodiment of the invention, the reproduction apparatus further includes a display section for displaying that the information cannot be reproduced when the copyright information includes the reproduction restriction information.

According to still another aspect of the invention, a recording and reproduction apparatus includes a writing section for deleting first information recorded on an information recording medium from the information recording medium; and a control section for controlling the writing section. The control section determines whether or not second information which is linked to the first information is recorded on the information recording medium; when the second information is recorded on the information recording medium, the control section controls the writing section so as to delete the first information and the second information from the information recording medium as the first information is deleted; and when the second information is not recorded on the information recording medium, the control section controls the writing section so as to delete the first information from the information recording medium.

In one embodiment of the invention, the first information is at least one of audio information and moving picture information. The second information is at least one of still picture information and text information.

According to still another aspect of the invention, an information recording medium for recording of first information and second information linked to the first information is provided. The second information includes inherent information for specifying the first information.

In one embodiment of the invention, the first information is at least one of audio information and moving picture information. The second information is at least one of still picture information and text information.

In one embodiment of the invention, the information recording medium further includes copyright information representing copyright regarding the first information, wherein the copyright information includes inherent information, which is the same as the inherent information included in the second information.

In one embodiment of the invention, the second information includes a plurality of pieces of partial information obtained as a result of division by a prescribed information unit. A prescribed piece of partial information among the plurality of pieces of partial information includes the inherent information.

According to still another aspect of the invention, a reproduction apparatus includes a reading section for reading first information and second information from an information recording medium including the first information and the second information; an output section for outputting the first information; and a control section for controlling the output section. The control section determines whether or not the second information includes inherent information for specifying the first information; when the second information includes the inherent information, the control section controls the output section so as to reproduce the first information and the second information; and when the second information does not include the inherent information, the control section controls the output section so as to reproduce the first information but not to reproduce the second information.

In one embodiment of the invention, the first information is at least one of audio information and moving picture information. The second information is at least one of still picture information and text information.

In one embodiment of the invention, the information recording medium further includes copyright information representing copyright regarding the first information recorded therein. The copyright information includes inherent information which is the same as the inherent information included in the second information. The control section compares the copyright information with the second information, to determine whether or not the second information includes the inherent information.

Thus, the invention described herein makes possible the advantages of providing an information recording medium, a reproduction apparatus, a recording apparatus, and a recording and reproduction apparatus which conform to copy and editing restrictions and reproduction restrictions made on contents based on copyright.

These and other advantages of the present invention will become apparent to those skilled in the art upon reading and understanding the following detailed description with reference to the accompanying figures.

### BRIEF DESCRIPTION OF THE DRAWINGS

FIG. 1 shows an information recording medium according to Example 1;

FIG. 2 shows a management information file according to Example 1;

FIG. 3 shows audio copy information according to Example 1:

FIG. 4 shows audio reproduction restriction information according to Example 1;

FIG. 5 shows audio editing restriction information according to Example 1;

FIG. 6 shows still picture copy control information according to Example 1;

FIG. 7A shows still picture reproduction restriction information according to Example 1;

FIG. 7B shows still picture editing restriction information according to Example 1;

FIG. 7C shows a data structure of the still picture information according to Example 1;

FIG. 8 shows an information recording medium according to Example 4;

FIG. 9A shows a management information file according to Example 4;

FIG. 9B shows a right information file according to Example 4;

FIG. 10A shows a management information file according to Example 5;

FIG. 10B shows a right information file according to Example 5;

FIG. 11 shows a text information structure;

FIG. 12A shows a management information file according to Example 6;

FIG. 12B shows a text information file according to Example 6;

FIG. 13 shows a recording apparatus according to Example 7;

FIG. 14 shows a reproduction apparatus according to Example 9;

FIG. 15 shows a reproduction apparatus according to Example 10;

FIG. 16 shows a recording apparatus according to Example 11;

FIG. 17 shows a recording and reproduction apparatus according to Example 12;

FIG. 18 shows a recording and reproduction apparatus according to Example 13;

FIG. 19 shows a recording and reproduction apparatus according to Example 14;

FIG. 20 shows a recording and reproduction apparatus according to Example 15;

FIG. 21 shows a recording and reproduction apparatus according to Example 16;

FIG. 22 shows a recording and reproduction apparatus according to Example 17;

FIG. 23 shows a recording and reproduction apparatus according to Example 18;

FIG. 24 shows a reproduction apparatus according to Example 19;

FIG. 25A shows a recording and reproduction apparatus according to Example 20;

FIG. 25B shows audio copyright information according to Example 20;

FIG. 26A shows a reproduction apparatus according to Example 21;

FIG. 26B shows audio copyright information according to Example 21;

FIG. 27 shows a reproduction apparatus according to Example 22;

FIG. 28 shows a reproduction apparatus according to Example 23;

FIG. 29 shows a reproduction apparatus according to Example 24;

FIG. 30 shows a reproduction apparatus according to Example 25;

FIG. 31 shows a reproduction apparatus according to Example 26;

FIG. 32 shows a reproduction apparatus according to Example 27;

FIG. 33 shows a reproduction apparatus according to Example 28;

FIG. 34 shows a reproduction apparatus according to Example 29;

FIG. 35 shows a reproduction apparatus according to Example 30;

FIG. 36 shows a recording and reproduction apparatus according to Example 31;

FIG. 37 shows a recording apparatus according to Example 32;

FIG. 38 shows a recording and reproduction apparatus according to Example 33;

FIG. 39 shows a recording apparatus according to Example 34:

FIG. 40 shows a recording and reproduction apparatus according to Example 35;

FIG. 41 shows a recording and reproduction apparatus according to Example 36;

FIG. 42 shows a recording and reproduction apparatus according to Example 37;

FIG. 43 shows a recording and reproduction apparatus according to Example 38;

FIG. 44A shows a reproduction apparatus according to Example 39; and

FIG. 44B shows copyright information according to Example 39.

### DESCRIPTION OF THE PREFERRED EMBODIMENTS

Hereinafter, the present invention will be described by way of illustrative examples with reference to the accompanying drawings.

### Example 1

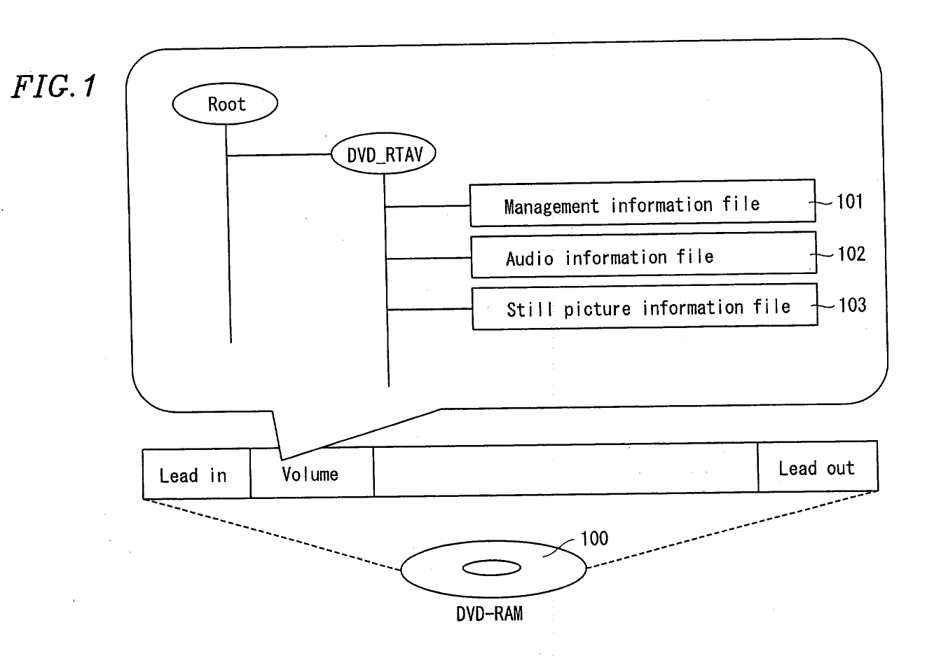

FIG. 1 shows an information recording medium 100 according to Example 1 of the present invention. The information recording medium 100 is, for example, a DVD-RAM disc. The information recording medium 100 includes an audio information file 102 including audio information, a still picture information file 103 including still picture information, and a management information file 101 including management information for managing reproduction of the audio information and the still picture information.

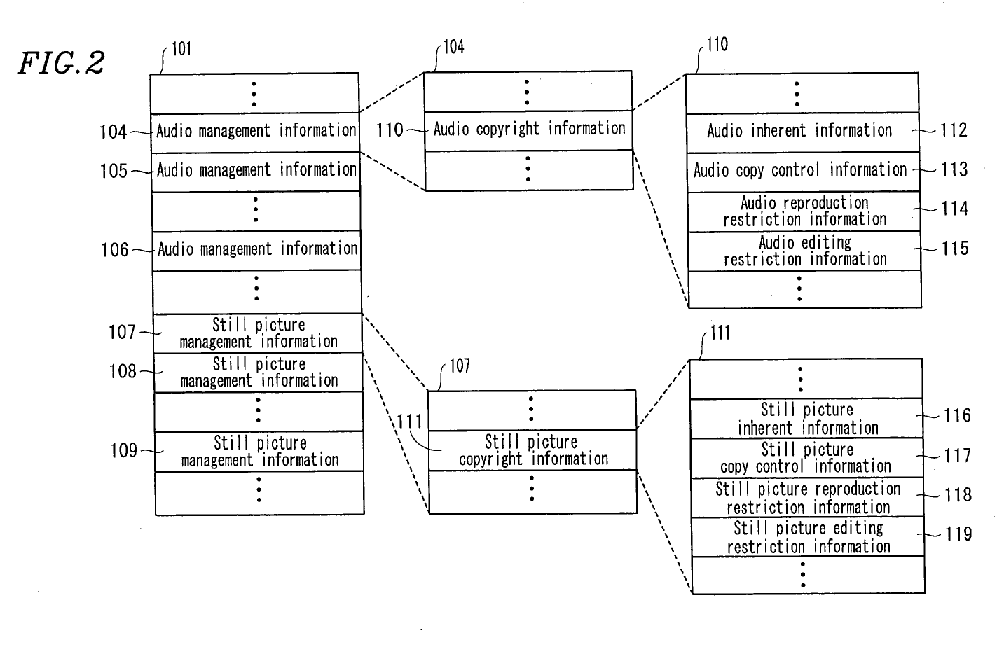

As shown in FIG. 2, the management information file 101 includes audio management information 104, 105 and 106, and still picture management information 107, 108 and 109. Each of audio management information 104, 105 and 106 relates to audio information recorded in a certain zone of the information recording medium 100, and include, for example, audio attribute information and a recording start address of the audio information. The audio information recorded in a certain zone of the information recording medium 100 is, for example, audio information corresponding to one song.

Each of the still picture management information 107, 108 and 109 relates to at least one piece of still picture information included in the still picture information file 103, and include, for example, still picture attribute information and a recording start address of the still picture information. The at least one piece of still picture information included in the still picture information file 103 is, for example, at least one still picture displayed while audio information representing a song is being reproduced. Throughout this specification, audio information and still picture information which is displayed while the audio information is being reproduced are referred to as “linked”. Information regarding the link is included in the management information file 101.

The audio management information 104 includes audio copyright information 110 representing copyright of the corresponding audio information. The still picture management information 107 includes still picture copyright information 11 representing copyright of the corresponding still picture information. The audio copyright information 110 includes audio inherent information 112, audio copy control information 113, audio reproduction restriction information 114, and audio editing restriction information 115.

The audio inherent information 112 is used for uniquely specifying the audio information, and is, for example, an ISRC code.

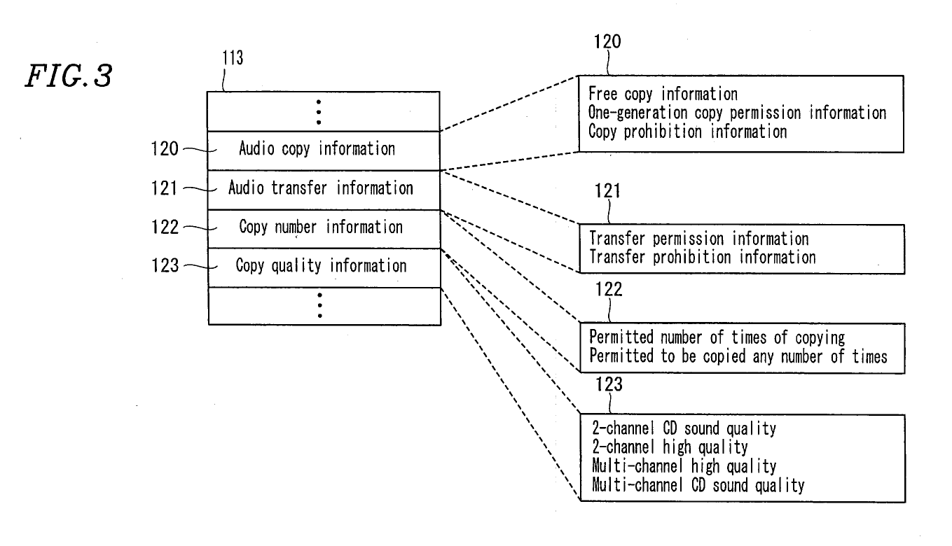

The audio copy control information 113 relates to copy and transfer of the audio information. As shown in FIG. 3, the audio copy control information 113 includes audio copy information 120, audio transfer information 121, copy number information 122, and copy quality information 123. The audio copy information 120 relates to copy permission/prohibition of the audio information, and includes (i) free copy information which indicates that the audio information can be permitted to be copied with no restriction, (ii) one-generation copy permission information which indicates that a grandchild-generation copy of the audio information is prohibited from being made, or (iii) copy prohibition information which indicates that the audio information is prohibited from being copied. The audio transfer information 121 relates to transfer permission/prohibition of the audio information, and includes (i) transfer permission information which indicates that the audio information is permitted to be transferred or (ii) transfer prohibition information which indicates that the audio information is prohibited from being transferred. The copy number information 122 specifies the number of times that the audio information is permitted to be copied, and represents either the permitted number of times of copying or that the audio information is permitted to be copied any number of times. The copy quality information 123 specifies the quality of the audio information to be copied, and represents, for example, (i) “2-channel CD sound quality” which represents 2-channels and specifies CD sound quality, (ii) 2-channel high quality” which represents 2-channels and does not specify sound quality, (iii) “multi-channel high quality” which does not specify the number of channels or sound quality, or (iv) “multi-channel CD sound quality” which does not specify the number of channels but specifies CD sound quality.

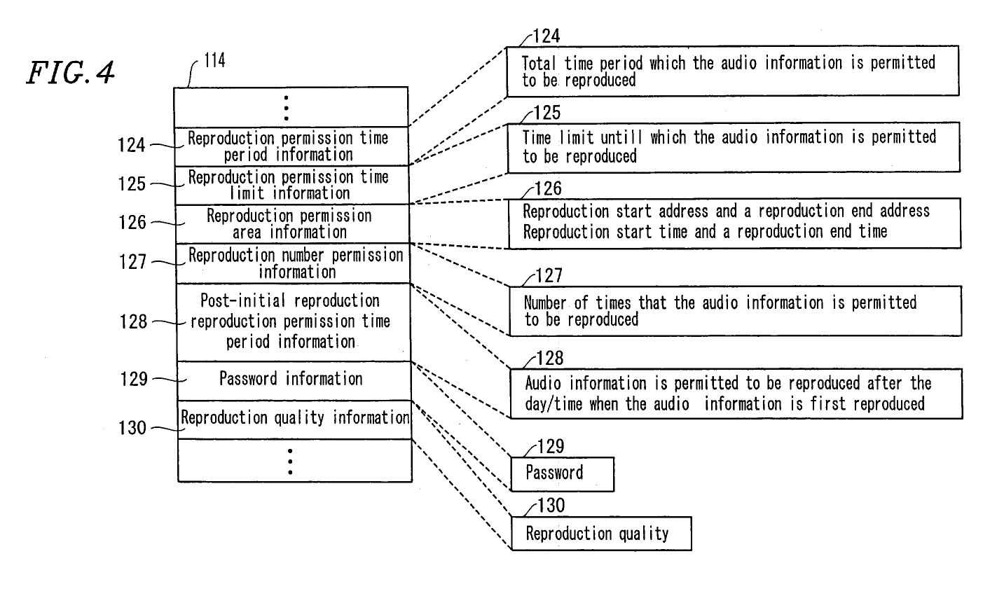

The audio reproduction restriction information 114 included in the audio copyright information 110 represents reproduction conditions of the audio information (i.e., restricts reproduction of the audio information). As shown in FIG. 4, the audio reproduction restriction information 114 includes at least one of reproduction permission time period information 124, reproduction permission time limit information 125, reproduction area permission information 126, reproduction number permission information 127, post-initial reproduction reproduction permission time period information 128, password information 129, and reproduction quality information 130. These pieces of information included in the audio reproduction restriction information 114 are each permission information which represents reproduction conditions of the audio information.

The reproduction permission time period information 124 represents a total time period in which the audio information is permitted to be reproduced, and represents the time period by units of, for example, hours/minutes/seconds. The reproduction permission time limit information 125 indicates that the audio information is permitted to be reproduced until a certain day or time, and represents, for example, the time limit until which the audio information is permitted to be reproduced. The reproduction area permission information 126 represents the area of the information recording medium 100 which is permitted to be reproduced, and represents, for example, a reproduction start address and a reproduction end address of the area which is permitted to be reproduced. Alternatively, the reproduction area permission information 126 represents a reproduction start time and a reproduction end time of the area of the audio information which is permitted to be reproduced. The reproduction number permission information 127 represents the number of times that the audio information is permitted to be reproduced. The post-initial reproduction reproduction permission time period information 128 represents the time period in which the audio information is permitted to be reproduced after the day/time when the audio information is first reproduced. The password information 129 indicates that the user is required to input his/her password for reproduction of the audio information, and includes a specific password. The reproduction quality information 130 specifies the reproduction quality, for example, monaural and CD sound quality reproduction.

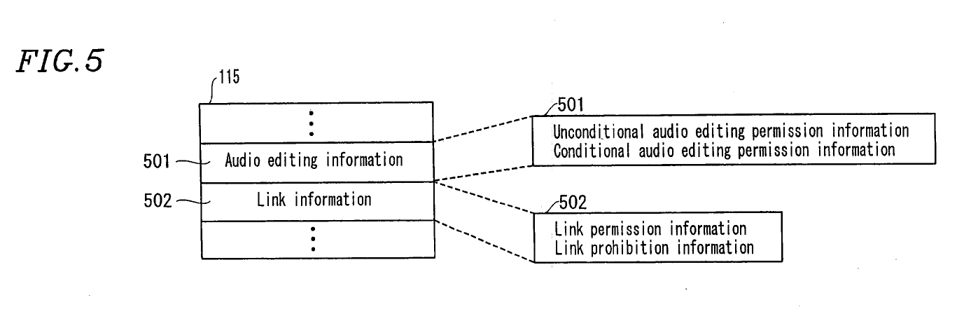

The audio editing restriction information 115 included in the audio copyright information 110 relates to editing of the audio information managed based on the audio management information 104, 105 or 106, or a change in the link between the audio information and the still picture information. As shown in FIG. 5, the audio editing restriction information 115 includes audio editing information 501 and link information 502. The audio editing information 501 includes unconditional audio editing permission information which indicates that the audio information is permitted to be edited in any way, or conditional audio editing permission information which indicates that the audio information is prohibited from being divided or combined with other audio information. The link information 502 includes link permission information which indicates that the current link between the audio. information and the still picture information is permitted to be deleted or a new link is permitted to be added, or link prohibition information which indicates that the current link between the audio information and the still picture information is prohibited from being deleted or a new link is prohibited from being added.

Returning to FIG. 2, the still picture copyright information 111 includes still picture inherent information 116, still picture copy control information 117, still picture reproduction restriction information 118, and still picture editing restriction information 119.

The still picture inherent information 116 is used for uniquely specifying the still picture information, and includes, for example, exactly the same or partially the same information as that of the audio inherent information of the audio information to be linked with the still picture information.

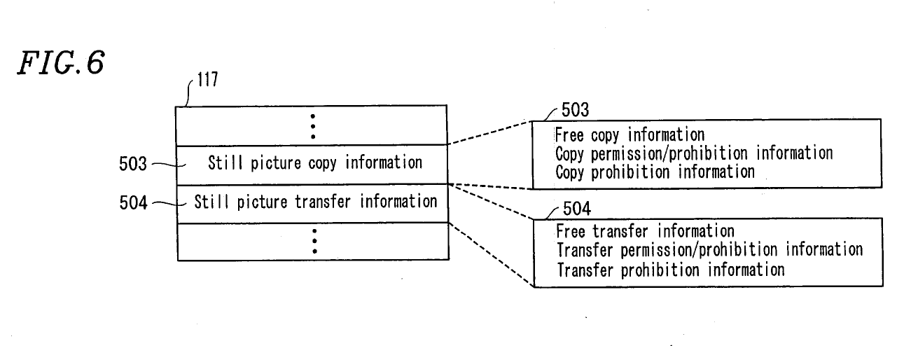

The still picture copy control information 117 relates to copying and transfer of the still picture information. As shown in FIG. 6, the still picture copy control information 117 includes still picture copy information 503, and still picture transfer information 504.

The still picture copy information 503 relates to copy permission or prohibition of the still picture information, and includes (i) free copy information which indicates that the still picture information can be permitted to be copied with no restriction, (ii) copy permission/prohibition information which indicates that copy permission/prohibition of the still picture information is conformed to the audio copy information 120 (FIG. 3) of the audio information linked to the still picture information, or (iii) copy prohibition information which indicates that the still picture information is prohibited from being copied. When the still picture copy information 503 includes the copy permission/prohibition information and the audio copy information 120 includes the free copy information, the still picture information is permitted to be copied with no restriction. When the still picture copy information 503 includes the copy permission/prohibition information and the audio copy information 120 includes the copy prohibition information, the still picture information is prohibited from being copied. When the still picture copy information 503 includes the copy permission/prohibition information and the audio copy information 120 includes the one-generation copy permission information, the still picture information is permitted to be copied when the audio information is permitted to be copied. When the still picture copy information 503 includes the copy permission/prohibition information but there is no audio information which is linked to the still picture, the still picture information is prohibited from being copied.

The still picture transfer information 504 relates to transfer permission or prohibition of the still picture information, and includes (i) transfer permission information which indicates that transfer of the of the still picture information is permitted, (ii) transfer permission/prohibition information which indicates that transfer permission/prohibition of the still picture information is conformed to the audio copy information 121 (FIG. 3) of the audio information linked to the still picture information, or (iii) transfer prohibition information which indicates that the still picture information is prohibited from being transferred. When the still picture transfer information 504 includes the transfer permission/prohibition information and the audio transfer information 121 includes the transfer permission information, the still picture information is permitted to be transferred when the audio information is transferred. When the still picture transfer information 504 includes the transfer permission/prohibition information and the audio transfer information 121 includes the transfer prohibition information, the still picture information is prohibited from being transferred. When the still picture transfer information 504 includes the transfer permission/prohibition information but there is no audio information which is linked to the still picture, the still picture information is prohibited from being transferred.

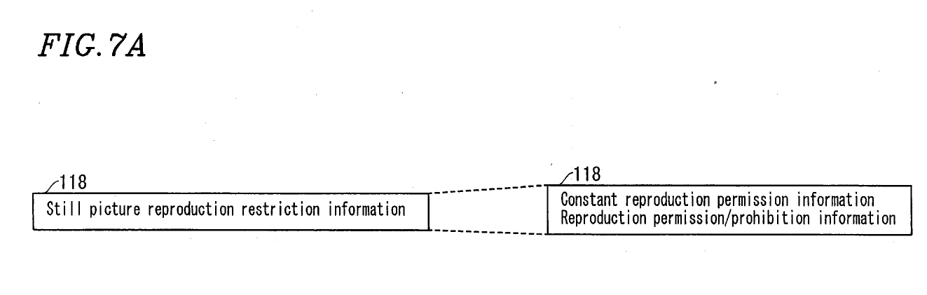

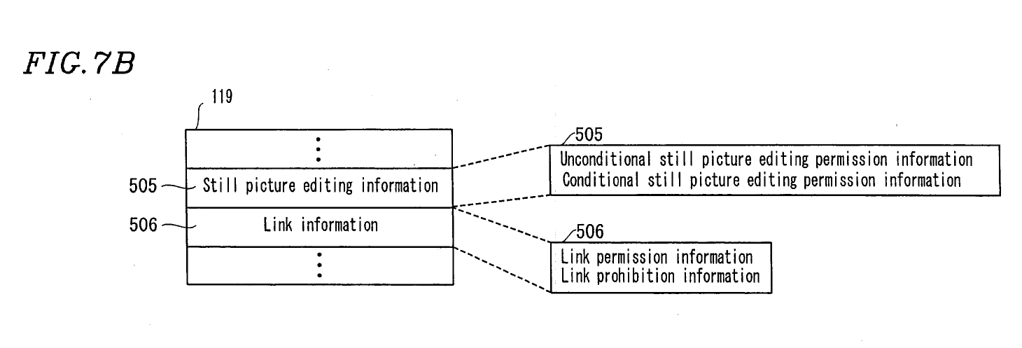

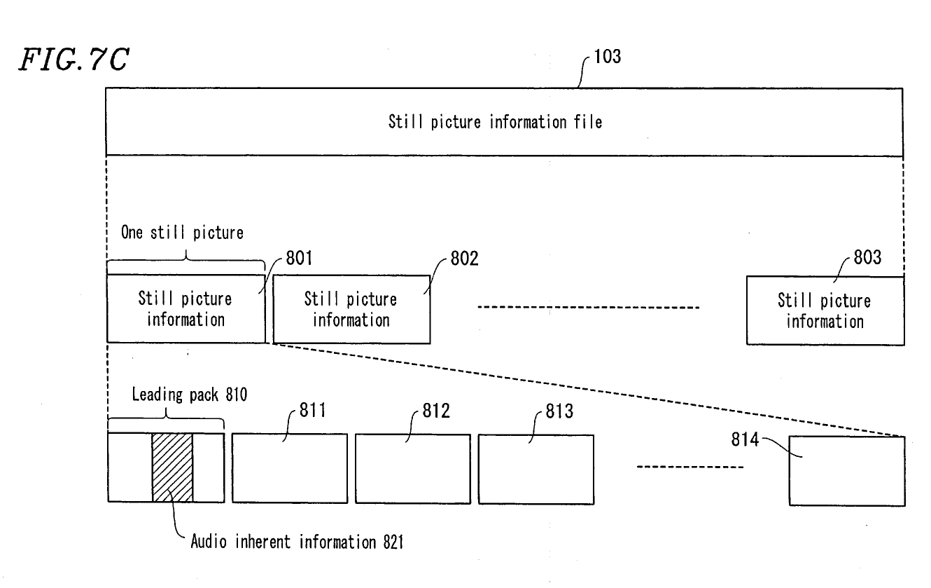

The still picture reproduction restriction information 118 included in the still picture copyright information 111 represents reproduction conditions of the still picture information (i.e., restricts reproduction of the still picture information). As shown in FIG. 7A, the still picture reproduction restriction information 118 includes constant reproduction permission information, or reproduction permission/prohibition information. The constant reproduction permission information indicates that the still picture information is constantly permitted to be reproduced regardless of whether or not the audio information which is linked to the still picture information associated with the still picture reproduction restriction information 118 is permitted to be reproduced by the audio reproduction restriction information 114. There production permission/prohibition information indicates that the still picture information is permitted to be reproduced only when the audio information which is linked to the still picture information associated with the still picture reproduction restriction information 118 is permitted to be reproduced by the audio reproduction restriction information 114. The reproduction permission/prohibition information also indicates that when there is no audio information linked to the still picture information, the still picture information is prohibited from being reproduced.

The still picture editing restriction information 119 included in the still picture copyright information 111 relates to editing of at least one piece of still picture information managed by the still picture management information 107, 108 or 109, or changing of the link between the audio information and at least one piece of still picture information. As shown in FIG. 7B, the still picture editing restriction information 119 includes still picture editing information 505 and link information 506. The still picture editing information 505 includes unconditional still picture editing permission information, or conditional still picture editing permission information. The unconditional still picture editing permission information indicates that the following, for example, is permitted: addition of a new piece of still picture information to the at least one piece of still picture information managed by the still picture management information 107, 108 or 109, deletion of the still picture information, and a change in the reproduction order of the still picture information. The conditional still picture editing permission information indicates that the following, for example, is prohibited: addition of a new piece of still picture information to the at least one piece of still picture information managed by the still picture management information 107, 108 or 109, deletion of the still picture information, and a change in the reproduction order of the still picture information. The link information 506 includes link permission information which indicates that the current link between the audio information and the still picture information is permitted to be deleted or a new link is permitted to be added, or link prohibition information which indicates that the current link between the audio information and the still picture information is prohibited from being deleted or a new link is prohibited from being added.

The information recording medium 100 may include text information linked to the audio information, in addition to the still picture information. In this case, the text information is included in the management information file 101 or a dedicated text information file (not shown). The management information file 101 includes text management information regarding the text information. The text management information includes, for example, information representing the type of character code used for the text information. The text management information also includes text copyright information having a similar data structure to that of the still picture copyright information 111 (FIG. 2).

The information recording medium 100 may have moving picture information or the like in addition to the audio information, the still picture information, and the text information.

The still picture information file 103 includes at least one piece of still picture information. As shown in FIG. 7C, the still picture information file 103 includes still picture information 801, 802, and 803, each of which is recorded on the information recording medium 100 as being divided into a plurality of partial information pieces. Each information piece has a data structure referred to as a “pack” having a certain number of bytes. This will be described regarding the still picture information 801, for example. The still picture information 801 is recorded as being divided into a plurality of packs 810, 811, 812, 813, . . . 814. The leading pack 810 includes audio inherent information 821 for specifying the audio information which is linked to the still picture information 801. The audio inherent information 821 corresponds to the audio inherent information 112 included in the audio copyright information shown in FIG. 2, and represents the same information as that of the audio inherent information 112.

For example, when the user purchases an information content including a plurality of pieces of still picture information and a plurality of pieces of audio information through electronic music distribution and records the information content on the information recording medium 100, the leading pack of each piece of still picture information includes audio inherent information of the audio information corresponding to each piece of still picture information.

When the user records still picture information photographed by a digital still camera on the information recording medium 100, an area of the leading pack of the still picture information, which is provided for audio inherent information, includes a value (default value) indicating that there is no audio information linked to the still picture information. The default value is, for example, “0” data.

Moving picture information may be linked to the still picture information instead of the audio information. In this case, the leading pack of the still picture information includes inherent information for specifying the moving picture information. In the case where the text information is linked to the audio information instead of the still picture information, the text information is recorded on the information recording medium 100 in substantially the same state as that of the still picture information, and the leading pack of the text information includes audio inherent information.

According to Example 1, audio information, still picture information, and text information are handled in conformance with the copy restriction and reproduction restriction.

Since the information recording medium 100 includes information regarding information editing permission/prohibition, audio information, still picture information and text information are protected against editing not intended by the copyright proprietor.

### Example 2

According to Example 2 of the present invention, reproduction restriction information recorded on the information recording medium 100 (FIG. 1) indicates that reproduction of information (for example, audio information) is restricted by the combination of a plurality of types of restriction. For example, the information recording medium 100 includes the audio reproduction restriction information 114 (FIG. 2). The audio reproduction restriction information 114 includes at least two of the reproduction permission time period information 124, the reproduction permission time limit information 125, the reproduction area permission information 126, the reproduction number permission information 127, the post-initial reproduction reproduction permission time period information 128, the password information 129, and the reproduction quality information 130.

When the reproduction restriction information 114 includes a plurality of pieces of permission information, the reproduction conditions of the audio information are determined based on the type of permission represented by the combination of the plurality of pieces of permission information. For example, when the reproduction restriction information 114 includes the reproduction permission time limit information 125 and the reproduction permission time period information 124, and the reproduction permission time limit information 125 indicates that the reproduction is permitted until September 2002 and the reproduction permission time period information 124 indicates that reproduction is permitted for a maximum of 10 minutes, the audio information is permitted to be reproduced for up to 10 minutes until September 2002.

The information to be recorded on or reproduced from the information recording medium 100 may be moving picture information, still picture information, text information or other types of information.

According to Example 2, reproduction restriction is set in more detail by combining a plurality of pieces of permission information.

### Example 3

According to Example 3 of the present invention, the information recording medium 100 (FIG. 1) includes audio information and audio copyright information 110 for the audio information. The audio copyright information 110 includes audio copy information 120 and audio transfer information 121.

The audio copy information 120 includes free copy information, one-generation copy permission information, or copy prohibition information. The audio transfer information 121 includes transfer permission information or transfer prohibition information.

When audio information which is not linked to the audio copy information 120 or the audio transfer information 121 is recorded on the information recording medium 100 like analog copying, the audio copy information 120 includes free copy information which indicates that the audio information can be permitted to be copied with no restriction, or one-generation copy permission information which indicates that a grandchild-generation copy of the audio information is prohibited from being made.

In the above-mentioned case, the audio transfer information 121 always includes transfer permission information which indicates that the audio information is permitted to be transferred. However, when the audio information is permitted to be copied, the audio transfer information 121 is treated as meaningless information. In other words, for recording audio information on another information recording medium, when the audio copy information 120 includes free copy information or one-generation copy permission information, the audio information is always recorded on the other information recording medium in the form of “copy”. When the audio copy information 120 includes copy prohibition information, the audio information is always recorded on the another information recording medium in the form of “transfer”.

Audio information which is associated with the audio copy information 120 is recorded on the information recording medium 100 as follows. Such audio information is, for example, audio information included in a CD. When the audio copy information 120 includes free copy information, the audio copy information 120 and the transfer permission information are recorded on the information recording medium 100 (as the audio transfer information 121). However, in this case, the audio transfer information 121 is treated as meaningless information. When the audio copy information 120 which was originally associated with the audio information includes one-generation copy permission information, copy prohibition information is recorded on the information recording medium 100 (as the audio copy information 120). In this case, transfer permission information or transfer prohibition information is recorded on the information recording medium 100 (as the audio transfer information 121).

Audio information which is associated with the audio transfer information 121 is recorded on the information recording medium 100 as follows. Such audio information is, for example, distributed by electronic music distribution. In this case, the audio transfer information 121 is recorded on the information recording medium 100, and copy prohibition information is recorded on the information recording medium 100 (as the audio copy information 120). Therefore, when the audio information is recorded on another information recording medium, the copy prohibition information is included as the audio copy information 120. Thus, the audio information is recorded on the another information recording medium in accordance with the audio transfer information 121. When transfer prohibition information is included in the audio transfer information 121, the copy prohibition information is always recorded on the information recording medium 100 as the audio copy information 120.

According to Example 3, the patterns of combining the audio copy information 120 and the audio transfer information 121 are limited. In general, when audio information is permitted to be copied, the transfer technique is not used instead of copying. When transfer is prohibited, copying is not permitted. Since combinations of information which are not generally used are excluded, copying and transfer can be handled more easily by a reproduction apparatus, and a recording and reproduction apparatus.

### Example 4

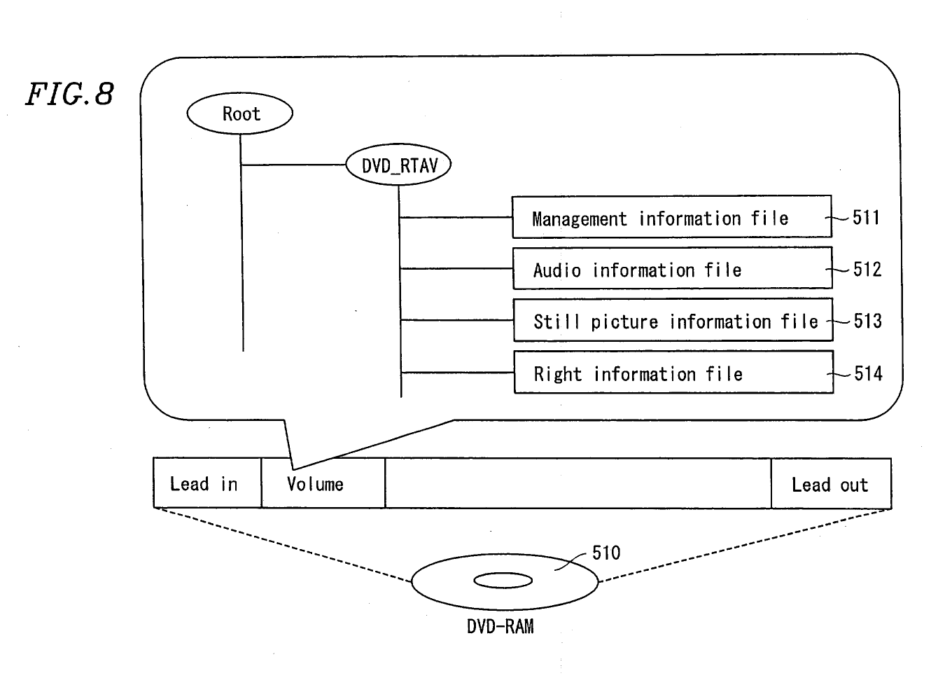

FIG. 8 shows an information recording medium 510 according to Example 4 of the present invention. The information recording medium 510 is, for example, a DVD-RAM disc. The information recording medium 510 includes an audio information file 512 including audio information, a still picture information file 513 including still picture information, a management information file 511 including management information for managing reproduction of the audio information and the still picture information, and a right information file 514 including copyright information representing copyright regarding the audio information and the still picture information.

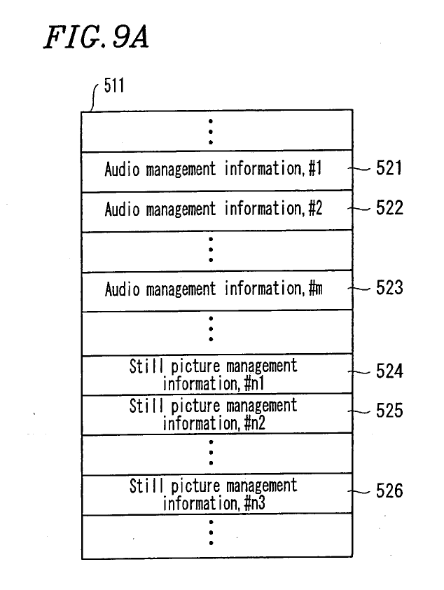

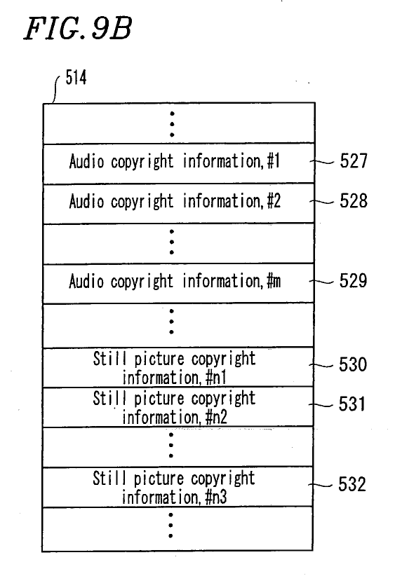

As shown in FIG. 9A, the management information file 511 includes audio management information 521, 522 and 523, and still picture management information 524, 525 and 526. The audio information included in the audio information file 512 includes a plurality of pieces of partial audio information, each of which is a zone of the audio information. Each of audio management information 521, 522 and 523 relates to the respective partial. audio information, and includes audio attribute information and a recording start address of the audio information. The partial audio information is, for example, audio information corresponding to one song.

The still picture information included in the still picture information file 513 includes a plurality of pieces of partial still picture information, each of which is a zone of the still picture information. Each of still picture management information 524, 525 and 526 relates to the respective partial still picture information, and includes still picture attribute information and a recording start address of the still picture information. The partial still picture information is, for example, still picture information representing at least one still picture which is displayed while audio information representing a song (partial audio information) is being reproduced. The audio management information 521, 522 and 523, and still picture management information 524, 525 and 526, are each provided with a number of “1” or greater as inherent information for identifying the information. The number is provided in the recording order of the audio management information, and in the recording order of the still picture management information. The number of “1” or greater is, for example, a positive serial number (#1, #2, . . . , #m).

As shown in FIG. 9B, the right information file 514 includes audio copyright information 527, 528 and 529, and still picture copyright information 530, 531 and 532. The audio copyright information 527, 528 and 529, and still picture copyright information 530, 531 and 532, are each provided with a number of “1” or greater as inherent information for identifying the information.

The audio management information 521, 522 or 523, and the audio copyright information 527, 528 or 529, which correspond to common partial audio information are provided with the same inherent information (i.e., the same number). The still picture management information 524, 525 or 526, and the still picture copyright information 530, 531 or 532, are provided with the same inherent information (i.e., the same number). Each of the audio copyright information 527, 528 and 529 includes copyright information regarding partial audio information which is managed by the audio management information having the same inherent information. Each of the still picture copyright information 530, 531 and 532 includes copyright information regarding partial still picture information which is managed by the still picture management information having the same inherent information. The audio copyright information and the still picture copyright information include the same type of information as in Example 1.

The information recording medium 510 may include text information linked to the audio information, in addition to the still picture information. In this case, the text information is included in the management information file 511 or a dedicated text information file (not shown). The management information file 511 includes text management information regarding the text information. The right information file 514 includes text copyright information having a similar data structure to that of the still picture copyright information, as copyright information representing copyright regarding the text information.

The information recording medium 510 may have moving picture information or the like in addition to the audio information, the still picture information, and the text information.

According to Example 4, the management information, the audio information, the still picture information, and the copyright information are included in separate files. (In other words, the copyright information is recorded in a different area of the information recording medium 510 from the areas in which the management information, the audio information, and the still picture information are recorded.) Owing to such a structure, the right information file 514, among the plurality of files, can be encrypted for copyright protection. This is advantageous for the following reason. Usually, the management information file is not encrypted so as to allow the reproduction apparatus to easily read the management information. Therefore, when the management information file includes copyright information, there is a risk that the copyright information can be illegally changed. According to Example 4, copyright information is included in a separate file from the management information. Therefore, the copyright information can be encrypted and thus protected more securely.

### Example 5

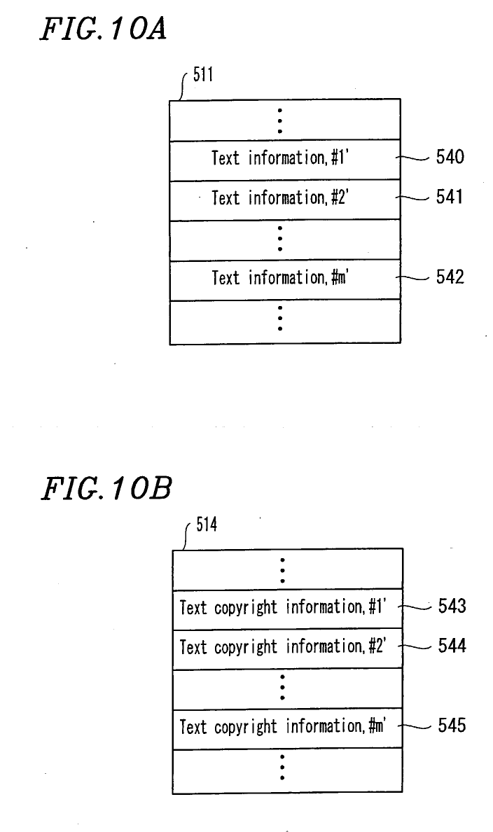

Example 5 of the present invention is a modification of the information recording medium 510 in Example 4. As shown in FIG. 10A, the management information file 511 included in the information recording medium 510 (FIG. 8) includes text information 540, 541 and 542, and the right information file 514 includes text copyright information 543, 544 and 545.

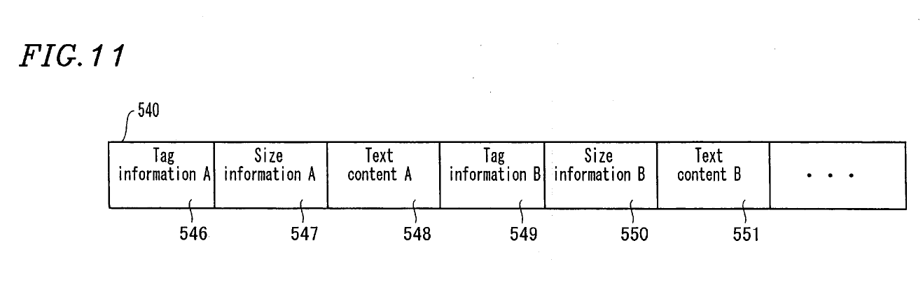

Each of the text information 540, 541 and 542 is provided with a serial number (#1′, #2′, . . . #m′) as inherent information for identifying the information. Each of the text information 540, 541 and 542 includes a text content associated with audio information representing a song or a play list (list of audio information representing at least one song). For example, as shown in FIG. 11, the text information 540 includes tag information A 546 representing the type of the text, size information A 547 representing data size of the text, and a text content A 548 representing actual text. One piece of text information may include a plurality of information sets, each of which includes the above-mentioned three types of information (FIG. 11). For example, the text information 540 may further include tag information B 549, size information B 550, and a text content B551. When the text information 540 is associated with audio information representing a song, the tag information A 546 represents a tag showing the song title, the text content A 548 represents the song title, the tag information B 549 represents a tag showing the lyrics, and the text content B 551 represents information on the lyrics.

As shown in FIG. 10B, the text copyright information 543, 544 and 545 included in the right information file 514 is provided with a serial number (#1′, #2′, . . . #m′) as inherent information for identifying the information. The copyright represented by each of the text copyright information 543, 544 and 545 relates to the text information provided with the same number as the inherent information. The copyright can be applied to only the text content specified by a specific tag information in the corresponding text information. For example, it is assumed that the text copyright information is applied only to the lyrics information, the text information 542 includes a text content showing the song title and a text content showing the lyrics, and the text copyright information 545 includes copy prohibition information. In this case, the text content showing the lyrics of the text information 542 is prohibited from being copied but the test content showing the song title is permitted to be copied.

In the case of audio information and still picture information, copyright can be applied to only a part of the data. In the case where copyright management information is associated with audio information recorded on the information recording medium 510, the copyright can be applied to the audio information which shows a certain play list or a song, or a part of the audio information which shows a certain index or a part of a song. In the case where copyright management information is associated with one play list, the copyright can be applied to a song in the play list, an index, or a part of the song. In the case where copyright management information is associated with audio information representing one song, the copyright can be applied to an index or a part of the song.

In the case where copyright management information is associated with still picture information recorded on the information recording medium 510, the copyright can be applied to still picture information which is linked to the audio information which shows a certain play list or a song. In the case where copyright management information is associated with still picture information which is linked to audio information representing one play list or one song, the copyright can be applied to still picture information linked to a song in the play list, or still picture information representing at least one specific still picture linked to the audio information.

According to Example 5, copyright is managed regarding a part of a text content included in text information. This is advantageous for the following reason. When copyright is applied to the entirety of text information including text contents representing the song title, lyrics and the like, if the copyright information includes conditional editing permission information which prohibits editing other than deletion, the song title is prohibited from being edited as well as the lyrics. For example, in the case where the text information recorded on the information recording medium 100 is in Japanese but the reproduction apparatus displays only the English alphabet, the user may want to display at least the song title in the English alphabet, but this is not permitted. According to Example 4, the text contents representing the minimum necessary information such as the song title, the name of the singer, and the like can be excluded from the target of copyright protection, so that the other text contents are copyright-protected. This is very convenient for users.

### Example 6

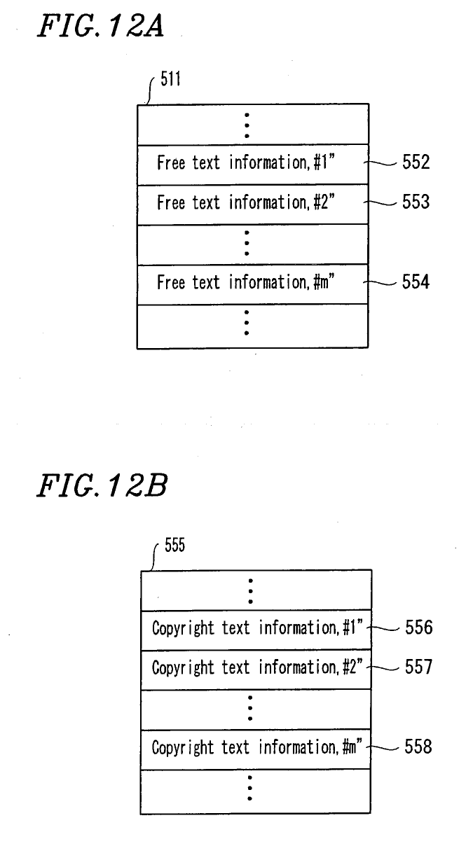

Example 6 of the present invention is a modification of the information recording medium 510 in Example 4. As shown in FIG. 12A, the management information file 511 included in the information recording medium 510 (FIG. 8) further includes free text information 552, 553 and 554 which are not copyright-protected. The information recording medium 510 further includes a text information file 555. As shown in FIG. 12B, the text information file 555 includes copyright text information 556, 557 and 558 which are copyright-protected. Each of the free text information 552, 553 and 554, and each of the copyright text information 556, 557 and 558, is provided with a serial number (#1″, #2″, . . . #m″) as inherent information for identifying the information.

Each of the free text information 552, 553 and 554, includes a text content associated with audio information representing a song or a play list. Each of the copyright text information 556, 557 and 558 includes a text content associated with audio information representing a song or a play list.

Like the text information 540 shown in FIG. 131, each of the free text information 552, 553 and 554, and each of the copyright text information 556, 557 and 558, includes at least one set of tag information, size information, and a text content. The text content included in each of the free text information 552, 553 and 554 represents a text which does not need to be copyright-protected, for example, the song title or the name of the singer. The text content included in each of the copyright text information 556, 557 and 558 represents a text which is copyright-protected, for example, lyrics or liner notes.

According to Example 6, the copyright text information including a text content representing the lyrics or the like is recorded in the dedicated text information file 555, and the text information file 555 is encrypted for protecting the copyright of the text content. The free text information including a text content representing the song title or the name of the singer is included in the management information file 511. Since the management information file 511 is usually not encrypted for easier reading of the information by a reproduction apparatus, the text information included in the management information file 511 is not encrypted either. This does not provide any problem since the information which does not need to be copyright-protected, such as the song title or the name of the singer, does not need to be encrypted. Rather, it alleviates the load on the reproduction apparatus to include the song title or the name of the singer in the management information file 511 for the following reason. Since the management information file 511 is always recorded in a memory of the reproduction apparatus, the song title or the name of the singer does not need to be read from the information recording medium 510 for displaying or retrieving a menu of songs.

In the case of audio information and still picture information, a part of the information can be included in the management information file 511 and the rest is included in each dedicated file. For example, in the case of audio information, audio information representing a play list or a memorable part of the song can be copied and included in the management information file 511. This is useful for retrieving the play list or the song. In the case of still picture information, the still picture information which is representative of a play list or a song (for example, thumb nails) can be included in the management information file 511. This is useful for displaying the menu screen.

### Example 7

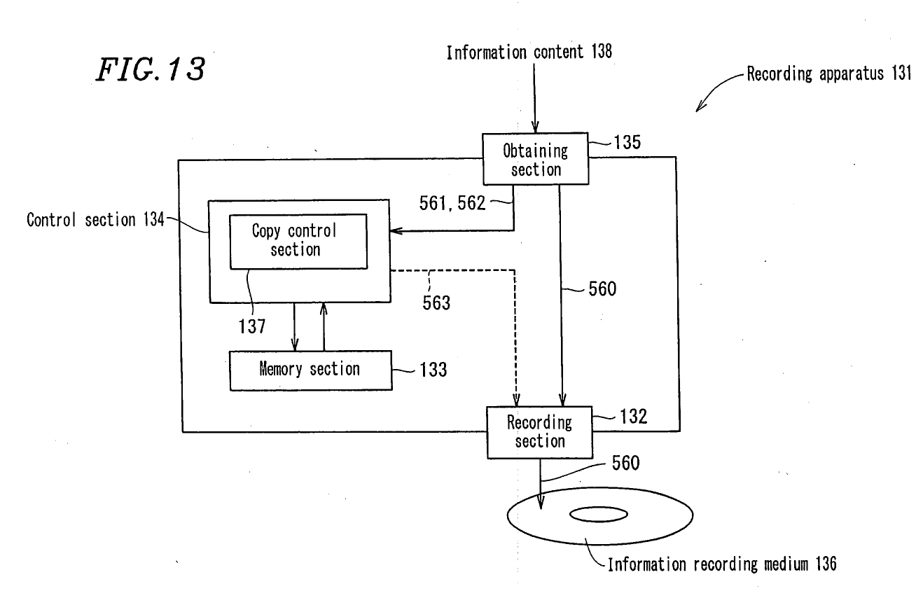

FIG. 13 shows a recording apparatus 131 according to Example 7 of the present invention. As shown in FIG. 13, the recording apparatus 131 includes a recording section 132, a memory section 133, a control section 134, and an obtaining section 135. The control section 134 includes a copy control section 137. An information content 138 includes audio information 560, inherent information 561 for specifying the audio information 560, and a copy number information 562 representing the number of times that the audio information 560 is permitted to be copied. The recording apparatus 131 obtains the information content 138 and records at least the audio information 560 on an information recording medium 136. The control section 134 controls the recording section 132 by outputting a control signal 563 to the recording section 132.

Upon obtaining the information content 138 from an information source such as, for example, electronic distribution, the obtaining section 135 outputs the copy number information 562 and the inherent information 561 to the control section 134, and outputs the audio information 560 to the recording section 132. The copy control section 137 in the control section 134 checks whether or not the inherent information 561 has been recorded in the memory section 133. When it is determined that the inherent information 561 has not been recorded in the memory section 133, the control section 134 records the inherent information 561 and remaining copy number information as a pair in the memory section 133, and the recording section 132 records the audio information 560 on the information recording medium 136. The remaining copy number information represents a remaining copy number which is obtained by subtracting 1from the number of times that the audio information 560 is permitted to be copied represented by the copy number information 562.

When it is determined that the inherent information 561 has been recorded in the memory section 133, the control section 134 reads the remaining copy number information recorded as a pair with the inherent information 561 from the memory section 133, and determines whether or not the read remaining copy number is a positive value. When the remaining copy number is a positive value, the control section 134 records the value obtained by subtracting 1 from the remaining copy number, and the recording section 132 records the audio information 560 on the information recording medium 136. When the remaining copy number is not a positive value, the control section 134 prohibits the recording section 132 from recording the audio information 560 on the information recording medium 136.

According to the above-described procedure executed by the recording apparatus 131, in summary, the remaining copy number is recorded in the memory section 133, and when the remaining copy number becomes zero as a result of performing copying of the audio information 560, copying is prohibited. Alternatively, the number of times that the audio information 560 has been copied may be recorded in the memory section 133. In this case, the number of times is incremented each time the audio information 560 is copied, and when the number of times reaches the number of times that the information content 138 is permitted to be copied, copying is prohibited.

According to Example 7, in the case where audio information which is permitted to be copied up to a certain number of times, the copy number can be managed for each recording apparatus.

Instead of audio information, moving picture information, still picture information, text information or other types of information may be obtained by the recording apparatus 131 and recorded on the information recording medium 136. The inherent information 561 is, for example, an ISRC code.

### Example 8

A reproduction apparatus according to Example 8 of the present invention includes a reading section for reading information from an information recording medium, and an output section for outputting the information.

The information recording medium includes audio information, audio copy control information regarding the audio information, and inherent information for specifying the audio information. The reproduction apparatus outputs these types of information so as to be copied on another information recording medium. In this case, the reading section reads the audio information, the audio copy control information, and the inherent information from the information recording medium. The output section outputs these types of information to the another recording apparatus.

Instead of audio information, moving picture information, still picture information, text information or other types of information may be read from the information recording medium and output to another information recording medium. The audio copy control information includes, for example, one-generation copy permission information which prohibits a grandchild-generation copy from being made, or copy number information. The inherent information is, for example, an ISRC code attached to the audio information.

According to Example 8, both the inherent information and the audio copy control information are output from the reproduction apparatus. Even when the copy information needs to be managed for each recording apparatus, the audio copy control information can be copied to another information recording medium using the recording apparatus and the reproduction apparatus according to this example.

### Example 9

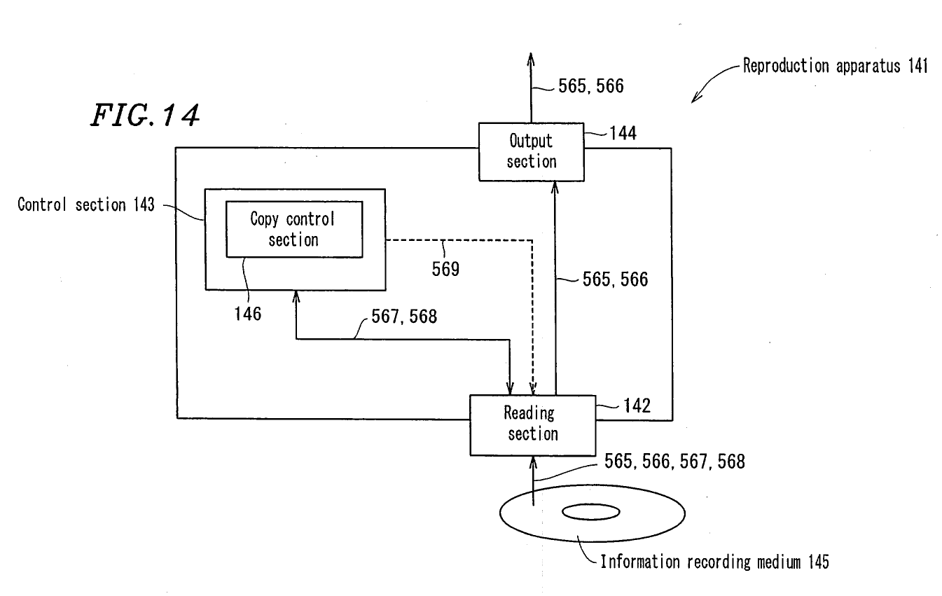

FIG. 14 shows a reproduction apparatus 141 according to Example 9. As shown in FIG. 14, the reproduction apparatus 141 includes a reading section 142 for reading information from an information recording medium 145, a control section 143, and an output section 144 for outputting information. The control section 143 includes a copy control section 146. The information recording medium 145 includes first information 565, second information 566, first copy information 567 regarding the first information 565, and second copy information 568 regarding the second information 566. The control section 143 controls the reading section 142 by outputting a control signal 569 to the reading section 142.

For reading information from the information recording medium 145 to be copied to another information recording medium, the reading section 142 reads the first and second copy information 567 and 568 from the information recording medium 145 and outputs both types of information to the control section 143. When the copy control section 146 included in the control section 143 determines that the second copy information 568 is copy permission/prohibition information which indicates that the copying of the second information 566 is permitted or prohibited in conformance with whether the first copy information 567 permits or prohibits copying of the first information 565, and that the first copy information 567 permits the first information 565 to be copied with no restriction, the copy control section 146 permits the reading section 142 to read the second information 566 and permits the output section 144 to output the information.

When it is determined that the second copy information 568 is copy permission/prohibition information, but that the first copy information 567 prohibits a copy from being made, the copy control section 146 controls the reading section 142 so as not to read the first information 565 and the second information 556.

When it is determined that the second copy information 568 is copy permission/prohibition information, and that the first copy information 567 is one-generation copy permission information which prohibits a grandchild-generation copy from being made, the copy control section 146 controls the reading section 142 and the output section 144 such that, when copying the second information 566, the reading section 142 reads the first and second information 565 and 566 and the output section 144 outputs the two types of information.

Each of the first and second information 565 and 566 is, for example, audio information, moving picture information, still picture information, text information or other types of information. Each of the first and second copy information 567 and 568 is, for example, audio copy information or still picture copy information.

According to Example 9, the following advantages are provided. When the user purchases an information content including audio information and still picture information via electronic distribution or the like, the following control is performed: in the case where the still picture copy information is copy permission/prohibition information, when copying the still picture information, audio information is necessarily copied. Therefore, the intention of the distributor that the audio information and the still picture information are always handled as a pair can be correctly reflected. When text information is distributed instead of, or together with the still picture information, the text information is handled in the same manner as the still picture information.

### Example 10

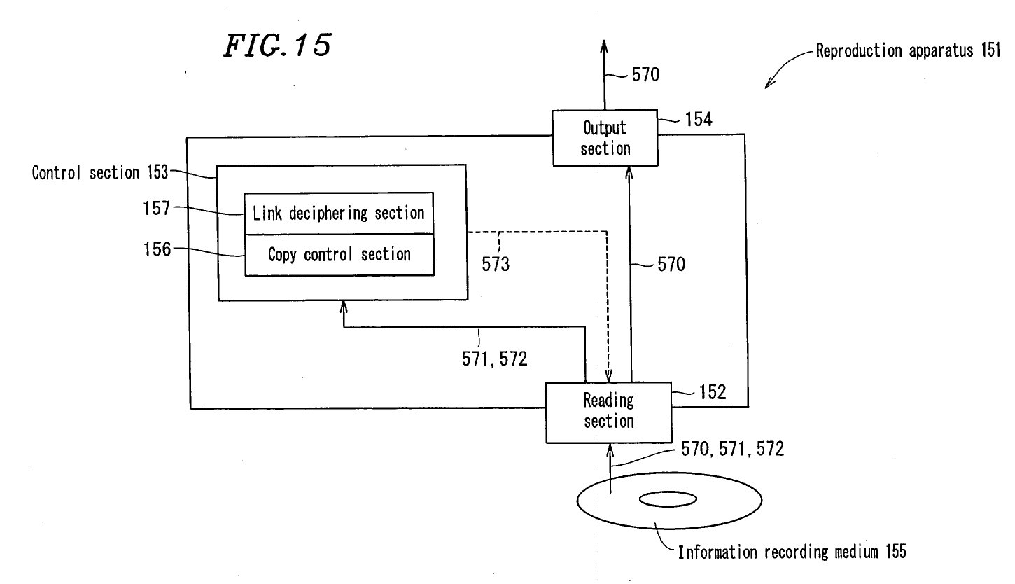

FIG. 15 shows a reproduction apparatus 151 according to Example 10 of the present invention. As shown in FIG. 15, the reproduction apparatus 151 includes a reading section 152, a control section 153, and an output section 154. The control section 153 includes a copy control section 156 and a link deciphering section 157.

An information recording medium 155 includes first information 570, copy information 571 regarding the first information 570, and management information 572 for managing reproduction of the first information 570. The control section 153 controls the reading section 152 by outputting a control signal 573 to the reading section 152.

For reading information from the information recording medium 155 to be copied to another information recording medium, the reading section 152 reads the management information 572 and first copy information 571 from the information recording medium 155 and outputs both types of information to the control section 153. When the copy control section 156 included in the control section 153 determines that the first copy information 571 is copy permission/prohibition information, and it is determined that the first information 570 is not linked to any other information as a result of deciphering of the management information 572 by the link deciphering section 157, the control section 153 controls the reading section 152 not to read the first information 570 to be copied. When the first copy information 571 is copy permission/prohibition information, and the first information 570 is linked to other information, the first information 570 which is read by the reading section 152 is output together with the other information by the output section 154. The first information 570 is, for example, audio information, moving picture information, still picture information, text information, or other types of information.

According to Example 10, the following advantages are provided. When the user purchases an information content including audio information and still picture information via electronic distribution or the like, and when the still picture copy information is copy permission/prohibition information, even if the link between the audio information and the still picture information is deleted, the still picture information cannot be copied separately from the audio information. As a result, the still picture information cannot be copied independently to be reused for other audio information. Therefore, the intention of the distributor that the audio information and the still picture information are always handled as a pair can be correctly reflected. When text information is distributed instead of, or together with the still picture information, the text information is handled in the same manner as the still picture information.

### Example 11

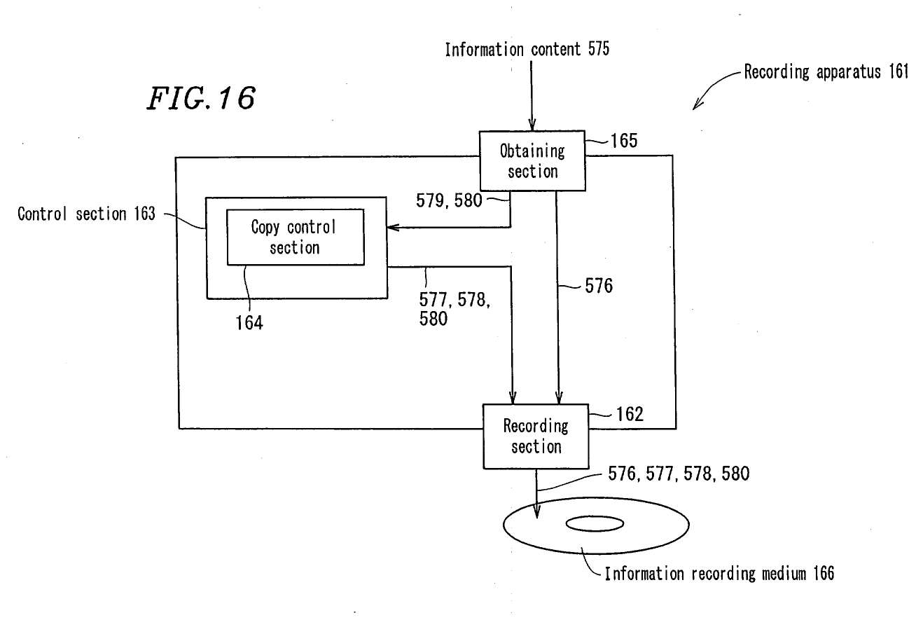

FIG. 16 shows a recording apparatus 161 according to Example 11 of the present invention. As shown in FIG. 16, the recording apparatus 161 includes a recording section 162, a control section 163, and an obtaining section 164. The control section 163 includes a copy control section 166. The recording apparatus 161 obtains an information content 575 including at least audio information 576 and records the audio information 576 on an information recording medium 166.

Upon obtaining only the audio information 576 like an analog input, the obtaining section 165 outputs the audio information 576 to the recording section 162. The copy control section 164 outputs free copy information which permits the audio information 576 to be copied with no restriction or one-generation copy permission information which prohibits a grandchild-generation copy from being made, as audio copy information 577 regarding the audio information 576. The copy control section 164 also outputs transfer permission information which permits transfer of the audio information 576, as audio transfer information 578 regarding the audio information 576. The recording section 162 records the audio information 576, the audio copy information 577 input from the copy control section 164, and the audio transfer information 578 on the information recording medium 166.

Upon obtaining the audio information 576 and audio copy information 579 such as, for example, a copy from a CD or a DVD, the obtaining section 165 outputs the audio information 576 to the recording section 162 and outputs the audio copy information 579 to the copy control section 164. When the copy control section 164 included in the control section 163 determines that the audio copy information 579 is one-generation copy permission information, the copy control section 164 outputs copy prohibition information which prohibits the audio information 576 from being copied to the recording section 162 as audio copy information 577. The copy control section 164 also outputs transfer permission information or transfer prohibition information which prohibits the audio information 576 from being transferred to the recording section 162 as audio transfer information 578 regarding the audio information 576. When it is determined that the audio copy information 579 is free copy information, the copy control section 164 outputs free copy information to the recording section 162 as the audio copy information 577, and also outputs transfer permission information to the recording section 162 as the audio transfer information 578. The recording section 162 records the audio information 576, the audio copy information 577 input from the copy control section 164, and the audio transfer information 578 on the information recording medium 166.

Upon obtaining the audio information 576 and audio transfer information 580 such as a content purchased via electronic music distribution, the obtaining section 165 outputs the audio information 576 to the recording section 162 and outputs the audio transfer information 580 to the copy control section 164. The copy control section 164 outputs the obtained audio transfer information 580 to the recording section 162 as it is, and outputs copy prohibition information to the recording section 162 as the audio copy information 577 regardless of the audio transfer information 580. The recording section 162 records the audio information 576, audio copy information 577 input from the copy control section 164, and the audio transfer information 580 on the information recording medium 166. Instead of audio information, moving picture information, still picture information, text information or other types of information may be obtained by the recording apparatus 161 and recorded on the information recording medium 166.

According to Example 11, when one of, or neither of, audio copy information and audio transfer information is input when the audio information 576 is recorded, the information is complemented with the audio copy information and/or the audio transfer information and recorded on the information recording medium 166.

### Example 12

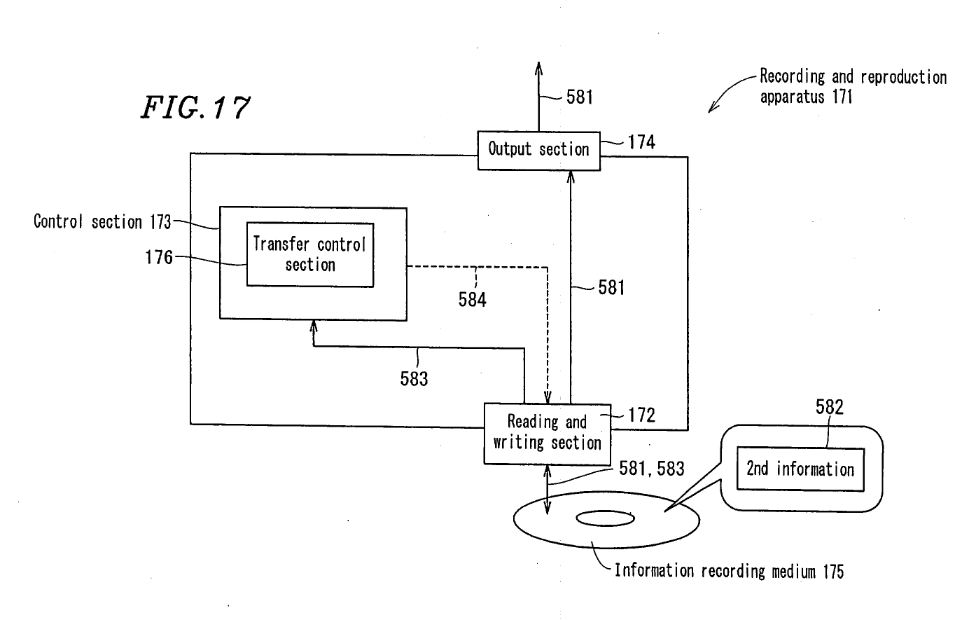

FIG. 17 shows a recording and reproduction apparatus 171 according to Example 12. As shown in FIG. 17, the recording and reproduction apparatus 171 includes a reading and writing section 172, a control section 173, and an output section 174. The control section 173 includes a transfer control section 176. An information recording medium 175 includes first information 581, second information 582 linked to the first information 581, and management information 583 for managing reproduction of the first information 581 and the second information 582. Each of the first information 581 and the second information 582 is, for example, audio information, moving picture information, still picture information, text information or other types of information. More specifically, the first information 581 is at least one of audio information and moving picture information, and the second information 582 is at least one of still picture information and text information. The management information 583 is, for example, audio management information or still picture management information.

For transferring the first information 581 from the information recording medium 175 to another information recording medium, the reading and writing section 172 reads the first information 581 and the management information 583 from the information recording medium 175 and outputs the first information 581 to the output section 174 and outputs the management information 583 to the control section 173. The transfer control section 176 included in the control section 173 deciphers the management information 583 so as to determine whether the second information 582 linked to the first information 581 which is to be transferred exists in the information recording medium 175. When it is determined that the second information 582 exists in the information recording medium 175, the transfer control section 176 controls the reading and writing section 172 such that the second information 582 is deleted from the information recording medium 175 as the first information 581 is transferred. The first information 581 is transferred as follows: the output section 174 outputs the first information 581 to an external apparatus having another information recording medium set therein, the transfer control section 176 controls the reading and writing section 172 to delete the first information 581 recorded on the information recording medium 175. The transfer control section 176 controls the reading and writing section 172 by outputting a control signal 584 to the reading and writing section 172.

The recording and reproduction apparatus 171 includes the reading and writing section 172 for both reading and writing of information. Alternatively, the recording and reproduction apparatus 171 may separately include a section for reading information and a section for writing information.

According to Example 12, when transferring only audio information of a content in which the audio information and still picture information are linked to each other, the still picture information is automatically deleted. This has the following advantages. In general, in the case of a content including audio information and still picture information which is purchased via, for example, electronic distribution, the still picture information is permitted to be reproduced only when the audio information is reproduced. Therefore, as long as the still picture information is deleted when only the audio information is transferred, the still picture information is prevented from being reproduced while being linked to another audio information. When text information is distributed instead of, or together with the still picture information, the text information is handled in the same manner as the still picture information.

### Example 13

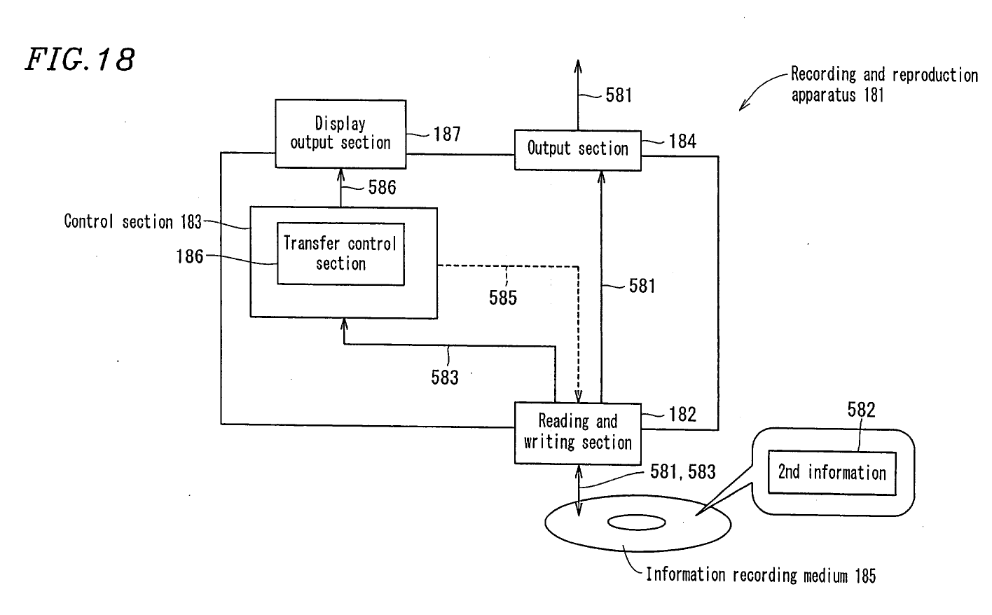

FIG. 18 shows a recording and reproduction apparatus 181 according to Example 13. As shown in FIG. 18, the recording and reproduction apparatus 181 includes a reading and writing section 182, a control section 183, an output section 184, and a display output section 187. The control section 183 includes a transfer control section 186. An information recording medium 185 includes first information 581, second information 582 linked to the first information 581, and management information 583 for managing reproduction of the first information 581 and the second information 582. Each of the first information 581 and the second information 582 is, for example, audio information, moving picture information, still picture information, text information or other types of information.

For transferring the first information 581 from the information recording medium 185 to another information recording medium, the reading and writing section 182 reads the first information 581 and the management information 583 from the information recording medium 185 and outputs the first information 581 to the output section 184 and outputs the management information 583 to the control section 183. The transfer control section 186 included in the control section 183 deciphers the management information 583 so as to determine whether the second information 582 linked to the first information 581 which is to be transferred exists in the information recording medium 185. When it is determined that the second information 582 exists in the information recording medium 185, the transfer control section 186 outputs a control signal 586 to the display output section 187. Upon receiving the control signal 586, the display output section 187 displays that the second information 582 is deleted from the information recording medium 185 as the first information 581 is transferred so as to warn the user. For transferring the first information 581 after the warning, the transfer control section 186 controls the reading and writing section 182 to delete the second information 582 from the information recording medium 185. The transfer control section 186 controls the reading and writing section 182 by outputting a control signal 585 to the reading and writing section 182.

The recording and reproduction apparatus 181 includes the reading and writing section 182 for both reading and writing of information. Alternatively, the recording and reproduction apparatus 181 may separately include a section for reading information and a section for writing information.

According to Example 13, when transferring only audio information, the user is notified that the still picture information linked to the audio information is automatically deleted. This has the following advantages. In general, when transferring only audio information of a content including the audio information and still picture information which is purchased via, for example, electronic distribution, the still picture information needs to be deleted. It is useful to warn the user of the deletion before the audio information is transferred. When text information is distributed instead of, or together with the still picture information, the text information is handled in the same manner as the still picture information.

### Example 14

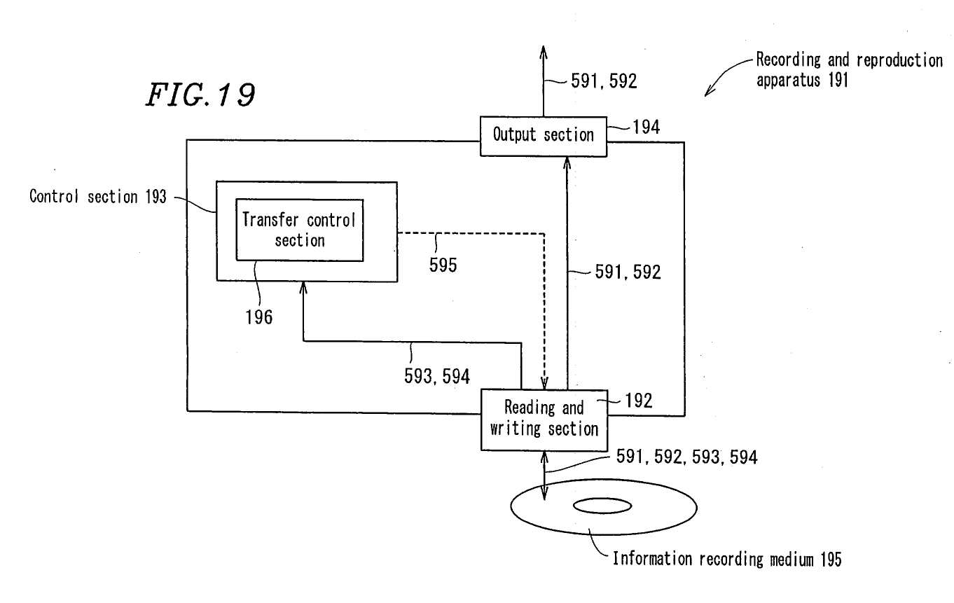

FIG. 19 shows a recording and reproduction apparatus 191 according to Example 14. As shown in FIG. 19, the recording and reproduction apparatus 191 includes a reading and writing section 192, a control section 193, and an output section 194. The control section 193 includes a transfer control section 196. An information recording medium 195 includes first information 591, second information 592 linked to the first information 591, first transfer information 593 regarding transfer of the first information 591, and second transfer information 594 regarding transfer of the second information 592. Each of the first information 591 and the second information 592 is, for example, audio information, moving picture information, still picture information, text information or other types of information. More specifically, the first information 591 is at least one of audio information and moving picture information, and the second information 592 is at least one of still picture information and text information. Each of the first transfer information 593 and the second transfer information 594 is, for example, audio transfer information or still picture transfer information.

For transferring the second information 592 from the information recording medium 195 to another information recording medium, the reading and writing section 192 reads the first information and second transfer information 593 and 594 from the information recording medium 195 and outputs both types of information to the control section 193. The transfer control section 196 included in the control section 193 determines the type of the first and second transfer information 593 and 594. When it is determined that the second transfer information 594 is transfer permission/prohibition information which represents that the second transfer information 592 is permitted or prohibited in conformance with whether the first transfer information 593 permits or prohibits transfer of the first information 591 and it is also determined that the first transfer information 593 permits the first information 591 to be permitted, the control section 193 transfers both the first and second information 591 and 592 when transferring the second information 592. In this case,the control section 193 controls the reading and writing section 192 so as to read the first and second information 591 and 592 and to prohibit reproduction of the first and second information 591 and 592 from the information recording medium 195 (e.g., delete the first and second information 591 and 592 from the information recording medium 195). The control section 193 controls the reading and writing section 192 by outputting a control signal 595 to the reading and writing section 192. The reading and writing section 192 outputs the read first and second information 591 and 592 to the output section 194. The output section 194 outputs the received first and second information 591 and 592 to an external apparatus having another information recording medium set therein.

When the transfer control section 196 determines that the second transfer information 594 is transfer permission/prohibition information and the first transfer information 593 prohibits transfer of the first information 591, the control section 193 controls the reading and writing section 192 so as not to read the first and second information 591 and 592 and thus prohibits transfer of the first and second information 591 and 592.

In the case where the recording and reproduction apparatus 191 is set such that, when the second information 592 is transferred, the first information 591 is necessarily transferred together with the second information 592, the operation of the reading and writing section 192 of reading the second transfer information 194 from the information recording medium 195 may be omitted.

The recording and reproduction apparatus 191 includes the reading and writing section 192 for both reading and writing of information. Alternatively, the recording and reproduction apparatus 191 may separately include a section for reading information and a section for writing information.

According to Example 14, when the user purchases an information content including audio information and still picture information via electronic distribution or the like, and when the still picture transfer information is transfer permission/prohibition information, the audio information is necessarily transferred when the still picture information is transferred. Therefore, the intention of the distributor that the audio information and the still picture information are always handled as a pair can be correctly reflected. When text information is distributed instead of, or together with the still picture information, the text information is handled in the same manner as the still picture information.

### Example 15

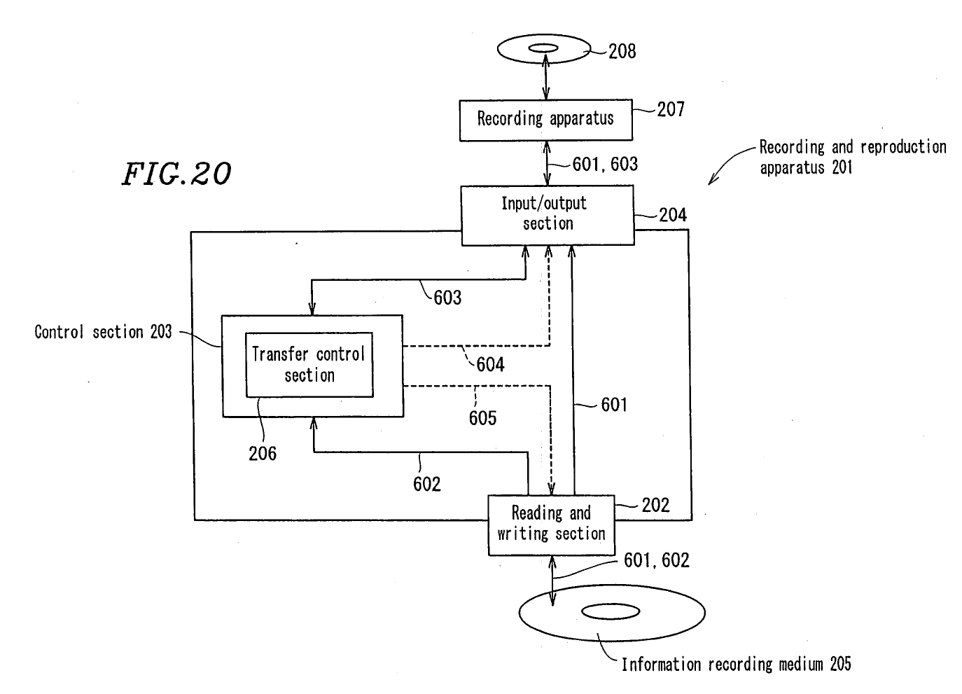

FIG. 20 shows a recording and reproduction apparatus 201 according to Example 15. As shown in FIG. 20, the recording and reproduction apparatus 201 includes a reading and writing section 202, a control section 203, and an input/output section 204. The control section 203 includes a transfer control section 206. An information recording medium 205 includes still picture information 601 and inherent recording information 602 for specifying the first still picture information 601.

For transferring the still picture information 601 from the information recording medium 205 to another information recording medium 208, the reading and writing section 202 reads the inherent information 602 from the information recording medium 205 and outputs the information to the control section 203. The control section 203 controls the reading and writing section 202 by outputting a control signal 604 to the reading and writing section 202, and controls the input/output section 204 by outputting a control signal 605 to the input/output section 204. The information recording medium 208 is set in an external recording apparatus 207. The transfer control section 206 included in the control section 203 mutually authenticates with the external recording apparatus 207 by exchanging mutual authentication information 603, and thus determines whether or not different inherent information specified by the inherent recording information 602 read by the reading and writing section 202 has been recorded on the information recording medium 208. The different inherent information specified by the inherent information 602 specifies information which can be linked to the still picture information 601 (for example, audio information). When it is determined that the different inherent information specified by the inherent recording information 602 has been recorded on the information recording medium 208, that means the information which can be linked to the still picture information 601 is recorded on the information recording medium 208.

When it is determined as a result of the mutual authentication that the different inherent information specified by the inherent recording 602 has been recorded on the information recording medium 208, the control section 203 controls the reading and writing section 202 and the input/output section 204 so as to transfer the still picture information 601 from the information recording medium 205 to the information recording medium 208. The reading and writing section 202 reads the still picture information 601 from the information recording medium 205 and outputs the information to the input/output section 204. The input/output section 204 outputs the still picture information 601 to a recording apparatus 207. Then, the reading and writing section 202 deletes the still picture information 601 from the information recording medium 205.

On the other hand, when it is determined as a result of the mutual authentication that the different inherent information specified by the inherent information 602 has not been recorded on the information recording medium 208, the control section 203 prohibits the still picture information 601 from being transferred to the information recording medium 208.

Instead of still picture information, at least one of moving picture information, audio information, text information and other types of information may be transferred. The information which can be linked to the still picture information 601 may be, for example, at least one of audio information and moving picture information. The inherent information 602 is, for example, an ISRC code.

The recording and reproduction apparatus 201 includes the reading and writing section 202 for both reading and writing of information. Alternatively, the recording and reproduction apparatus 201 may separately include a section for reading information and a section for writing information.

Example 15 is useful when the user purchases a content including audio information and still picture information linked to the audio information via electronic music distribution, records the content on an information recording medium, and then transfers only the audio information to another information recording medium. In this case, the still picture information can be transferred only to the information recording medium on which the audio information linked to the still picture information (i.e., information which can be linked to the still picture information) is recorded. As a result, the still picture information is prohibited from being independently transferred to another information recording medium. The audio information and the still picture information purchased as a pair are prohibited from being transferred to different information recording mediums.

### Example 16

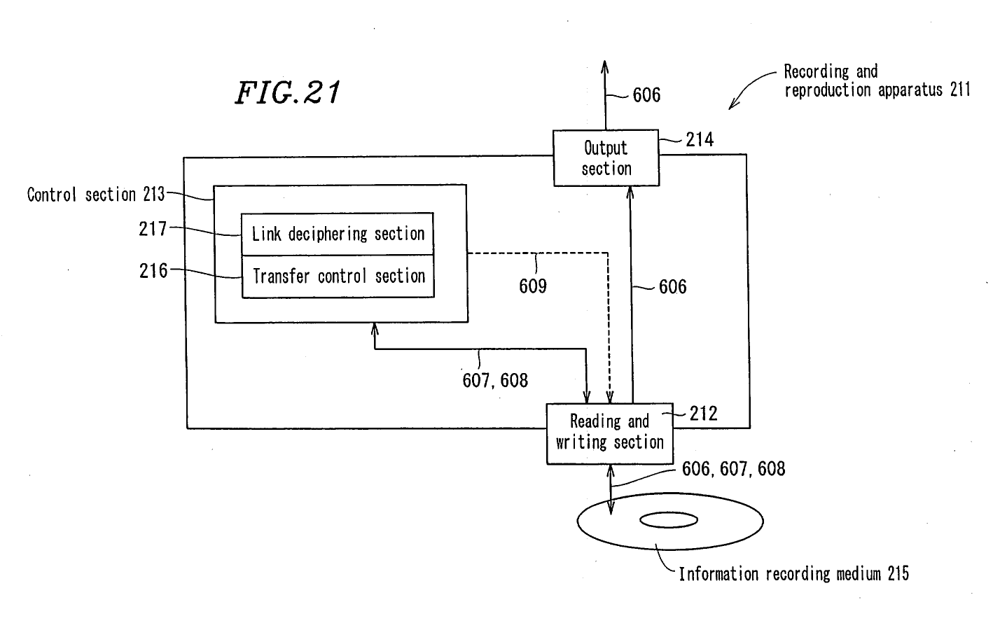

FIG. 21 shows a recording and reproduction apparatus 211 according to Example 16. As shown in FIG. 21, the recording and reproduction apparatus 211 includes a reading and writing section 212, a control section 213, and an output section 214. The control section 213 includes a transfer control section 216 and a link deciphering section 217. An information recording medium 215 includes still picture information 606, still picture transfer information 607 regarding the still picture information 606, and still picture management information 608 for managing reproduction of the still picture information 606.

For transferring the still picture information 606 from the information recording medium 215 to another information recording medium, the reading and writing section 212 reads the still picture transfer information 607 and the still picture management information 608 from the information recording medium 215 and outputs both types of information to the control section 213. The control section 213 controls the reading and writing section 212 by outputting a control signal 609 to the reading and writing section 212. The transfer control section 216 included in the control section 213 deciphers the still picture transfer information 607. The link deciphering section 217 included in the control section 213 deciphers the still picture management information 608. When it is determined as a result of the deciphering that the still picture transfer information 607 is transfer permission/prohibition information and that the still picture information 606 is not linked to any other information, the control section 213 controls the reading and writing section 212 not to read the still picture information 606 to be transferred. When it is determined that the still picture transfer information 607 is transfer permission/prohibition information and that the still picture information 606 is linked to another information, the control section 213 controls the reading and writing section 212 to read the still picture information 606 from the information recording medium 215 to be transferred. The reading and writing section 212 outputs the still picture information 606 to the out put section 214. The out put section 214 outputs the still picture information 606 received from the reading and writing section 212. Instead of still picture information, audio information, moving picture information, text information or other types of information may be processed fore transfer by the recording and reproduction apparatus 211.

The recording and reproduction apparatus 211 includes the reading and writing section 212 for both reading and writing of information. Alternatively, the recording and reproduction apparatus 211 may separately include a section for reading information and a section for writing information.

According to Example 16, the following advantages are provided. When the user purchases a content including audio information and still picture information by electronic distribution or the like, and when the still picture transfer information is transfer permission/prohibition information, the still picture information cannot be transferred separately from the audio information even after the link between the audio information and the still picture information is deleted. As a result, the still picture information cannot be transferred independently to be reused for other audio information. Therefore, the intention of the distributor that the audio information and the still picture information are always handled as a pair can be correctly reflected. When text information is distributed instead of, or together with the still picture information, the text information is handled in the same manner as the still picture information.

### Example 17

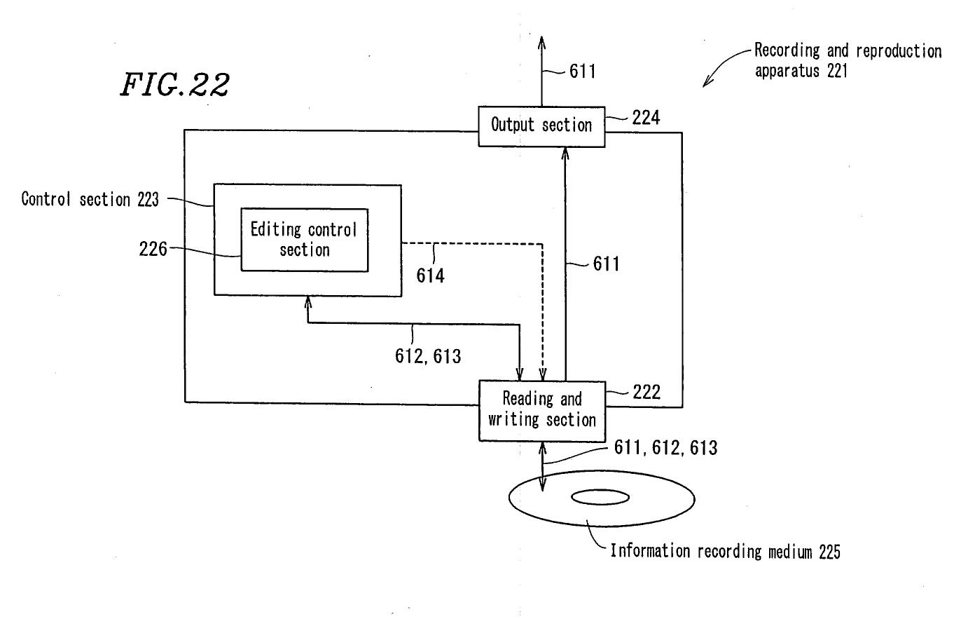

FIG. 22 shows a recording and reproduction apparatus 221 according to Example 17. As shown in FIG. 22, the recording and reproduction apparatus 221 includes a reading and writing section 222, a control section 223, and an output section 224. The control section 223 includes an editing control section 226. An information recording medium 225 includes audio information 611, audio copy information 612 regarding copy permission of the audio information 611, and audio transfer in formation 613 regarding transfer permission of the audio information 611. The control section 223 controls the reading and writing section 222 by outputting a control signal 614 to the reading and writing section 222.

For editing the audio information 611, the reading and writing section 222 reads the audio copy information 612 or the audio transfer information 613 from the information recording medium 225 and outputs the information to the control section 223. The editing section 226 included in the control section 223 deciphers the audio copy information 612 or the audio transfer information 613.

When it is determined as a result of the deciphering that the audio transfer information 613 permits transfer of the audio information 611, the control section 223 updates the audio transfer information 613 so as to indicate that the audio information 611 is prohibited from being transferred after the audio information 611 is edited. The control section 223 records the updated audio transfer information 613 on the information recording medium 225 via the reading and writing section 222.

When it is determined as a result of the deciphering that the audio copy information 612 does not permit the audio information 611 to be copied with no restriction, the control section 223 updates the audio copy information 612 so as to indicate that the audio information 611 is prohibited from being copied after the audio information 611 is edited. The control section 223 records the updated audio copy information 612 on the information recording medium 225 via the reading and writing section 222.

For transferring or copying the audio information 611, the control section 223 controls the reading and writing section 222 so as to read the audio information 611 from the information recording medium 225. The reading and writing section 222 outputs the audio information 611 to the output section 224. The output section 224 outputs the audio information 611 received from the reading and writing section 222.

Instead of audio information 611, still picture information, moving picture information, text information or other types of information may be processed for copying or transfer by the recording and reproduction apparatus 221.

The recording and reproduction apparatus 221 includes the reading and writing section 222 for both reading and writing of information. Alternatively, the recording and reproduction apparatus 221 may separately include a section for reading information and a section for writing information.

According to Example 17, when transferable audio information or audio information with copy restriction is edited, the audio information can be prohibited from being copied or transferred. As a result, the original content purchased by the user via electronic music distribution or the like is prohibited from being transferred or copied, and thus the changed content is prohibited from being transferred or copied, i.e., be having as if it was the original content.

### Example 18

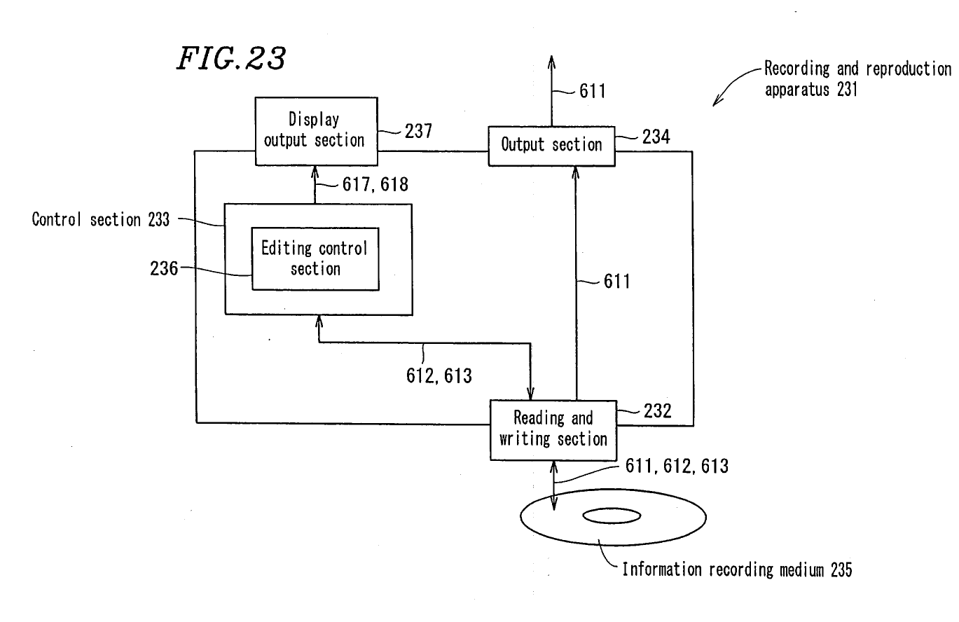

FIG. 23 shows a recording and reproduction apparatus 231 according to Example 18. As shown in FIG. 23, the recording and reproduction apparatus 231 includes a reading and writing section 232, a control section 233, an output section 234, and a display output section 237. The control section 233 includes an editing control section 236. An information recording medium 235 includes audio information 611, audio copy information 612 regarding copy permission of the audio information 611, and audio transfer information 613 regarding transfer permission of the audio information 611.

For editing the audio information 611, the reading and writing section 232 reads the audio copy information 612 or the audio transfer information 613 from the information recording medium 235 and outputs the information to the control section 233. The editing section 236 included in the control section 233 deciphers the audio copy information 612 or the audio transfer information 613.

When it is determined as a result of the deciphering that the audio transfer information 613 permits transfer of the audio information 611, the control section 233 outputs a control signal 617 to the display output section 237. Upon receiving the control signal 617, the display output section 237, displays that the edited audio information 611 is prohibited from being transferred to another information recording medium so as to warn the user.

When it is determined as a result of the deciphering that the audio copy information 612 is either free copy information which permits the audio information 611 to be copied with no restriction, or copy prohibition information which prohibits the audio information 611 from being copied, the control section 233 outputs a control signal 618 to the display output section 237. Upon receiving the control signal 618, the display output section 237 displays that the audio information 611 processed with editing other than specific manner of editing (for example, division of the audio information 611, partial deletion of the audio information 611, or combination of the audio information 611 with other audio information) is prohibited from being copied to another information recording medium, so as to warn the user.

For transferring or copying the audio information 611, the control section 233 controls the reading and writing section 232 so as to read the audio information 611 from the information recording medium 235. The reading and writing section 232 outputs the audio information 611 to the output section 234. The output section 234 outputs the audio information 611 received from the reading and writing section 232.

Instead of audio information 611, still picture information, moving picture information, text information or other types of information may be processed for copying or transfer by the recording and reproduction apparatus 231.

The recording and reproduction apparatus 231 includes the reading and writing section 232 for both reading and writing of information. Alternatively, the recording and reproduction apparatus 231 may separately include a section for reading information and a section for writing information.

According to Example 18, it can be notified to the user that even audio information, which is permitted to be transferred or copied, is prohibited from being transferred or copied after being edited in some manners. This is advantageous to the user since the user can choose to edit the audio information, or not to edit the audio information such that the audio information can be transferred or copied.

### Example 19

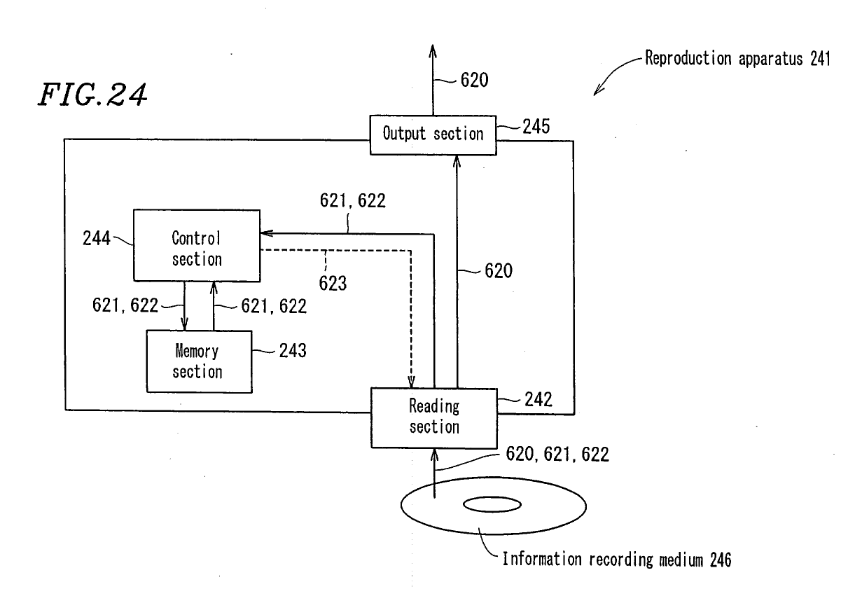

FIG. 24 shows a reproduction apparatus 241 according to Example 19. As shown in FIG. 24, the reproduction apparatus 241 includes a reading section 242, a memory section 243, a control section 244, and an output section 245. An information recording medium 246 includes audio information 620, audio reproduction restriction information 621 for restricting reproduction of the audio information 620, and inherent information 622 for specifying the audio information 620. The control section 244 controls the reading section 242 by outputting a control signal 623 to the reading section 242.

For reproducing the audio information 620, the reading section 242 reads the audio reproduction restriction information 621 and the inherent information 622 from the information recording medium 246 and outputs both types of information to the control section 244. The control section 244 determines whether or not the inherent information 622 has been stored in the memory section 243. When it is determined that the inherent information 622 has not been stored in the memory section 243, the control section 244 deciphers the audio reproduction restriction information 621. The control section 244 controls the reading section 242 based on the restriction represented by the audio reproduction restriction information 621. When it is determined as a result of deciphering of the audio reproduction restriction information 621 that the audio information 620 is permitted to be reproduced, the control section 244 controls the reading section 242 to read the audio information 620 from the information recording medium 246 and output the information to the output section 245. The output section 245 reproduces the received audio information 620. Further, the control section 244 updates the audio reproduction restriction information 621 in accordance with the reproduction of the audio information 620, and stores the inherent information 622 and the updated audio reproduction restriction information 621 as a pair in the memory section 243.

When it is determined that the inherent information 622 has been stored in the memory section 243, the control section 244 reads the audio reproduction restriction information 621 stored as apair with the inherent information 622 from the memory section 243. The control section 244 determines whether or not the read audio reproduction restriction information 621 permits the audio information 620 to be reproduced. When it is determined that the audio reproduction restriction information 621 permits the audio information 620 to be reproduced, the control section 244 controls the reading section 242 to read the audio information 620 from the information recording medium 246 and output the information to the out put section 245. The out put section 245 reproduces the received audio information 620. Further, the control section 244 updates the audio reproduction restriction information 621 in accordance with the reproduction of the audio information 620, and stores the inherent information 622 and the updated audio reproduction restriction information 621 as a pair in the memory section 243.

When it is determined that the audio reproduction restriction information 621 does not permit the audio information 620 to be reproduced, the control section 244 controls the reading section 242 so as not to read the audio information 620 from the information recording medium 246.

Instead of audio information 620, still picture information, moving picture information, text information or other types of information may be processed for reproduction by the reproduction apparatus 241 in accordance with the restriction represented by the reproduction restriction information. The inherent information 622 is, for example, an ISRC code.

According to Example 19, when the user purchases audio information associated with audio reproduction restriction information via electronic distribution or the like, the audio reproduction restriction information is managed using the memory of the reproduction apparatus. Therefore, it is not necessary to rewrite the audio reproduction restriction information recorded on the information recording medium each time the audio information is reproduced. As a result, even a reproduction apparatus which does not have a function of writing information to an information recording medium can be used to reproduce the audio information associated with the audio reproduction restriction information.

### Example 20

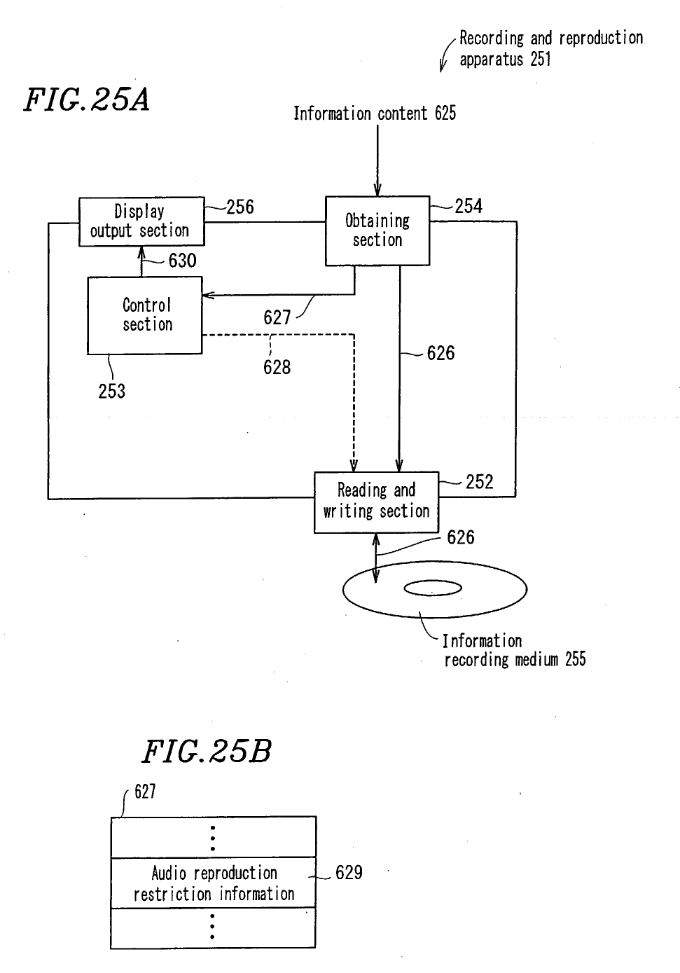

FIG. 25A shows a recording and reproduction apparatus 251 according to Example 20 of the present invention. As shown in FIG. 25, the recording and reproduction apparatus 251 includes a reading and writing section 252, a control section 253, an obtaining section 254, and a display output section 265. The recording and reproduction apparatus 251 obtains an information content 625 including audio information 626 and audio copyright information 627 representing copyright regarding the audio information 626, and records at least the audio information 626 on an information recording medium 255. The control section 253 controls the reading and writing section 252 by outputting a control signal 628 to the reading and writing section 252.

Upon obtaining the information content 625 from an information source such as, for example, electronic distribution, the obtaining section 254 outputs the audio copyright information 627 to the control section 253 and outputs the audio information 626 to the reading and writing section 252. The control section 253 deciphers the audio copyright information 627, and determines whether or not the audio copyright information 627 includes audio reproduction restriction information 629 for restricting reproduction of the audio information 626. As shown in FIG. 25B, when it is determined that the copyright information 627 includes the audio reproduction restriction information 629, the control section 253 controls the reading and writing section 252 so as not to record the audio information 626 on the information recording medium 255. The control section 253 outputs a control signal 630 to the display output section 265. Upon receiving the control signal 630, the display output section 265 displays that the audio information 626 associated with the audio reproduction restriction information 629 is prohibited from being recorded so as to warn the user.

When it is determined that the copyright information 627 does not include the audio reproduction restriction information 629, the control section 253 controls the reading and writing section 252 so as to record the audio information 626 on the information recording medium 255.

Instead of audio information, still picture information, moving picture information, text information or other types of information may be processed for recording by the recording and reproduction apparatus 251.

The recording and reproduction apparatus 251 includes the reading and writing section 252 for both reading and writing of information. Alternatively, the recording and reproduction apparatus 251 may separately include a section for reading information and a section for writing information.

According to Example 20, when the recording and reproduction apparatus cannot reproduce audio information in accordance with the audio reproduction restriction information, the audio information associated with the audio reproduction restriction information is not recorded on an information recording medium. Therefore, the confusion on the side of the user in the case that the user recorded audio information associated with the reproduction restriction information but cannot reproduce the audio information because the recording and reproduction apparatus does not have a function of reproducing the audio information in accordance with the reproduction restriction information, can be minimized.

### Example 21

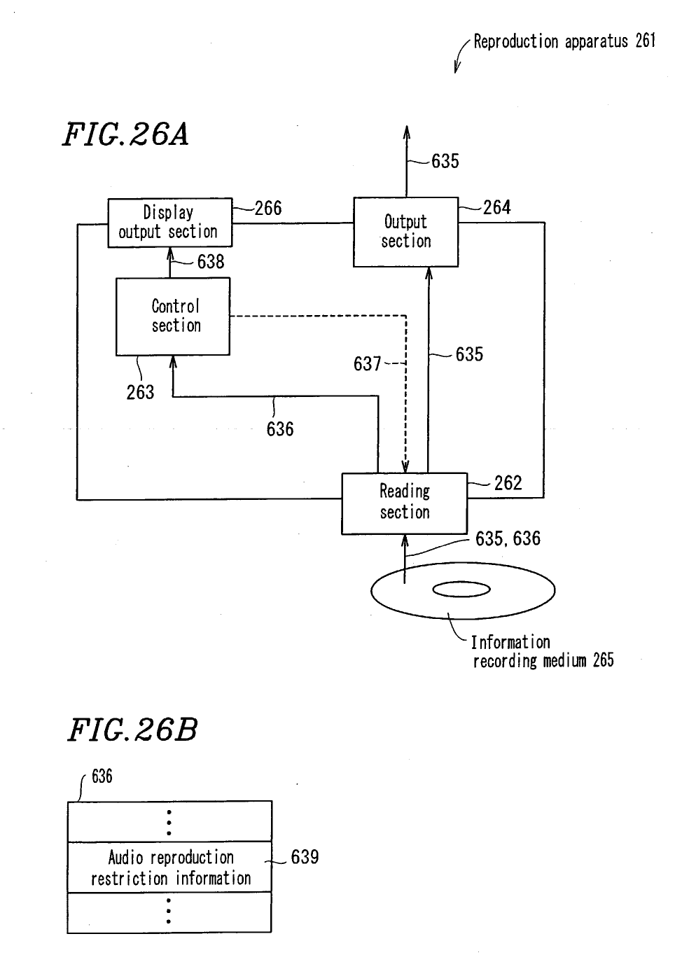

FIG. 26A shows a reproduction apparatus 261 according to Example 21 of the present invention. As shown in FIG. 26, the reproduction apparatus 261 includes a reading section 262, a control section 263, an output section 264, and a display output section 266. An information recording medium 265 includes audio information 635, and audio copyright information 636 representing copyright regarding the audio information 635. The control section 263 controls the reading section 262 by outputting a control signal 637 to the reading section 262.

For reproducing the audio information 635, the reading section 262 reads the audio copyright information 636 from the information recording medium 265, and outputs the information to the control section 263. The control section 263 deciphers the audio copyright information 636 and determines whether or not the audio copyright information 636 includes audio reproduction restriction information 639 for restricting reproduction of the audio information 635. As shown in FIG. 26B, when it is determined that the audio copyright information 636 includes the audio reproduction restriction information 639, the control section 263 controls the reading section 262 so as not to read the audio information 635 to be reproduced. The control section 263 further outputs a control signal 638 to the display output section 266. Upon receiving the control signal 638, the display output section 266 displays that the audio information 625 associated with the audio reproduction restriction information 629 is prohibited from being reproduced so as to warn the user.

When it is determined that the audio copyright information 636 does not include the audio reproduction restriction information 639, the control section 263 controls the reading section 262 so as to read the audio information 635 from the information recording medium 265. The reading section 262 outputs the audio information 635 to the output section 264. The output section 264 outputs the audio information 635 received from the reading section 262.

Instead of audio information, still picture information, moving picture information, text information or other types of information may be processed for reproduction by the reproduction apparatus 261.

According to Example 21, when the reproduction apparatus cannot reproduce audio information in accordance with the audio reproduction restriction information, the audio information associated with the audio reproduction restriction information is not reproduced. Therefore, the act of reproducing audio information ignoring the set audio reproduction restriction information can be prohibited. It is important to have the user understand that the audio information cannot be reproduced by displaying the warning.

### Example 22

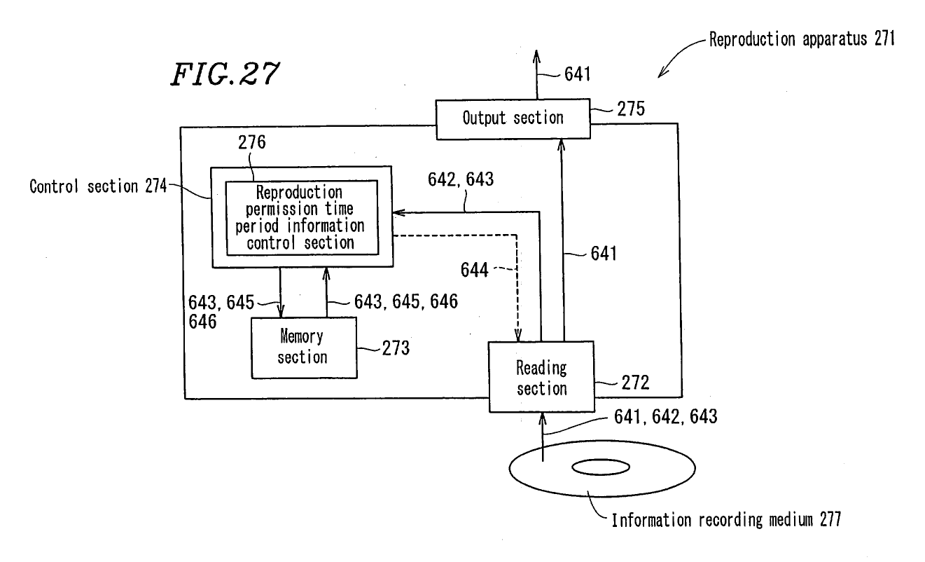

FIG. 27 shows a reproduction apparatus 271 according to Example 22 of the present invention. As shown in FIG. 27, the reproduction apparatus 271 includes a reading section 272, a memory section 273, a control section 274, and an output section 275. The control section 274 includes a reproduction permission time period information control section 276. An information recording medium 277 includes audio information 641, reproduction permission time period information 642 representing a time period in which the audio information 641 is permitted to be reproduced, and inherent information 643 for specifying the audio information 641. The reproduction permission time period information 642 is included in the audio reproduction restriction information which is included in the information recording medium 277. The control section 274 controls the reading section 272 by outputting a control signal 644 to the reading section 272.

For reproducing the audio information 641, the reading section 272 reads the reproduction permission time period information 642 and the inherent information 643 from the information recording medium 277, and outputs both types of information to the control section 274. The reproduction permission time period information control section 276 included in the control section 274 determines whether or not the inherent information 643 is already stored in the memory section 273. When it is determined that the inherent information 643 has not been stored in the memory section 273, the reproduction permission time period information control section 276 deciphers the reproduction permission time period information 642. The control section 274 controls the reading section 272 based on the restriction represented by the reproduction permission time period information 642. The control section 274 controls the reading section 272 so as to read the audio information 641 from the information recording medium 277 in accordance with the reproduction permission time period represented by the reproduction permission time period information 642. The reading section 272 outputs the audio information 641 to the output section 275. The output section 275 outputs the audio information 641 received from the reading section 272. As the audio information 641 is reproduced, the control section 274 calculates the remaining reproduction permission time period by subtracting the time period in which the audio information 641 has been reproduced from the reproduction permission time period represented by the reproduction permission time period information 642. The control section 274 controls the reading section 272 so as to reproduce the audio information 641 until the remaining reproduction permission time period becomes 0. When the reproduction permission time period becomes 0 or less, the control section 274 controls the reading section 272 so as not to reproduce the audio information 641.

The control section 274 generates remaining reproduction permission time period information 645 representing the remaining reproduction permission time period. After the reproduction is finished, the control section 274 stores the generated remaining reproduction permission time period information 645 in the memory section 273 as a pair with the inherent information 643. When the remaining reproduction permission time becomes 0 in the middle of the reproduction, the control section 274 stops the reproduction operation and records the remaining reproduction permission time period information 645 which represents 0 or information prohibiting reproduction and the inherent information 643 as a pair in the memory section 273.

When it is determined that the inherent information 643 has been stored in the memory section 273, the reproduction permission time period information control section 276 reads the remaining reproduction permission time period information 645 stored as apair with the inherent information 643 from the memory section 273. When the remaining reproduction permission time period represented by the remaining reproduction permission time period information 645 is greater than 0 (or when the information prohibiting reproduction is not stored in the memory section 273), the reproduction permission time period information control section 276 permits the audio information 641 to be reproduced. The control section 274 controls the reading section 272 so as to read the audio information 641 from the information recording medium 272. The reading section 272 outputs the audio information 641 to the output section 275. The output section 275 outputs the audio information 641 received from the reading section 272. As the audio information 641 is reproduced, the control section 274 subtracts the time period in which the audio information 641 has been reproduced from the reproduction permission time period. After the reproduction is finished, the control section 274 stores the remaining reproduction permission time period information 645 representing the obtained remaining reproduction permission time period in the memory section 273. When the remaining reproduction permission time becomes 0 in the middle of the reproduction, the control section 274 stops the reproduction operation and records the remaining reproduction permission time period information 645 which represents 0 or information prohibiting reproduction and the inherent information 643 as a pair in the memory section 273.

According to the above-described procedure, in summary, the remaining reproduction permission time period information 645 is stored in the memory section 273. When the remaining reproduction permission time period becomes 0 as a result of reproduction, reproduction is prohibited. Alternatively, the time period in which the information has been reproduced may be stored in the memory section 273. In this case, the information representing the time period in which the information has been reproduced is incremented while the information is being reproduced. When the time period in which the information has been reproduce reaches the reproduction permission time period, reproduction is prohibited.

In this case, the control section 274 compares the time period in which the information has been reproduced with the reproduction permission time period represented by the reproduction permission time period information 642. When the time period in which the information has been reproduced is smaller than the reproduction permission time period, the control section 274 controls the reading section 272 so as to reproduce the audio information 641. When the time period in which the information has been reproduced reaches the reproduction permission time period, the control section 274 controls the reading section 272 so as not to reproduce the audio information 641.

The control section 274 generates past reproduction time period information 646 representing the time period in which the information has been reproduced, as the information is reproduced. After the reproduction is finished, the control section 274 stores the generated past reproduction time period information 646 in the memory section 273 as a pair with the inherent information 643.

When it is determined that the inherent information 643 has been stored in the memory section 273, the reproduction permission time period information control section 276 reads the past reproduction time period information 646 stored in the memory section 273 as a pair with the inherent information 643, and compares the time period represented by the past reproduction time period information 646 with the reproduction permission time period represented by the reproduction permission time period information 642. When the time period represented by the past reproduction time period information 646 is smaller than the reproduction permission time period represented by the reproduction permission time period information 642, the reproduction permission time period information control section 276 controls the reading section 272 so as to reproduce the audio information 641. When the time period represented by the past reproduction time period information 646 is the reproduction permission time period represented by the reproduction permission time period information 642, the reproduction permission time period information control section 276 controls the reading section 272 so as not to reproduce the audio information 641.

Instead of audio information, moving picture information, still picture information, text information or other types of information may be processed for reproduction by the reproduction apparatus 271. The inherent information 643 is, for example, an ISRC code.

According to Example 22, even a reproduction apparatus which does not have a function of writing information on an information recording medium can reproduce audio information associated with the reproduction permission time period information.

### Example 23

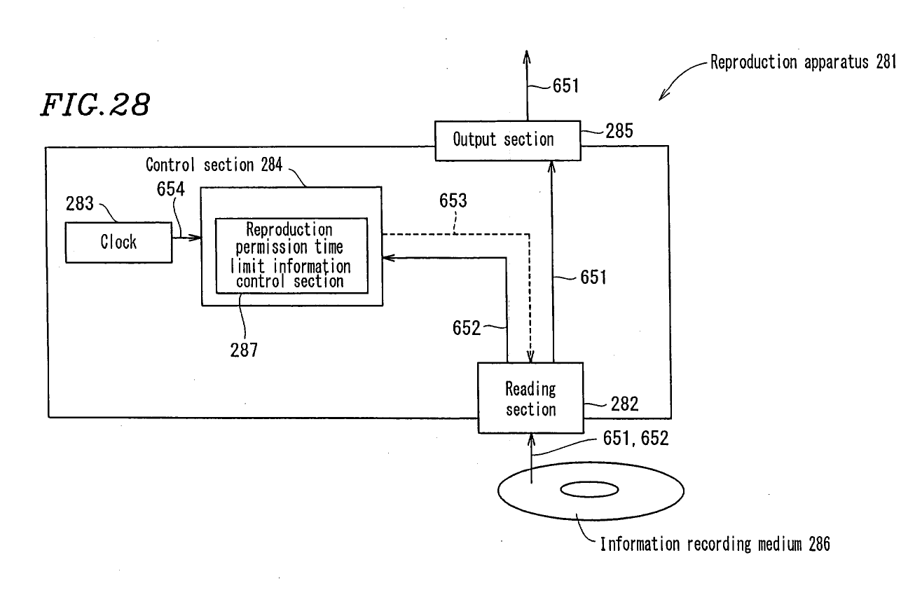

FIG. 28 shows a reproduction apparatus 281 according to Example 23 of the present invention. As shown in FIG. 28, the reproduction apparatus 281 includes a reading section 282, a clock 283, a control section 284, and an output section 285. The control section 284 includes a reproduction permission time limit information control section 287. An information recording medium 286 includes audio information 651, and reproduction permission time limit information 652 representing the time limit until which the audio information is permitted to be reproduced. The reproduction permission time limit information 652 is included in the audio reproduction restriction information which is included in the information recording medium 286. The control section 284 controls the reading section 282 by outputting a control signal 653 to the reading section 282.

For reproducing the audio information 651, the reading section 282 reads the reproduction permission time limit information 652 from the information recording medium 286 and outputs the information to the control section 284. The control section 284 controls the reading section 282 based on the restriction represented by the reproduction permission time limit information 652. The reproduction permission time limit information control section 287 included in the control section 284 obtains date and time information 654 representing the current date and time from the clock 283.

The reproduction permission time limit information control section 287 compares the current date and time represented by the date and time information 654 with the time limit represented by the reproduction permission time limit information 652. When the current date and time is before the reproduction permission time limit, the control section 284 controls the reading section 282 so as to reproduce the audio information 651. The reading section 282 outputs the audio information 651 to the output section 285. The output section 285 outputs the audio information 651 received from the reading section 282.

When the current date and time is not before the reproduction permission time limit, the control section 284 controls the reading section 282 so as not to reproduce the audio information 651.

Instead of audio information, moving picture information, still picture information, text information or other types of information may be processed for reproduction by the reproduction apparatus 281.

According to Example 23, reproduction of audio information associated with reproduction permission time limit information can be permitted only before the reproduction permission time limit represented by the reproduction permission time limit information.

### Example 24

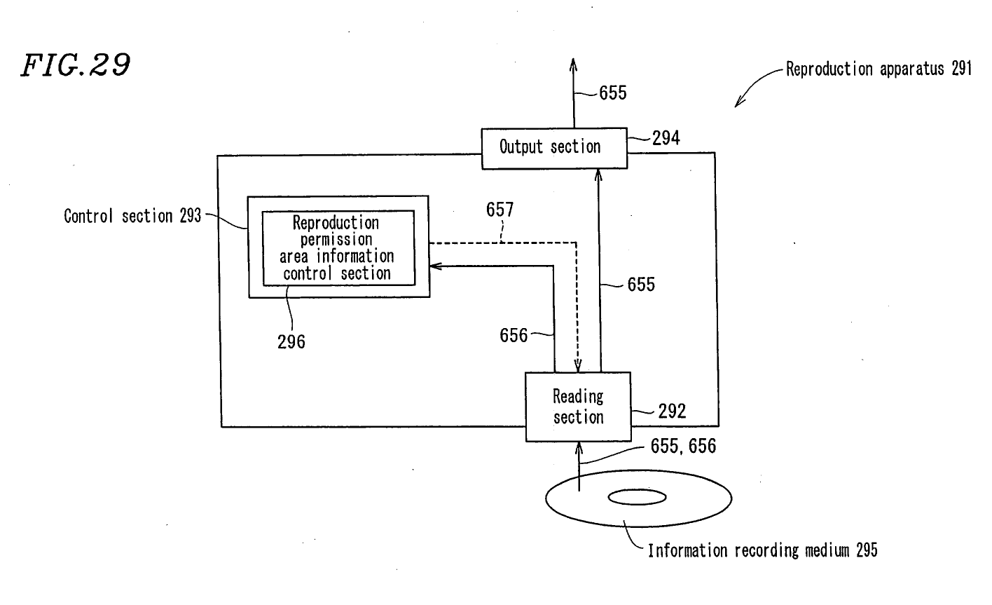

FIG. 29 shows a reproduction apparatus 291 according to Example 24 of the present invention. As shown in FIG. 29, the reproduction apparatus 291 includes a reading section 292, a control section 293, and an output section 294. The control section 293includes areproduction area permission information control section 296. An information recording medium 295 includes audio information 655, and reproduction area permission information 656 representing the area of the information recording medium 295 which is permitted to be reproduced. The reproduction area permission information 656 is included in the audio reproduction restriction information which is included in the information recording medium 295. The control section 293 controls the reading section 292 by outputting a control signal 657 to the reading section 292.

In Example 24, the reproduction area permission information 656 represents a reproduction start address and a reproduction end address of the area of the audio information 655 which is permitted to be reproduced. The reproduction start address and the reproduction end address may be physical addresses or logical addresses. The reproduction area permission information 656 may represent areproduction start time and a reproduction end time of the area of the audio information 655 which is permitted to be reproduced.

For reproducing the audio information 655, the reading section 292 reads the reproduction area permission information 656 from the information recording medium 295 and outputs the information to the control section 293. The control section 293 controls the reading section 292 based on the restriction represented by the reproduction area permission information 656. The reproduction area permission information control section 296 included in the control section 293 deciphers the reproduction area permission information 656, and controls the reading section 292 so as to read a part of the audio information 655, the part being recorded in the area permitted to be reproduced. The reading section 292 outputs the audio information 655 to the output section 294. The output section 294 outputs the audio information 655 received from the reading section 292.

Reproduction permission area information associated with moving picture information represents, for example, a reproduction start time and a reproduction end time. In this case, the reproduction apparatus 291 reproduces the moving picture information from the reproduction start time until the reproduction end time. Reproduction permission area information associated with a plurality of pieces of text information specifies, for example, text information which is permitted to be reproduced. In this case, the reproduction apparatus 291 operates to display only the text information specified.

According to Example 24, a reproduction apparatus for reproducing audio information which is associated with reproduction area permission information is provided.

### Example 25

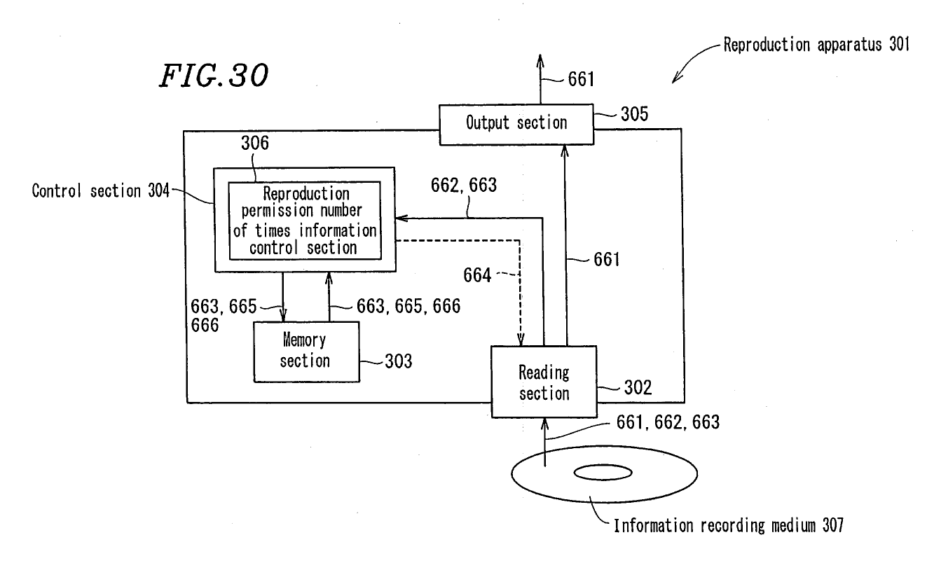

FIG. 30 shows a reproduction apparatus 301 according to Example 25 of the present invention. As shown in FIG. 30, the reproduction apparatus 301 includes a reading section 302, a memory section 303, a control section 304, and an output section 305. The control section 304 includes a reproduction number permission information control section 306. An information recording medium 307 includes audio information 661, reproduction number permission information 662 representing the number of times that the audio information 661 is permitted to be reproduced, and inherent information 663 for specifying the audio information 661. The reproduction number permission information 662 is included in the audio reproduction restriction information which is included in the information recording medium 307. The control section 304 controls the reading section 302 by outputting a control signal 664 to the reading section 302.

For reproducing the audio information 661, the reading section 302 reads the reproduction number permission information 662 and the inherent information 663 from the information recording medium 307, and outputs both types of information to the control section 304. The control section 304 determines whether or not the inherent information 663 has been stored in the memory section 303. When it is determined that the inherent information 663 has not been stored in the memory section 303, the reproduction number permission information control section 306 deciphers the reproduction number permission information 662. The control section 304 controls the reading section 302 based on the restriction represented by the reproduction number permission information 662. The control section 304 controls the reading section 302 to read the audio information 661 from the information recording medium 307 in accordance with the number of times represented by the reproduction number permission information 662. The reading section 302 outputs the audio information 661 to the output section 305. The output section 305 outputs the audio information 661 received from the reading section 302. As the audio information 661 is reproduced, the control section 304 calculates the remaining reproduction permission number of times that the audio information 661 is permitted to be reproduced by subtracting the number of times that the audio information 661 has been reproduced from the number of times represented by the reproduction number permission information 662. The control section 304 controls the reading section 302 so as to reproduce the audio information 661 until the remaining reproduction number of times becomes 0. When the remaining reproduction number of times becomes 0, the control section 304 controls the reading section 302 so as not to reproduce the audio information 661.

The control section 304 generates remaining reproduction number permission information 665 representing the remaining number of times that the audio information 661 is permitted to be reproduced. After the reproduction is finished, the control section 304 stores the generated remaining reproduction number permission information 665 in the memory section 303 as a pair with the inherent information 663. When the remaining number of times becomes 0 in the middle of the reproduction, the control section 304 stops the reproduction operation and records the remaining reproduction number permission information 665 which represents 0 or information prohibiting reproduction and the inherent information 663 as a pair in the memory section 303.

When it is determined that the inherent information 663 has been stored in the memory section 303, the reproduction number permission information control section 306 reads the remaining reproduction number permission information 665 stored as a pair with the inherent information 663 from the memory section 303. When the remaining number of times represented by the remaining reproduction number permission information 665 is greater than 0 (or when the information prohibiting reproduction is not stored in the memory section 303), the reproduction number permission information control section 306 permits the audio information 661 to be reproduced. The control section 304 controls the reading section 302 so as to read the audio information 661 from the information recording medium 307. The reading section 302 outputs the audio information 661to the out put section 305. The output section 305 outputs the audio information 661 received from the reading section 302. As the audio information 661 is reproduced, the control section 304 subtracts the number of times that the audio information 661 has been reproduced from the remaining reproduction permission number of times. After the reproduction is finished, the control section 304 stores the remaining reproduction number permission information 665 representing the obtained remaining number of times in the memory section 303. When the remaining number of times becomes 0 in the middle of the reproduction, the control section 304 stops the reproduction operation and records the remaining reproduction permission number of times 665 which represents 0 or information prohibiting reproduction and the inherent information 663 as a pair in the memory section 303.

According to the above-described procedure, in summary, the remaining reproduction number permission information 665 is stored in the memory section 303. When the remaining number of times becomes 0 as a result of reproduction, reproduction is prohibited. Alternatively, the number of times that the information has been reproduced may be stored in the memory section 303. In this case, the information representing the number of times that the information has been reproduced is incremented while the information is being reproduced. When the number of times that the information has been reproduced reaches the number of times that the information is permitted to be reproduced, reproduction is prohibited.

In this case, the control section 304 compares the number of times that the information has been reproduced with the number of times represented by the reproduction number permission information 662. When the number of times that the information has been reproduced is smaller than the number of times that the information is permitted to be reproduced, the control section 304 controls the reading section 302 so as to reproduce the audio information 661. When the number of times that the information has been reproduced reaches the number of times that the information is permitted to be reproduced, the control section 304 controls the reading section 302 so as not to reproduce the audio information 661.

The control section 304 generates past reproduction number information 666 representing the number of times that the information has been reproduced, as the information is reproduced. After the reproduction is finished, the control section 304 stores the generated past reproduction number information 666 in the memory section 303 as a pair with the inherent information 663.

When it is determined that the inherent information 663 has been stored in the memory section 303, the reproduction number information control section 306 reads the past reproduction number information 666 stored in the memory section 303 as a pair with the inherent information 663, and compares the number of times represented by the past reproduction number information 666 with the number of times represented by the reproduction number permission information 662. When the number of times represented by the past reproduction number information 666 is smaller than the number of times represented by the reproduction number permission information 662, the reproduction number permission information control section 306 controls the reading section 302 so as to reproduce the audio information 661. When the number of times represented by the past reproduction number information 666 is the number of times represented by the reproduction number permission information 662, the reproduction number permission information control section 306 controls the reading section 302 so as not to reproduce the audio information 661.

Instead of audio information, moving picture information, still picture information, text information or other types of information may be processed for reproduction by the reproduction apparatus 301. The inherent information 643 is, for example, an ISRC code.

According to Example 25, even a reproduction apparatus which does not have a function of writing information on an information recording medium can reproduce audio information associated with the reproduction number permission information.

### Example 26

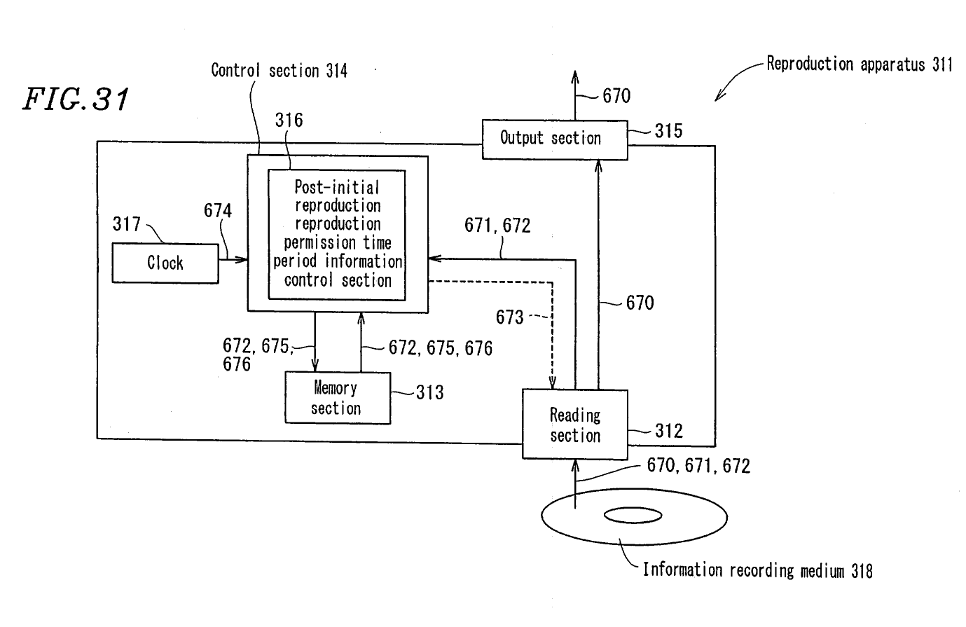

FIG. 31 shows a reproduction apparatus 311 according to Example 26 of the present invention. As shown in FIG. 31, the reproduction apparatus 311 includes a reading section 312, a memory section 313, a control section 314, an output section 315, and a clock 317. The control section 314 includes a post-initial reproduction reproduction permission time period information control section 316. An information recording medium 318 includes audio information 670, post-initial reproduction reproduction permission time period information 671 representing the time period in which the audio information 670 is permitted to be reproduced after the day/time when the audio information 670 is first reproduced, and inherent information 671 for specifying the audio information 670. The post-initial reproduction reproduction permission time period information 671 is included in the audio reproduction restriction information which is included in the information recording medium 318. The control section 314 controls the reading section 312 by outputting a control signal 673 to the reading section 312.

For reproducing the audio information 670, the reading section 312 reads the post-initial reproduction reproduction permission time period information 671 and the inherent information 672 from the information recording medium 318, and outputs both types of information to the control section 314. The control section 314 controls the reading section 312 based on the restriction represented by the post-initial reproduction reproduction permission time period information 671. The post-initial reproduction reproduction permission time period information control section 316 included in the control section 314 determines whether or not the inherent information 672 has been stored in the memory section 313. When it is determined that the inherent information 672 has not been stored in the memory section 313, the post-initial reproduction reproduction permission time period information control section 316 obtains date/time information 674 representing the current date/time (i.e., the date/time of the initial reproduction) from the clock 317. The post-initial reproduction reproduction permission time period information control section 316 adds the date/time of the initial reproduction represented by the date/time information 674, and the reproduction permission time period represented by the post-initial reproduction reproduction permission time period information 671, so as to calculate the reproduction permission time limit. The post-initial reproduction reproduction permission time period information control section 316 compares the current date/time with the reproduction permission time limit.

When the current date/time is before the reproduction permission time limit, the control section 314 controls the reading section 312 so as to read the audio information 670 from the information recording medium 318. The reading section 312 outputs the audio information 670 to the output section 315. The output section 315 outputs the audio information 670 received from the reading section 312. When the current date/time is not before the reproduction permission time limit, the control section 314 controls the reading section 312 so as not to read the audio information 670 from the information recording medium 318.

The control section 314 also generates time limit information 675 representing a reproduction permission time limit, and initial reproduction date/time information 676 representing the date/time of the initial reproduction. The control section 314 stores the time limit information 675 and the initial reproduction date/time information 676, which have been generated, as a set with the inherent information 672 in the memory section 313.

When it is determined that the inherent information 672 has been stored in the memory section 313, the post-initial reproduction reproduction permission time period information control section 316 reads the time limit information 675 and the initial reproduction date/time information 676 stored in the memory section 313 as a set with the inherent information 672, and obtains the date/time information 674 from the clock 317. The post-initial reproduction reproduction permission time period information control section 316 compares the date/time of the initial reproduction, the reproduction permission time limit, and the current date/time.

When the current date/time is between the date/time of the initial reproduction and the reproduction permission time limit (i.e., when the current date/time is before the reproduction permission time limit), the control section 314 controls the reading section 312 so as to read the audio information 670 from the information recording medium 318. When the current date/time is not between the date/time of the initial reproduction and the reproduction permission time limit (i.e., when the current date/time is not before the reproduction permission time limit), the control section 314 controls the reading section 312 so as not to read the audio information 670 from the information recording medium 318.

Instead of audio information, moving picture information, still picture information, text information or other types of information may be processed for reproduction by the reproduction apparatus 311.

According to Example 26, a reproduction apparatus for reproducing audio information which is associated with post-initial reproduction reproduction permission time period information is provided.

### Example 27

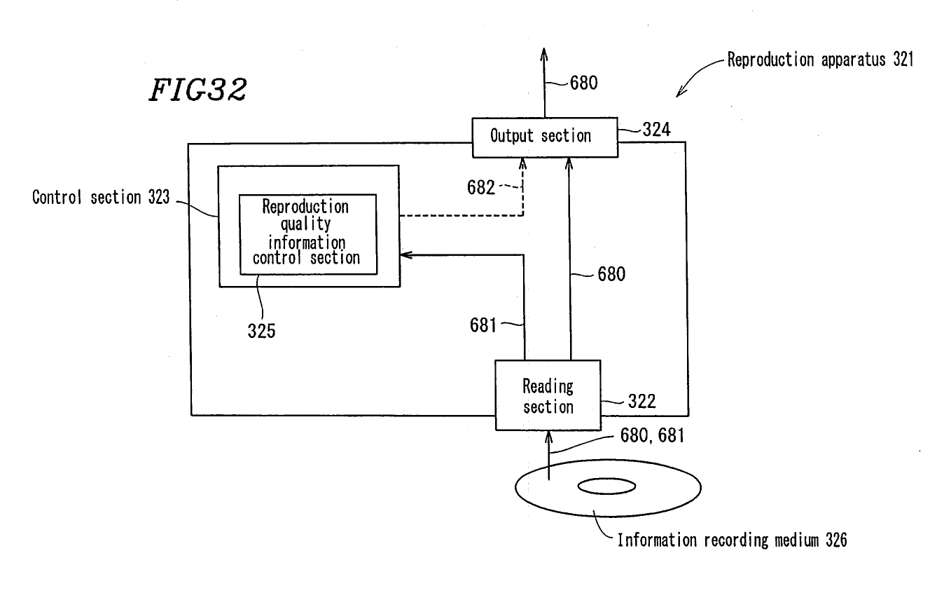

FIG. 32 shows a reproduction apparatus 321 according to Example 27 of the present invention. As shown in FIG. 32, the reproduction apparatus 321 includes a reading section 322, a control section 323, and an output section 324. The control section 323 includes reproduction quality information control section 325. An information recording medium 326 includes audio information 680, and reproduction quality information 681 representing the quality at the time of reproduction. The reproduction quality information 681 is included in the audio reproduction restriction information which is included in the information recording medium 326. The control section 323 controls the output section 324 by outputting a control signal 682 to the output section 324.

For reproducing the audio information 680, the reading section 322 reads the audio information 680 and the reproduction quality information 681, and outputs the reproduction quality information 681 to the control section 323 and outputs the audio information 680 to the output section 324. The control section 323 controls the reading section 322 based on the restriction represented by the reproduction quality information 681. The reproduction quality information control section 325 included in the control section 323 deciphers the reproduction quality information 681 and controls the output section 324 so as to reproduce the audio information 680 in accordance with the reproduction quality specified by the reproduction quality information 681. The output section 324 outputs the audio information 680 at the reproduction quality specified by the reproduction quality information 681. The reproduction quality represented by the reproduction quality information 681 is, for example, 2-channel CD sound quality or monaural and CD sound quality.

According to Example 27, a reproduction apparatus for reproducing audio information which is associated with reproduction quality information is provided.

### Example 28

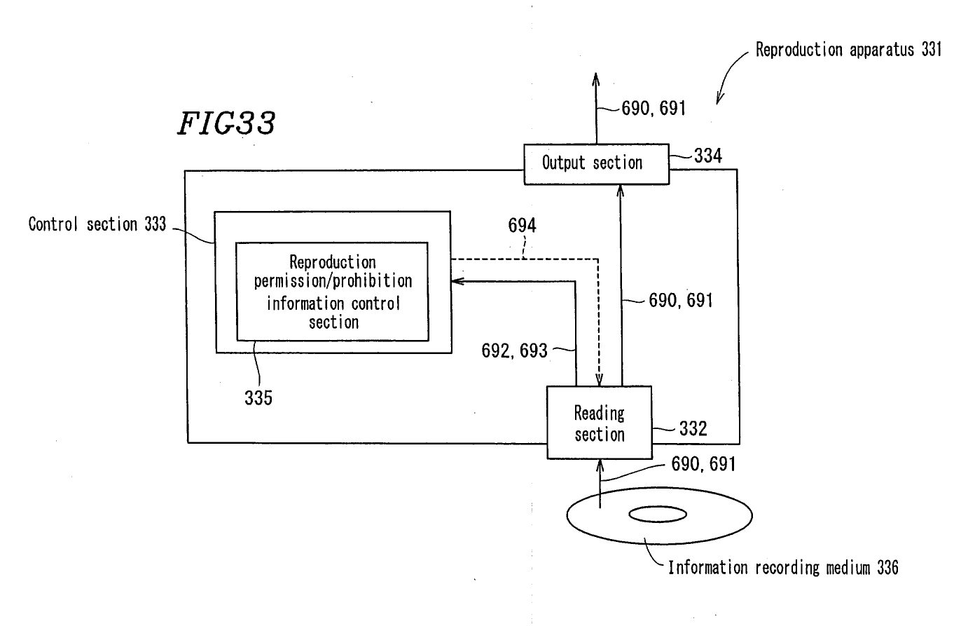

FIG. 33 shows a reproduction apparatus 331 according to Example 28 of the present invention. As shown in FIG. 33, the reproduction apparatus 331 includes a reading section 332, a control section 333, and an output section 334. The control section 333 includes a reproduction permission/prohibition information control section 335. An information recording medium 336 includes first information 690, second information 691 linked to the first information 690, first reproduction restriction information 692 for restricting reproduction of the first information 690, and second reproduction restriction information 693 for restricting reproduction of the second information 691. Each of the first information 690 and the second information 691 is, for example, audio information, moving picture information, still picture information, text information, or other types of information. More specifically, the first information 690 is at least one of audio information and moving picture information. The second information 691 is at least one of still picture information and text information. The control section 333 controls the reading section 332 by outputting a control signal 694 to the reading section 332.

For reproducing the first information 690 and the second information 691, the reading section 332 reads the first reproduction restriction information 692 and the second reproduction restriction information 693 from the information recording medium 336, and outputs both types of information to the control section 333. The control section 333 controls the reading section 332 based on the restriction represented by the first reproduction restriction information 692 and the second reproduction restriction information 693. The reproduction permission/prohibition information control section 335 included in the control section 333 deciphers the first reproduction restriction information 692 and the second reproduction restriction information 693, and determines whether or not the second reproduction restriction information 693 is reproduction permission/prohibition information which represents that the second information 691 is permitted to be reproduced only when the second reproduction restriction information 693 permits reproduction of the first information 690. The reproduction permission/prohibition information control section 335 determines whether or not the first reproduction restriction information 692 permits reproduction of the first information 690. When it is determined that the second reproduction restriction information 693 is reproduction permission/prohibition information and that the first reproduction restriction information 692 permits reproduction of the first information 690, the control section 333 controls the reading section 332 so as to read the second information 691 when reading the first information 690 to be reproduced. The reading section 332 outputs the first information 690 and the second information 691, which have been read from the information recording medium 336, to the output section 334. The output section 334 outputs first information 690 and the second information 691 received from the reading section 332.

When it is determined that the first reproduction restriction information 692 does not permit reproduction of the first information 690, the control section 333 controls the reading section 332 such that neither the first information 690 nor the second information 691 is reproduced.

According to Example 28, when the user purchases an information content including still picture information and audio information via electronic music distribution, and when the reproduction restriction information regarding the still picture information is reproduction permission/prohibition information, reproduction of the still picture information is permitted only when the audio information is reproduced. This prevents the still picture information from being reproduced regardless of the reproduction of the audio information. Therefore, the intention of the distributor that the audio information and the still picture information are reproduced at the same time can be correctly reflected. When text information is distributed instead of, or together with the still picture information, the text information is handled in the same manner as the still picture information.

### Example 29

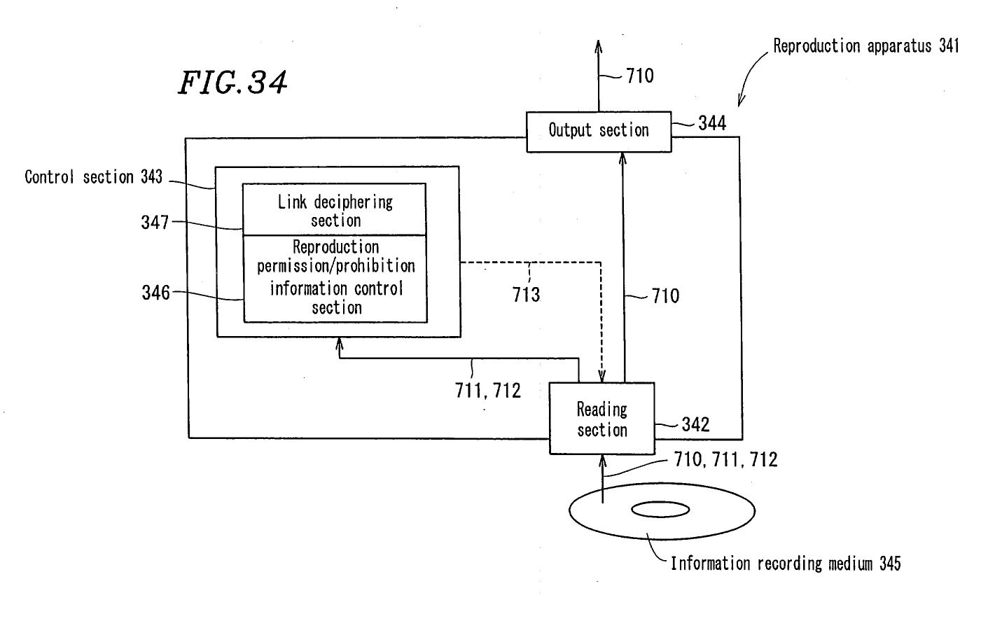

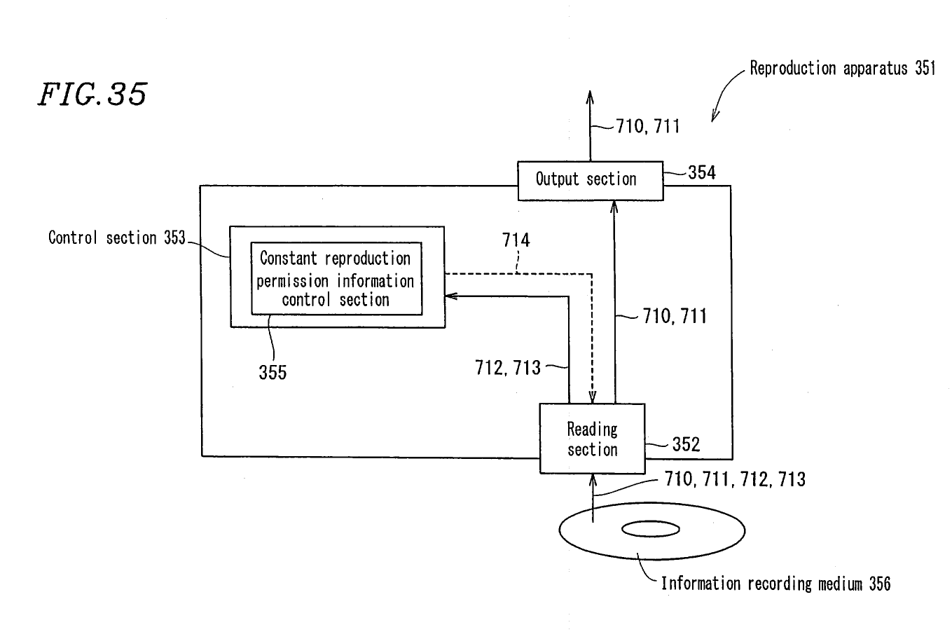

FIG. 34 shows a reproduction apparatus 341 according to Example 29 of the present invention. As shown in FIG. 34, the reproduction apparatus 341 includes a reading section 342, a control section 343, and an output section 344. The control section 343 includes a reproduction permission/prohibition information control section 346 and a link deciphering section 347. An information recording medium 345 includes still picture information 710, still picture reproduction restriction information 711 for restricting reproduction of the still picture information 710, and still picture management information 712 for managing reproduction of the still picture information 710. The control 347 controls the reading section 342 by outputting a control signal 713 to the reading section 342.

For reproducing the still picture information 710, the reading section 342 reads the still picture reproduction restriction information 711 and the still picture management information 712, and outputs both types of information to the control section 343. The control section 343 controls the reading section 342 based on the restriction represented by the still picture reproduction restriction information 711. The reproduction permission/prohibition information control section 346 included in the control section 343 deciphers the still picture reproduction restriction information 711. The link deciphering section 347 deciphers the still picture management information 712. When it is found that the still picture reproduction restriction information 711 is reproduction permission/prohibition information and that the still picture information 710 is not linked to any other information as a result of the deciphering, the control section 343 controls the reading section 342 so as not to read the still picture information 710 to be reproduced.

When it is found that the still picture reproduction restriction information 711 is reproduction permission/prohibition information and that the still picture information 710 is linked to other information, the control section 333 controls the reading section 342 so as to read the still picture information 710 to be reproduced. The reading section 342 outputs the still picture information 710 to the out put section 344. The out put section 344 out puts the still picture information 710 received from the reading section 342. In this case, the still picture information 710 is reproduced with the other information linked to the still picture information 710.

Instead of still picture information 710, audio information, moving picture information, text information or other types of information may be processed for reproduction by the reproduction apparatus 341.

According to Example 29, the following advantages are provided. It is assumed that the user purchases an information content including still picture information and audio information via electronic music distribution or the like. When the still picture reproduction restriction information is reproduction permission/prohibition information, even if the user edits such that the audio information is linked to other still picture information, the still picture information included in the information content is prohibited from being reproduced independently. Therefore, the intention of the distributor that the audio information and the still picture information included in the information content distributed by electronic distribution should be reproduced at the same time can be correctly reflected. When text information is distributed instead of, or together with the still picture information, the text information is handled in the same manner as the still picture information.

### Example 30

FIG. 35 shows a reproduction apparatus 351 according to Example 30 of the present invention. As shown in FIG. 35, the reproduction apparatus 351 includes a reading section 352, a control section 353, and an output section 354. The control section 353 includes a constant reproduction permission information control section 355. An information recording medium 356 includes first information 710, second information 711 linked to the first information 710, first reproduction restriction information 712 for restricting reproduction of the first information 710, and second reproduction restriction information 713 for restricting reproduction of the second information 711. Each of the first information 710 and the second information 711 is, for example, audio information, moving picture information, still picture information, text information, or other types of information. More specifically, the first information 710 is at least one of audio information and moving picture information. The second information 711 is at least one of still picture information and text information. The control section 353 controls the reading section 352 by outputting a control signal 714 to the reading section 352.

For reproducing the audio information 710 and the second information 711, the reading section 352 reads the first reproduction restriction information 712 and the second reproduction restriction information 713 from the information recording medium 356, and outputs both types of information to the control section 353. The control section 353 controls the reading section 352 based on the first reproduction restriction information 712 and the second reproduction restriction information 713. The constant reproduction permission information control section 355 included in the control section 353 deciphers the second reproduction restriction information 713, and determines whether or not the second reproduction restriction information 713 is constant reproduction permission information which represents that the reproduction of the second information 711 is permitted regardless of whether or not reproduction of the first information 710 is permitted by the first reproduction restriction information 712. When it is determined that the second reproduction restriction information 713 is constant reproduction permission information, the control section 353 controls the reading section 352 so as to read the second information 711 for reproduction regardless of whether or not the reproduction of the first information 710 is permitted. The reading section 352 outputs the second information 711 to the output section 354. The output section 354 outputs the second information 711 received from the reading section 352. When reproduction of the first information 710 is permitted, the reading section 352 and the output section 354 can operate so as to reproduce the first information 710 and the second information 711.

According to Example 30, the following advantages are provided. It is assumed that the user purchases an information content including audio information associated with the reproduction restriction information and still picture information associated with the reproduction restriction information, via electronic music distribution or the like. When the reproduction restriction information associated with the still picture information is constant reproduction permission information, even when the audio information is not permitted to be reproduced by the reproduction restriction information, the still picture information can be reproduced. Thus, the still picture information can be used for displaying the menu of the audio information, which is very useful to the user. When text information is distributed instead of, or together with the still picture information, the text information is handled in the same manner as the still picture information.

### Example 31

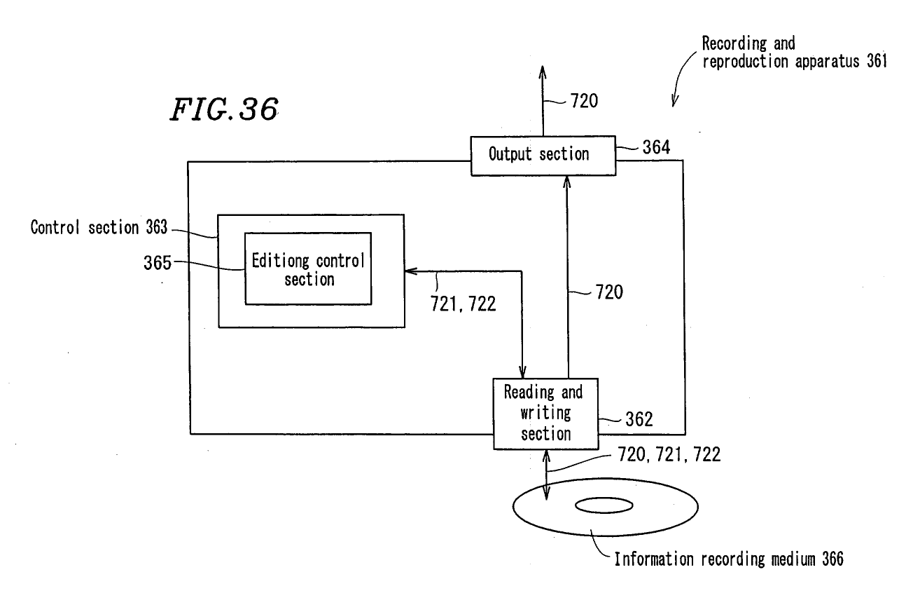

FIG. 36 shows a recording and reproduction apparatus 361 according to Example 31 of the present invention. As shown in FIG. 36, the recording and reproduction apparatus 361 includes a reading and writing section 362, a control section 363, and an output section 364. The control section 363 includes an editing control section 365. An information recording medium 366 includes audio information 720, audio editing information 721 regarding editing permission of the audio information 720, and audio management information 722 for managing reproduction of the audio information 720.

For editing the audio information 720, the reading and writing section 362 reads the audio editing information 721 and the audio management information 722, and outputs both types of information to the control section 363. The editing control section 365 included in the control section 363 deciphers the audio editing information 721. When it is found that the audio editing information 721 is conditional editing permission information which prohibits information editing, the editing control section 365 prohibits the audio management information 722 from being rewritten for editing other than deletion of the audio information 720 in any way.

When it is found that the audio editing information 721 is unconditional editing permission information, the editing control section 365 permits the audio management information 722 to be rewritten in any manner for editing the audio information 720.

For reproducing the audio information 720 which is edited or unedited, the control section 363 controls the reading and writing section 362 and the output section 364 so as to reproduce the audio information 720.

Instead of audio information, still picture information, moving picture information, text information or other types of information may be processed for reproduction by the recording and reproduction apparatus 361.

The recording and reproduction apparatus 361 includes the reading and writing section 362 for both reading and writing of information. Alternatively, the recording and reproduction apparatus 361 may separately include a section for reading information and a section for writing information.

According to Example 31, when the user purchases audio information via electronic distribution or the like, and when the audio editing information is conditional editing permission information, the audio information can be prohibited from being edited by the user. As a result, the audio information edited by the user is prohibited from being copied or transferred to another information recording medium as if it was the original audio information. Even when the audio editing information is unconditional editing permission information, the right of the user who wishes to delete unnecessary data is maintained.

### Example 32

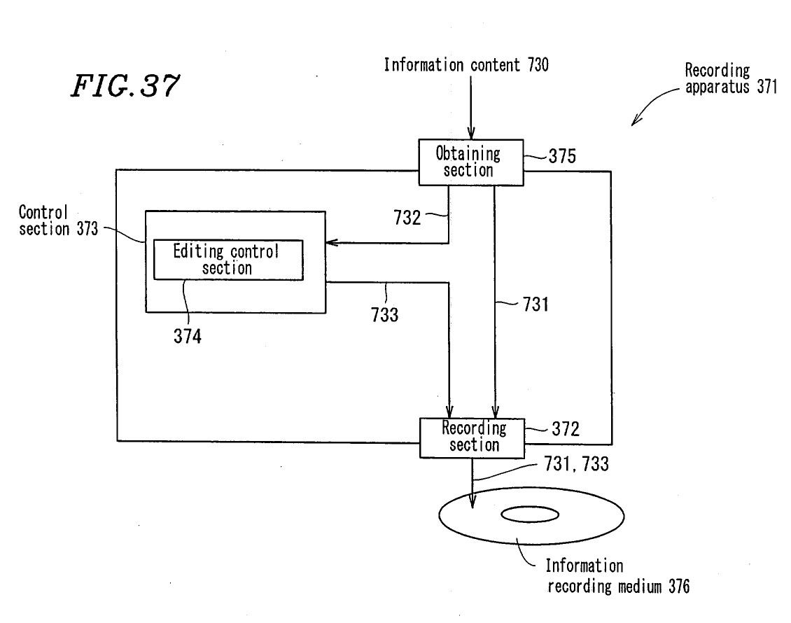

FIG. 37 shows a recording apparatus 371 according to Example 32 of the present invention. As shown in FIG. 37, the recording apparatus 371 includes a recording section 372, a control section 373, and an obtaining section 375. The control section 373 includes an editing control section 374. An information content 730 includes audio information 731, and copyright information 732 representing copyright of the audio information 731.

Upon obtaining the information content 730 from an information source such as, for example, electronic distribution, the obtaining section 375 outputs the copyright information 732 to the control section 373, and outputs the audio information 731 to the recording section 372. When it is determined that the copyright information 732 includes audio reproduction restriction information, the editing control section 374 included in the control section 373 outputs conditional editing permission information 733, which prohibits editing other than deletion, to the recording section 732 as audio editing restriction information. The recording section 372 records the audio information 731 and the conditional editing permission information 733 on an information recording medium 376.

Instead of audio information 731, still picture information, moving picture information, text information or other types of information may be processed for recording by the recording apparatus 371.

According to Example 32, when recording audio information associated with audio reproduction restriction information which is purchased by the user via electronic distribution or the like, the audio information can be recorded with a restriction which prohibits editing other than deletion. For example, in the case where the audio reproduction restriction information is reproduction area permission information which specifies the reproduceable area, editing of the audio information may influence the reproduction area permission information. Therefore, it is effective to prohibit editing of the audio information associated with reproduction restriction information.

### Example 33

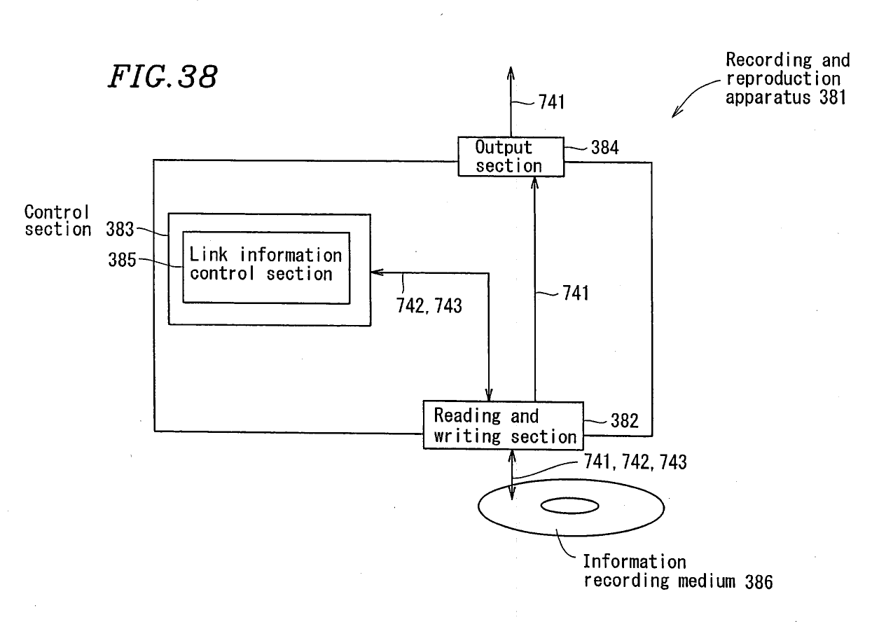

FIG. 38 shows a recording and reproduction apparatus 381 according to Example 33 of the present invention. As shown in FIG. 38, the recording and reproduction apparatus 381 includes a reading and writing section 382, a control section 383, and an output section 384. The control section 383 includes a link information control section 385. An information recording medium 386 includes audio information 741, link information 742 regarding permission/prohibition of linking between the audio information 741 and other information, and audio management information 743 for managing reproduction of the audio information 741.

For changing the linking between the audio information 741 and other information, the reading and writing section 382 reads the link information 742 and the audio management information 743, and outputs both types of information to the control section 383. The link information control section 385 included in the control section 383 determines whether or not the link information 742 is link permission information which permits link editing. When it is determined that the link information 742 is link permission information, the link information control section 385 permits deletion or addition of linking between the audio information 741 and other information which is represented by the audio management information 743.

When it is determined that the link information 742 is link prohibition information which prohibits link editing, the link information control section 385 prohibits deletion or addition of linking between the audio information 741 and other information which is represented by the audio management information 743.

Instead of audio information 741, still picture information; moving picture information, text information or other types of information may be processed for editing regarding linking by the recording and reproduction apparatus 381.

For reproducing audio information 741 whose linking is changed or unchanged, the control section 383 controls the reading and writing section 382 and the output section 384 so as to reproduce the audio information 741.

The recording and reproduction apparatus 381 includes the reading and writing section 382 for both reading and writing of information. Alternatively, the recording and reproduction apparatus 381 may separately include a section for reading information and a section for writing information.

According to Example 33, when the user purchases an information content including audio information and still picture information via electronic music distribution, and when the audio information is associated with link prohibition information, the audio information is prohibited from being linked to other still picture information by the user. Therefore, the intention of the distributor that the audio information and the still picture information distributed via electronic distribution are always handled as a pair can be correctly reflected. In the case where the user associates audio information copied from a CD or the like with link permission information, the user can arbitrarily link still picture information to the audio information. Therefore, both audio information to which the user can arbitrarily link with still picture information, and audio information to which the user is prohibited from linking with still picture information, can be managed. When text information is distributed instead of, or together with the still picture information, the text information is handled in the same manner as the still picture information.

### Example 34

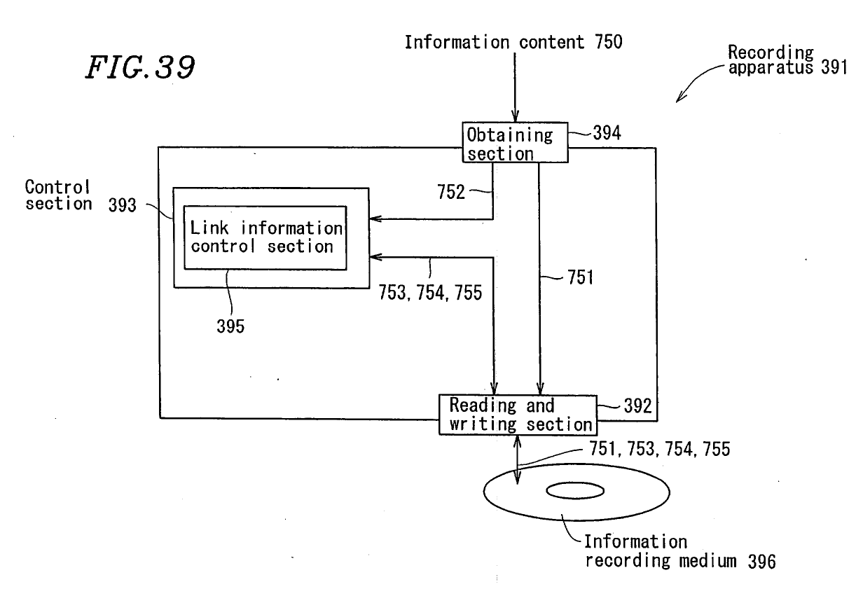

FIG. 39 shows a recording apparatus 391 according to Example 34 of the present invention. As shown in FIG. 39, the recording apparatus 391 includes a reading and writing section 392, a control section 393, and an obtaining section 394. The control section 393 includes a link information control section 395. An information content 750 includes audio information 751, and inherent information 752 for specifying the audio information 751.

Upon obtaining the information content 750 from an information source such as, for example, electronic distribution, the obtaining section 394 outputs the audio information 751 to the reading and writing section 392. The reading and writing section 392 reads management information 753 for managing reproduction of the information recorded on the information recording medium 396 and inherent information 755, and outputs both types of information to the control section 393. The link information control section 395 included in the control section 393 determines whether or not the inherent information 755 is the same as the inherent information 752. When it is determined that the inherent information 755 is the same as the inherent information 752, the link information control section 395 rewrites the management information 754 such that the audio information 751 is linked to the information in the information recording medium 396 which is specified by the inherent information 855, and outputs the written management information 754. The link information control section 395 also outputs, to the reading and writing section 392, link information 753 which indicates that the linking between the audio information 751 and the information in the information recording medium 396 which is specified by the inherent information 755 is prohibited from being changed. The reading and writing section 392 records the audio information 751, the written management information 754, and the link information 753 on the information recording medium 396.

Instead of audio information 751, still picture information, moving picture information, text information or other types of information may be processed for linking by the recording apparatus 391. The inherent information 752 and the inherent information 755 are, for example, an ISRC code.

The recording and reproduction apparatus 391 includes the reading and writing section 392 for both reading and writing of information. Alternatively, the recording and reproduction apparatus 391 may separately include a section for reading information and a section for writing information.

According to Example 34, when the user purchases an information content including audio information and still picture information via electronic music distribution, then transfers only the audio information to another information recording medium, and then transfers the audio information back to the original information recording medium, the audio information can be automatically linked to the still picture information which was purchased together with the audio information via the electronic music distribution. Therefore, the audio information and the still picture information, even if once separated, can be automatically linked to each other when recorded on the same information recording medium. This is convenient to the user. When text information is distributed instead of, or together with the still picture information, the text information is handled in the same manner as the still picture information.

### Example 35

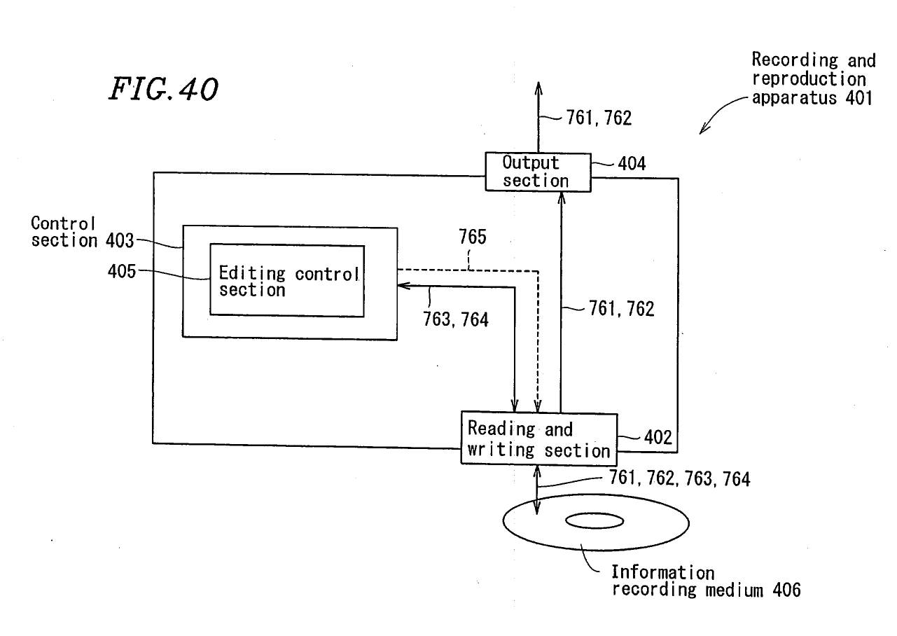

FIG. 40 shows a recording and reproduction apparatus 401 according to Example 35 of the present invention. As shown in FIG. 40, the recording and reproduction apparatus 401 includes a reading and writing section 402, a control section 403, and an output section 404. The control section 403 includes an editing control section 405. An information recording medium 406 includes first information 761, inherent information 764 for specifying the first information 761, and management information 763 for managing the first information 761. The information recording medium 406 may further include second information 762.

Each of the first information 761 and the second information 762 is, for example, audio information, moving picture information, still picture information, text information or other types of information. More specifically, the first information 761 is at least one of the audio information and the moving picture information, and the second information 762 is at least one of the still picture information and the text information. The inherent information 764 is, for example, an ISRC code. The control section 403 controls the reading and writing section 402 by outputting a control signal 765 to the reading and writing section 402.

For deleting the first information 761, the reading and writing section 402 reads the management information 763 and the inherent information 764 from the information recording medium 406, and outputs both types of information to the control section 403. The editing control section 405 included in the control section 403 deciphers the management information 763, and determines whether or not the second information 762 linked to the first information 761 to be deleted (the linked second information 762 is associated with the same inherent information as that of the inherent information 764) is recorded on the information recording medium 406. At this point, the editing control section 405 may perform a search throughout the information recording medium 406 via the reading and writing section 402 in order to find whether or not the second information 762 is recorded on the information recording medium 406.

When it is determined that the second information 762 is recorded on the information recording medium 406, the control section 403 controls the reading and writing section 402 so as to delete the second information 762 when deleting the first information 761 from the information recording medium 762. When the second information 762 is not recorded on the information recording medium 406, the control section 403 controls the reading and writing section 402 to delete only the first information 761 from the information recording medium 406.

For reproducing the first information 761 and the second information 762, the reading and writing section 402 and the output section 404 may operate so as to reproduce the first information 761 and the second information 762.

The recording and reproduction apparatus 401 includes the reading and writing section 402 for both reading and writing of information. Alternatively, the recording and reproduction apparatus 401 may separately include a section for reading information and a section for writing information.

According to Example 35, in the case where the user purchases audio information and still picture information each provided with inherent information and records both types of information on an information recording medium, when the audio information and the still picture information are linked to each other, the still picture information is deleted when the audio information is deleted. Therefore, the user is prevented from deleting only the audio information and linking the still picture information to other audio information for reuse. When text information is distributed instead of, or together with the still picture information, the text information is handled in the same manner as the still picture information.

### Example 36

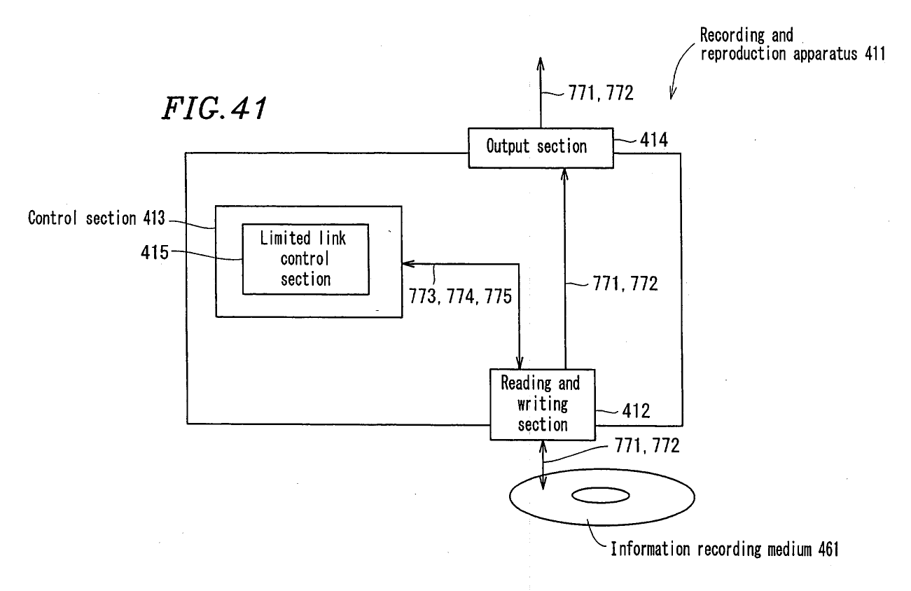

FIG. 41 shows a recording and reproduction apparatus 411 according to Example 36 of the present invention. As shown in FIG. 41, the recording and reproduction apparatus 411 includes a reading and writing section 412, a control section 413, and an output section 414. The control section 413 includes a limited link control section 415. An information recording medium 416 includes first information 771, management information 773 for managing reproduction of the first information 777, and first inherent information 774 for specifying the first information 771.

For linking the first information 771 to other information, the reading and writing section 412 reads a plurality of pieces of inherent information including the inherent information 774 and the management information 773 from the information recording medium 461, and outputs the read information to the control section 413. The limited link control section 415 deciphers the plurality of pieces of inherent information including the inherent information 774, and determines whether or not second inherent information 775 specified by the first inherent information 774 exists. When it is determined that the second inherent information 775 exists, the limited link control section 415 rewrites the management information 773 so as to link the second information 772 specified by the second inherent information 775 (the second information 772 is recorded on the information recording medium 461) and the first information 771. When the second inherent information 775 does not exist, the first information 771 is not linked to any other information.

For reproducing the first information 771 and the second information 772, the reading and writing section 412 and the output section 414 operate so as to reproduce the first information 771 and the second information 772.

Each of the first information 771 and the second information 772 is, for example, audio information, moving picture information, still picture information, text information or other types of information. Each of the inherent information 774 and the inherent information 775 is, for example, an ISRC code.

The recording and reproduction apparatus 411 includes the reading and writing section 412 for both reading and writing of information. Alternatively, the recording and reproduction apparatus 411 may separately include a section for reading information and a section for writing information.

According to Example 36, when audio information and still picture information purchased via electronic music distribution are provided with the same inherent information, the audio information can be controlled so as to be linked to only the still picture information distributed with the audio information. Linking between the distributed still picture information and audio information copied from a CD or a DVD can be prohibited. As a result, the intention of the distributor that the still picture information and the audio information should be reproduce as a pair can be accurately reflected. When text information is distributed instead of, or together with the still picture information, the text information is handled in the same manner as the still picture information.

### Example 37

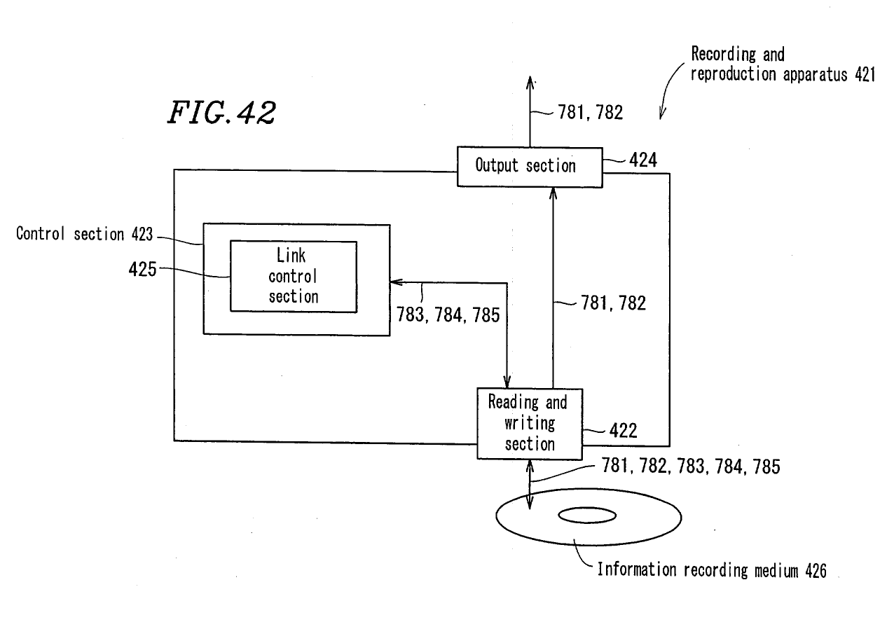

FIG. 42 shows a recording and reproduction apparatus 421 according to Example 37 of the present invention. As shown in FIG. 42, the recording and reproduction apparatus 421 includes a reading and writing section 422, a control section 423, and an output section 424. The control section 423 includes a link control section 425. An information recording medium 426 includes first information 781, management information 783 for managing reproduction of the first information 781, and first inherent information 784 for specifying the first information 781.

For linking the first information 781 to other information, the reading and writing section 422 reads the management information 783 and a plurality of pieces of inherent information including the inherent information 784, and outputs the read information to the control section 423. The link control section 425 deciphers the plurality of pieces of inherent information including the inherent information 784, and determines whether or not second inherent information 785 specified by the first inherent information 784 exists. When it is determined that the second inherent information 785 exists, the link control section 425 rewrites the management information 783 so as to link the second information 782 specified by the second inherent information 785 (the second information 782 is recorded on the information recording medium 426) and the first information 781. When the second inherent information 785 does not exist, the link control section 425 permits linking between the first information 781 and the information which is provided with inherent information which is not specified by the first inherent information 784.

For reproducing the first information 781 and the second information 782, the reading and writing section 422 and the output section 424 operate so as to reproduce the first information 781 and the second information 782.

Each of the first information 781 and the second information 782 is, for example, audio information, moving picture information, still picture information, text information or other types of information. Each of the inherent information 784 and the inherent information 785 is, for example, an ISRC code.

The recording and reproduction apparatus 421 includes the reading and writing section 422 for both reading and writing of information. Alternatively, the recording and reproduction apparatus 421 may separately include a section for reading information and a section for writing information.

According to Example 37, when the audio information and the still picture information purchased by the user via electronic music distribution are provided with the same inherent information, the audio information can be always controlled to be linked only to the distributed still picture information. The audio information copied from a CD or a DVD and provided with inherent information can be linked to still picture information photographed by the user using a digital still camera and provided with no inherent information. When text information is distributed instead of, or together with the still picture information, the text information is handled in the same manner as the still picture information.

### Example 38

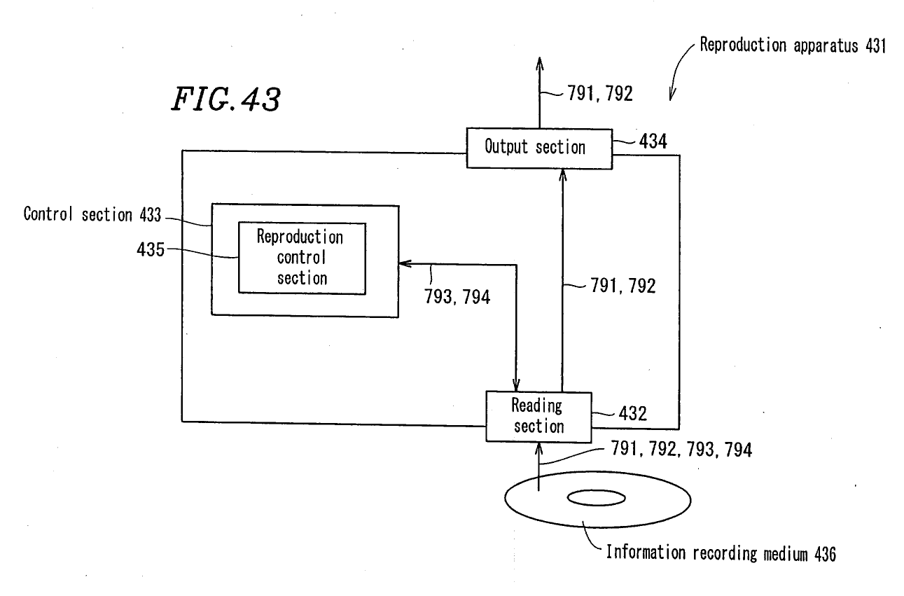

FIG. 43 shows a reproduction apparatus 431 according to Example 38 of the present invention. As shown in FIG. 43, the reproduction apparatus 431 includes a reading section 432, a control section 433, and an output section 434. The control section 433 includes a reproduction control section 435. An information recording medium 436 includes still picture information 791, still picture management information 793 for managing reproduction of the still picture information 791, and first inherent information 794 for specifying the still picture information 791.

For reproducing the still picture information 791, the reading section 432 reads the still picture management information 793 and first inherent information 794, and outputs both types of information to the control section 433. When the first inherent information 794 is found to be recorded on the information recording medium 436, the reproduction control section 435 deciphers the management information 793 and determines whether or not the still picture information 791 is linked to the other information. When it is determined that the still picture information 791 is not linked to any other information, the control section 433 controls the reading section 432 so as not to reproduce the still picture information 791. When it is determined that the still picture information 791 is linked to other information, the control section 433 controls the reading section 432 so as to reproduce the still picture information 791. The reading section 432 reads the still picture information 791 and the audio information 792 from the information recording medium 436, and outputs both types of information to the output section 434. The output section 434 outputs the still picture information 791 and the audio information 792 received from the reading section 432.

Instead of the still picture information 791, audio information, moving picture information, text information or other types of information may be processed for reproduction by the reproduction apparatus 431.

According to Example 38, in the case where the user purchases audio information and still picture information each provided with inherent information via electronic music distribution, even when the only the audio information is transferred to another information recording medium, the still picture information is prohibited from being reproduced independently. As a result, the intention of the distributor that the still picture information is reproduced when only specific audio information is reproduced can be accurately reflected.

### Example 39

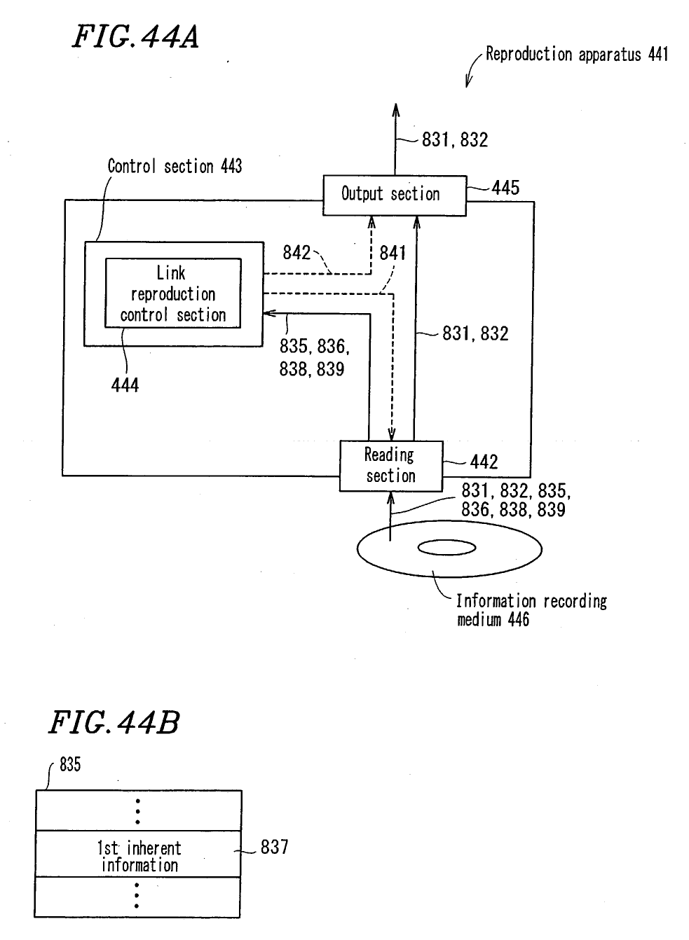

FIG. 44A shows a reproduction apparatus 441 according to Example 39. As shown in FIG. 44, the reproduction apparatus 441 includes a reading section 442, a control section 443, and an output section 445. The control section 443 includes a link reproduction control section 444. An information recording medium 446 includes first information 831, second information 832, copyright information 835 representing copyright regarding the first information 831, management information 836 for managing reproduction of the first information 831, and management information 839 for managing reproduction of the second information 832. As shown in FIG. 44B, the copyright information 835 includes first inherent information 837 for specifying the first information. The second information 832 includes second inherent information 838 for specifying the information linked to the second information 832. When the first information 831 and the second information 832 are linked to each other, the first inherent information 837 and the second inherent information 838 are the same as each other.

Each of first information 831 and second information 832 is, for example, audio information, moving picture information, still picture information, text information, and other information. More specifically, the first information 831 is at least one of audio information and moving picture information, and the second information 832 is at least one of still picture information and text information. Each of the first inherent information 837 and the second inherent information 838 is, for example, an ISRC code.

The control section 443 controls the reading section 442 by outputting a control signal 841 to the reading section 442. The control section 443 controls the output section 445 by outputting a control signal 842 to the output section 445.

For reproducing the first information 831 and the second information 832, the reading section 442 reads the management information 836, the management information 839, and the copyright information 835 from the information recording medium 446, and outputs the read information to the control section 443. The link control section 444 included in the control section 443 deciphers management information 836 and management information 839. The control section 443 recognizes a recording position of the first information 831 and a recording position of the second information 832 in the information recording medium 446, and controls the reading section 442 so as to read the first information 831 and the second information 832 in accordance with those recording positions.

The reading section 442 reads the first information 831 and the second information 832 from the information recording medium 446, and outputs the first information 831 to the output section 445. The reading section 442 outputs the second inherent information 838 included in the second information 832 to the control section 443, and outputs the remaining part of the second information 832 to the output section 445.

The link reproduction control section 444 retrieves the first inherent information 837 from the copyright information 835, and compares the first inherent information 837 with the second inherent information 838. When the first inherent information 837 and the second inherent information 838 are found to be the same inherent information (i.e., the first information 381 is linked to the second information 832), the link reproduction control 444 controls the reading section 442 and the output section 445 so as to reproduce the first information 831 and the second information 832. The output section 445 outputs the first information 831 and the second information 832 received from the reading section 442.

When the first inherent information 837 and the second inherent information 838 are found not to be the same inherent information (i.e., the first information 381 is not linked to the second information 832), the link reproduction control section 444 controls the output section 445 so as to reproduce the first information 831 but not to reproduce the second information 832. Alternatively when the first inherent information 837 and the second inherent information 838 are found not to be the same inherent information, the link reproduction control section 445 may control the output section 444 so as not to reproduce the first information 831 or the second information 832.

According to Example 39, for reproducing linked audio information and still picture information, the inherent information of the audio information is compared to the inherent information of the still picture information. Thus, execution of the reproduction of the audio information and the still picture information can be controlled. For example, it is assumed that the user purchases an information content including audio information and still picture information linked to each other via electronic music distribution, and records the information content on an information recording medium. This linking reflects the intention of the music company which created the information content. Therefore, the linking should not be changed by the user. In other words, the still picture information included in the information content should be arranged so as not to be reproduced together with other audio information. For recording such an information content on an information recording medium, the audio information and still picture information are recorded such that audio information is linked to still picture information and such that the still picture information includes inherent information for specifying the audio information. Therefore, even if the user changes the linking between the audio information and the still picture information, the still picture information purchased via electronic music distribution is not reproduced together with other audio information as long as the still picture information is reproduced in accordance with Example 39. Thus, the intention of the music company can be reflected.

An information recording medium according to the present invention includes reproduction restriction information for restricting reproduction of information, and thus reproduces the information in accordance with the restriction of reproduction of the information defined by the copyright proprietor.

According to the present invention, two different types of audio information, i.e., audio information which is managed by a conventional generation management type copy control system against, for example, copies from a CD or a DVD, and audio information which is managed by a copy control system adopted by electronic music distribution such as, for example, transfer, can be managed in one information recording medium. In addition to the audio information, still picture information and text information for which copyright is asserted can be managed. Copyright information representing the linking between the audio information, the still picture information, and the text information can be managed. Contents such as audio information and the like which are associated with reproduction restriction information which is distributed via electronic music distribution can also be managed.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. An information recording medium for recording of information and copyright information representing copyright regarding the information,
wherein the copyright information includes reproduction restriction information for restricting reproduction of the information.

2. An information recording medium according to claim 1, wherein the information is at least one of audio information, still picture information, moving picture information, and text information.

3. An information recording medium according to claim 1, wherein the reproduction restriction information represents one of a time period in which the information is permitted to be reproduced, a time limit until which the information is permitted to be reproduced, a number of times that the information is permitted to be reproduced, a time period in which the information is permitted to be reproduced after an initial reproduction of the information, a password for reproducing the information, a reproduction quality of the information, and an area of the information recording medium which is permitted to be reproduced.

4. An information recording medium according to claim 1, wherein the reproduction restriction information indicates that reproduction of the information is restricted by a combination of a plurality of types of restriction.

5. An information recording medium according to claim 1, wherein:
the information includes first information and second information linked to the first information; and
the reproduction restriction information includes permission information indicating that the second information is permitted to be reproduced when the first information is permitted to be reproduced.

6. An information recording medium according to claim 1, wherein:
the information includes first information and second information linked to the first information; and
the reproduction restriction information includes permission information indicating that the second information is permitted to be reproduced regardless of whether or not the first information is permitted to be reproduced.

7. An information recording medium for recording of information, management information for managing reproduction of the information, and copyright information representing copyright regarding the information,
wherein the copyright information is recorded in a different area of the information recording medium from an area in which the information and the management information are recorded.

8. An information recording medium according to claim 7, wherein the information is at least one of audio information, still picture information, moving picture information, and text information.

9. An information recording medium according to claim 7, wherein the information, the management information, and the copyright information are included in different files from each other.

10. An information recording medium according to claim 7, wherein:
the information includes a plurality of pieces of partial information;
the management information includes a plurality of pieces of partial management information;
the copyright information includes a plurality of pieces of partial copyright information;
each of the plurality of pieces of partial management information represents a management content regarding reproduction of a respective one of the plurality of pieces of partial information;
each of the plurality of pieces of partial copyright information represents copyright regarding a respective one of the plurality of pieces of partial information;
the plurality of pieces of partial management information, and the plurality of pieces of partial copyright information, are each provided with inherent information for identifying each piece of partial information; and
each of the pieces of partial management information and each of the pieces of partial copyright information which correspond to common partial information are provided with the same inherent information.

11. An information recording medium according to claim 10, wherein the inherent information is positive serial numbers.

12. An information recording medium for recording of information including a plurality of pieces of partial information, and copyright information representing copyright regarding a specific piece of partial information among the plurality of pieces of partial information.

13. An information recording medium according to claim 12, wherein the plurality of pieces of information are at least one of audio information, still picture information, moving picture information, and text information.

14. An information recording and reproduction apparatus, comprising:
a reading section for reading first information from an information recording medium including the first information and second information linked to the first information;
an output section for outputting the first information;
a writing section for deleting the first information from the information recording medium; and
a control section for controlling the reading section and the writing section,
wherein the control section controls the writing section so as to delete the second information from the information recording medium when transferring the first information to another information recording medium.

15. A recording and reproduction apparatus according to claim 14, wherein:
the first information is at least one of audio information and moving picture information; and
the second information is at least one of still picture information and text information.

16. A recording and reproduction apparatus according to claim 14, further comprising a display section for displaying that the second information is deleted from the information recording medium when transferring the first information to the another information recording medium.

17. An information recording and reproduction apparatus, comprising:
a reading section for reading second information from a first information recording medium including the first information and second information linked to the first information;
an output section for outputting the second information;
a writing section for deleting the second information from the first information recording medium; and
a control section for controlling the reading section and the writing section,
wherein the control section controls the reading section and the writing section so as to transfer the first information from the first information recording medium to a second information recording medium when transferring the second information from the first information recording medium to the second information recording medium.

18. A recording and reproduction apparatus according to claim 17, wherein:
the first information is at least one of audio information and moving picture information; and
the second information is at least one of still picture information and text information.

19. A recording and reproduction apparatus according to claim 17, wherein:
the first information recording medium further includes transfer information which represents whether the first information is permitted to be transferred or prohibited from being transferred;
the reading section further reads the transfer information from the first information recording medium;
the control section transfers the first information and the second information to the second information recording medium when the transfer information represents the first information is permitted to be transferred; and
the control section does not transfer the first information or the second information to the second information recording medium when the transfer information represents the first information is prohibited from being transferred.

20. A recording and reproduction apparatus according to claim 17, wherein:
the first information recording medium further includes transfer information which represents that transfer of the second information is permitted or prohibited in conformance with whether the first information is permitted to be transferred or prohibited from being transferred;
the reading section further reads the transfer information from the first information recording medium;
the control section transfers the first information and the second information to the second information recording medium when the first information is permitted to be transferred; and
the control section does not transfer the first information or the second information to the second information recording medium when the first information is prohibited from being transferred.

21. A recording and reproduction apparatus for transferring first information from a first information recording medium including the first information to a second information recording medium, the recording and reproduction apparatus comprising:
a reading section for reading the first information from the first information recording medium;
an output section for outputting the first information;
a writing section for deleting the first information from the first information recording medium; and
a control section for controlling the reading section and the writing section;
wherein the control section determines whether or not second information which can be linked to the first information has been recorded on the second information recording medium; when the second information has been recorded on the second information recording medium, the control section controls the reading section and the writing section so as to transfer the first information to the second information recording medium; and when the second information has not been recorded on the second information recording medium, the control section controls the reading section and the writing section so as not to transfer the first information to the second information recording medium.

22. A recording and reproduction apparatus according to claim 21, wherein:
the first information is at least one of still picture information and text information: and
the second information is at least one of audio information and moving picture information.

23. A reproduction apparatus, comprising:
a reading section for reading information and copyright information representing copyright regarding the information from an information recording medium having the information and the copyright information; and
an output section for outputting the information,
wherein:
the copyright information includes reproduction restriction information for restricting reproduction of the information; and
the reproduction apparatus further includes a control section for controlling at least one of the reading section and the output section based on a restriction represented by the reproduction restriction information.

24. A reproduction apparatus according to claim 23, wherein the information is at least one of audio information, still picture information, moving picture information, and text information.

25. A reproduction apparatus according to claim 23, further comprising a memory section,
wherein the control section updates the reproduction restriction information as the information is reproduced, and stores the updated reproduction restriction information in the memory section.

26. A reproduction apparatus according to claim 25, wherein the control section determines whether or not to permit reproduction of the information based on a restriction represented by the reproduction restriction information.

27. A reproduction apparatus according to claim 23, wherein:
the reproduction restriction information includes permission information representing a time period in which reproduction of the information is permitted, and
the control section calculates a remaining time period in which reproduction of the information is permitted based on a time period in which the information has been reproduced and the time period represented by the permission information, and controls the reading section based on the calculated remaining time period.

28. A reproduction apparatus according to claim 27, wherein the control section controls the reading section so as to reproduce the information until the calculated remaining time period becomes zero, and so as not to reproduce the information when the calculated remaining time period reaches zero.

29. A reproduction apparatus according to claim 23, further comprising a memory section, wherein:
the reproduction restriction information includes permission information representing a time period in which reproduction of the information is permitted,
the control section calculates a remaining time period in which reproduction of the information is permitted based on a time period in which the information has been reproduced and the time period represented by the permission information, generates remaining time period information representing the calculated remaining time period, and stores the generated remaining time period information in the memory section, and
the control section controls the reading section based on the remaining time period represented by the remaining time period information stored in the memory section.

30. A reproduction apparatus according to claim 23, wherein:
the reproduction restriction information includes permission information representing a time period in which reproduction of the information is permitted, and
the control section compares a time period in which the information has been reproduced with the time period represented by the permission information, and controls the reading section based on the comparison result.

31. A reproduction apparatus according to claim 30, wherein when the time period in which the information has been reproduced is shorter than the time period represented by the permission information, the control section controls the reading section so as to reproduce the information; and when the time period in which the information has been reproduced reaches the time period represented by the permission information, the control section controls the reading section so as not to reproduce the information.

32. A reproduction apparatus according to claim 23, further comprising a memory section, wherein:
the reproduction restriction information includes permission information representing a time period in which reproduction of the information is permitted,
the control section generates past reproduction time information which represents the time period in which the information has been reproduced, and stores the generated past reproduction time period information in the memory section, and
the control section compares the time period represented by the past reproduction time information stored in the memory section with the time period represented by the permission information, and controls the reading section based on the result of the comparison.

33. A reproduction apparatus according to claim 23, further comprising a clock section representing a date/time, wherein:
the reproduction restriction information includes permission information representing a time limit until which reproduction of the information is permitted, and
the control section compares a date/time represented by the clock section with the time limit represented by the permission information, and controls the reading section based on the result of the comparison.

34. A reproduction apparatus according to claim 33, wherein when the date/time represented by the clock section is before the time limit represented by the permission information, the control section controls the reading section so as to reproduce the information, and when the date/time represented by the clock section is not before the time limit represented by the permission information, the control section controls the reading section so as not to reproduce the information.

35. A reproduction apparatus according to claim 23, wherein:
the reproduction restriction information includes permission information representing an area of the information recording medium which is permitted to be reproduced,
the area has a part of the information recorded therein, and
the control section controls the reading section so as to reproduce the part of the information recorded in the area.

36. A reproduction apparatus according to claim 23, wherein:
the reproduction restriction information includes permission information representing a number of times that the information is permitted to be reproduced, and
the control section calculates a remaining reproduction number of times that the information is permitted to be reproduced based on the number of times that the information has been reproduced and the number of times represented by the permission information, and controls the reading section based on the calculated remaining reproduction number of times.

37. A reproduction apparatus according to claim 36, wherein the control section controls the reading section so as to reproduce the information until the calculated remaining reproduction number of times becomes zero, and controls the reading section so as not to reproduce the information when the calculated remaining reproduction number of times becomes zero.

38. A reproduction apparatus according to claim 23, further comprising a memory section, wherein:
the reproduction restriction information includes permission information representing a number of times that the information is permitted to be reproduced,
the control section calculates a remaining reproduction number of times that the information is permitted to be reproduced based on the number of times that the information has been reproduced and the number of times represented by the permission information, generates remaining reproduction number information representing the calculated remaining reproduction number of times, and stores the generated remaining reproduction number information in the memory section, and
the control section controls the reading section based on the remaining reproduction number of times represented by the remaining reproduction number information stored in the memory section.

39. A reproduction apparatus according to claim 23, wherein the reproduction restriction information includes permission information representing a number of times that the information is permitted to be reproduced, and
the control section compares the number of times that the information has been reproduced with the number of times represented by the permission information, and controls the reading section based on the result of the comparison.

40. A reproduction apparatus according to claim 39, wherein when the number of times that the information has been reproduced is smaller than the number of times represented by the permission information, the control section controls the reading section so as to reproduce the information; and when the number of times that the information has been reproduced reaches the number of times represented by the permission information, the control section controls the reading section so as not to reproduce the information.

41. A reproduction apparatus according to claim 23, further comprising a memory section, wherein:
the reproduction restriction information includes permission information representing a number of times that the information is permitted to be reproduced,
the control section generates past reproduction number information representing a number of times that the information has been reproduced, and stores the generated past reproduction number information in the memory section, and
the control section compares the number of times represented by the past reproduction number information stored in the memory section with the number of times represented by the permission information stored in the memory section, and controls the reading section based on the result of the comparison.

42. A reproduction apparatus according to claim 23, further comprising a clock section representing a date/time, wherein:
the reproduction restriction information includes permission information representing a time period, from an initial reproduction of the information, in which reproduction of the information is permitted,
the control section specifies a date/time when the information was first reproduced from a date/time represented by the clock section, and calculates the time limit until which the reproduction of the information is permitted based on a date/time when the information was first reproduced and the time period represented by the permission information, and
the control section compares a date/time represented by the clock section with the calculated time limit, and controls the reading section based on the result of the comparison.

43. A reproduction apparatus according to claim 42, wherein when a date/time represented by the clock section is before the calculated time limit, the control section controls the reading section so as to reproduce the information, and when a date/time represented by the clock section is not before the calculated time limit, the control section controls the reading section so as not to reproduce the information.

44. A reproduction apparatus according to claim 23, further comprising:
a clock section representing a date/time; and
a memory section;
wherein:
the reproduction restriction information includes permission information representing a time period, from an initial reproduction of the information, in which reproduction of the information is permitted,
the control section specifies a date/time when the information was first reproduced from a date/time represented by the clock section, calculates the time limit until which the reproduction of the information is permitted based on a date/time when the information was first reproduced and the time period represented by the permission information, generates time limit information representing the calculated time limit, and stores the generated time limit information in the memory section, and
the control section compares the time limit represented by the time limit information stored in the memory section with a date/time represented by the clock, and controls the reading section based on the result of the comparison.

45. A reproduction apparatus according to claim 44, wherein:
the control section generates initial reproduction date/time information representing a date/time when the information was first reproduced, and stores the generated initial reproduction date/time information in the memory section,
the control section compares the date/time represented by the initial reproduction date/time information stored in the memory section with a time/date represented by the clock section, and controls the reading section based on the result of the comparison between the time limit represented by the time limit information stored in the memory section and the date/time represented by the clock section, and the result of the comparison between the date/time represented by the initial reproduction date/time information stored in the memory section and the date/time represented by the clock section.

46. A reproduction apparatus according to claim 23, wherein:
the reproduction restriction information includes reproduction quality information representing a quality of the information at the time of reproduction, and
the control section controls the output section so as to reproduce the information with the quality represented by the reproduction quality information.

47. A reproduction apparatus according to claim 23, wherein:
the information includes first information and second information linked to the first information,
the reproduction restriction information includes first reproduction restriction information for restricting reproduction of the first information, and second reproduction restriction information for restricting reproduction of the second information,
the second reproduction restriction information includes permission information representing that when reproduction of the first information is permitted, reproduction of the second information is permitted, and
the control section determines whether or not to permit reproduction of the first information based on the first reproduction restriction information, permits reproduction of the second information when reproduction of the first information is permitted, and does not permit reproduction of the second information when reproduction of the first information is not permitted.

48. A reproduction apparatus according to claim 23, wherein:
the information includes first information and second information linked to the first information,
the reproduction restriction information includes permission information which represents that reproduction of the second information is permitted regardless of whether or not reproduction of the first information is permitted, and
the control section permits reproduction of the second information regardless of whether or not the reproduction of the first information is permitted.

49. A recording and reproduction apparatus, comprising:
an obtaining section for obtaining information and copyright information representing copyright regarding the information;
a writing section for writing the information on an information recording medium; and
a control section for controlling the writing section;
wherein the control section determines whether or not the copyright information includes reproduction restriction information for restricting reproduction of the information, and when the copyright information includes the reproduction restriction information, the control section controls the writing section so as not to write the information on the information recording medium.

50. A recording and reproduction apparatus according to claim 49, wherein the information is at least one of audio information, still picture information, moving picture information, and text information.

51. A recording and reproduction apparatus according to claim 49, wherein when the copyright information does not include the reproduction restriction information, the control section controls the writing section so as to write the information on the information recording medium.

52. A recording and reproduction apparatus according to claim 49, further comprising a display section for displaying that the information cannot be written on the information recording medium when the copyright information includes the reproduction restriction information.

53. A reproduction apparatus, comprising:
a reading section for reading information and copyright information regarding the information from an information recording medium including the information and the copyright information;
an output section for outputting the information; and
a control section for controlling the reading section;
wherein the control section determines whether or not the copyright information includes reproduction restriction information for restricting reproduction of the information, and when the copyright information includes the reproduction restriction information, the control section controls the reading section so as not to reproduce the information.

54. A reproduction apparatus according to claim 53, wherein the information is at least one of audio information, still picture information, moving picture information, and text information.

55. A reproduction apparatus according to claim 53, wherein when the copyright information does not include the reproduction restriction information, the control section controls the reading section so as to reproduce the information.

56. A reproduction apparatus according to claim 53, further comprising a display section for displaying that the information cannot be reproduced when the copyright information includes the reproduction restriction information.

57. A recording and reproduction apparatus, comprising:
a writing section for deleting first information recorded on an information recording medium from the information recording medium; and
a control section for controlling the writing section;
wherein the control section determines whether or not second information which is linked to the first information is recorded on the information recording medium; when the second information is recorded on the information recording medium, the control section controls the writing section so as to delete the first information and the second information from the information recording medium as the first information is deleted; and when the second information is not recorded on the information recording medium, the control section controls the writing section so as to delete the first information from the information recording medium.

58. A recording and reproduction apparatus according to claim 57, wherein:
the first information is at least one of audio information and moving picture information, and
the second information is at least one of still picture information and text information.

59. An information recording medium for recording of first information and second information linked to the first information, wherein the second information includes inherent information for specifying the first information.

60. An information recording medium according to claim 59, wherein:
the first information is at least one of audio information and moving picture information, and
the second information is at least one of still picture information and text information.

61. An information recording medium according to claim 59, further comprising copyright information representing copyright regarding the first information, wherein the copyright information includes inherent information, which is the same as the inherent information included in the second information.

62. An information recording medium according to claim 59, wherein:
the second information includes a plurality of pieces of partial information obtained as a result of division by a prescribed information unit, and
a prescribed piece of partial information among the plurality of pieces of partial information includes the inherent information.

63. A reproduction apparatus, comprising:
a reading section for reading first information and second information from an information recording medium including the first information and the second information;
an output section for outputting the first information; and
a control section for controlling the output section;
wherein the control section determines whether or not the second information includes inherent information for specifying the first information; when the second information includes the inherent information, the control section controls the output section so as to reproduce the first information and the second information; and when the second information does not include the inherent information, the control section controls the output section so as to reproduce the first information but not to reproduce the second information.

64. A reproduction apparatus according to claim 63, wherein:
the first information is at least one of audio information and moving picture information, and
the second information is at least one of still picture information and text information.

65. A reproduction apparatus according to claim 63, wherein:
the information recording medium further includes copyright information representing copyright regarding the first information recorded therein,
the copyright information includes inherent information which is the same as the inherent information included in the second information, and
the control section compares the copyright information with the second information, to determine whether or not the second information includes the inherent information.
